(19) United States
(12) Patent Application Publication
(10) Pub. No.: US 2025/0220724 A1
(43) Pub. Date: Jul. 3, 2025

(54) METHOD AND APPARATUS FOR PROVIDING ASSISTANCE INFORMATION OF AMBIENT IOT IN A WIRELESS COMMUNICATION SYSTEM

(71) Applicant: ASUS Technology Licensing Inc., Taipei City (TW)

(72) Inventors: Yi-Hsuan Huang, Taipei City (TW); Meng-Hui Ou, Taipei City (TW); Yu-Hsuan Guo, Taipei City (TW); Ming-Che Li, Taipei City (TW)

(21) Appl. No.: 19/004,174

(22) Filed: Dec. 27, 2024

Related U.S. Application Data
(60) Provisional application No. 63/616,328, filed on Dec. 29, 2023.
(60) Provisional application No. 63/616,478, filed on Dec. 29, 2023.
(60) Provisional application No. 63/620,656, filed on Jan. 12, 2024.
(60) Provisional application No. 63/563,130, filed on Mar. 8, 2024.

(51) Int. Cl. H04W 74/0833; H04W 48/02; H04W 68/02

(52) U.S. Cl. CPC H04W 74/0833; H04W 48/02; H04W 68/02

(57) ABSTRACT

Methods, systems, and apparatuses are provided for providing assistance information of ambient Internet of Things (IoT) in a wireless communication system, wherein a method of a User Equipment (UE) comprises receiving a first signaling of triggering a random access procedure, wherein the first signaling indicates a first information associated with a specific device type of device types, and determining whether to trigger the random access procedure, in response to receiving the first signaling, based on at least whether the UE belongs to the specific device type associated with the first information.

### CROSS-REFERENCE TO RELATED APPLICATIONS

The present application claims priority to and the benefit of U.S. Provisional Patent Application Ser. No. 63/616,328, filed Dec. 29, 2023, U.S. Provisional Patent Application Ser. No. 63/616,478, filed Dec. 29, 2023, U.S. Provisional Patent Application Ser. No. 63/620,656, filed Jan. 12, 2024, and U.S. Provisional Patent Application Ser. No. 63/563,130, filed Mar. 8, 2024; which each of the listed and referenced applications and disclosures fully incorporated herein by reference.

### FIELD

This disclosure generally relates to wireless communication networks and, more particularly, to a method and apparatus for providing assistance information of ambient Internet of Things (IoT) in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

Methods, systems, and apparatuses are provided for providing assistance information of ambient Internet of Things (IoT) in a wireless communication system. A User Equipment (UE) with a specific device type could trigger random access with proper resources for the specific device type indicated by a Network (NW). The NW could provide resources for different device types (to perform random access) in each paging. Alternatively and/or additionally, in response to (receiving) a signaling for triggering a random access, the UE could indicate its capability on transmission generation and its apparatus, which can help the NW to schedule Device to Receiver (D2R) transmissions. The ambient IoT UEs/devices could access the NW and/or transmit data using proper resources.

In various embodiments, a method of a UE comprises receiving a first signaling of triggering a random access procedure, wherein the first signaling indicates a first information associated with a specific device type of device types, and determining whether to trigger the random access procedure, in response to (receiving) the first signaling, based on (at least) whether the UE belongs to the specific device type associated with the first information.

In various embodiments, a method of a UE comprises receiving a first signaling of triggering a random access procedure, triggering the random access procedure in response to (receiving) the first signaling, and performing a transmission indicating or providing a third information during the random access procedure, wherein the third information indicates a device type of the UE, and the device type of the UE is differentiated by or associated with any of: a method to perform the transmission, equipped with amplification, energy storage, power level, and/or device size.

### BRIEF DESCRIPTION OF THE DRAWINGS

FIG. 1 shows a diagram of a wireless communication system, in accordance with embodiments of the present invention.

FIG. 2 is a block diagram of a transmitter system (also known as access network) and a receiver system (also known as user equipment or UE), in accordance with embodiments of the present invention.

FIG. 3 is a functional block diagram of a communication system, in accordance with embodiments of the present invention.

FIG. 4 is a functional block diagram of the program code of FIG. 3, in accordance with embodiments of the present invention.

FIG. 5 is a reproduction of FIG. 4.2.1.1-1: Topology 1, from 3GPP TR 38.848 V18.0.0.

FIG. 6 is a reproduction of FIG. 4.2.1.2-1: Topology 2, from 3GPP TR 38.848 V18.0.0.

FIG. 7A is a reproduction of FIG. 9.2.6-1: Random Access Procedures—(a) CBRA with 4-step RA type, from 3GPP TS 38.300 V17.6.0.

FIG. 7B is a reproduction of FIG. 9.2.6-1: Random Access Procedures—(b) CBRA with 2-step RA type, from 3GPP TS 38.300 V17.6.0.

FIG. 7C is a reproduction of FIG. 9.2.6-1: Random Access Procedures—(c) CFRA with 4-step RA type, from 3GPP TS 38.300 V17.6.0.

FIG. 7D is a reproduction of FIG. 9.2.6-1: Random Access Procedures—(d) CFRA with 2-step RA type, from 3GPP TS 38.300 V17.6.0.

FIG. 8 is a reproduction of FIG. 9.2.6-2: Fallback for CBRA with 2-step RA type, from 3GPP TS 38.300 V17.6.0.

FIG. 9 is an example diagram showing that a first UE may provide (or transmit) (at least) a (first) information to a network node (or a second UE), in accordance with embodiments of the present invention.

FIG. 10 is a flow diagram of a method of a first UE comprising initiating or performing a transmission to a network node (or a second UE), wherein the transmission includes at least a (first) information, in accordance with embodiments of the present invention.

FIG. 11 is a flow diagram of a method of a UE comprising initiating an RA procedure, in the RA procedure, transmitting a message including an identity of the UE, receiving a PDCCH transmission in response to transmitting the message, and determining the RA procedure is successfully completed based on the PDCCH transmission scrambling with the identity of the UE or the PDCCH transmission indicating the identity of the UE, in accordance with embodiments of the present invention.

FIG. 12 is a flow diagram of a method of a UE comprising initiating an RA procedure, in the RA procedure, transmitting a first message including an identity of the UE, receiving a second message in response to transmitting the first message, and determining the RA procedure is successfully completed based on the second message indicating the identity of the UE, in accordance with embodiments of the present invention.

FIG. 13 is a flow diagram of a method of a UE comprising receiving a signaling from a NW, initiating an RA procedure in response to receiving the signaling, transmitting a first message, starting a first timer at a specific timing, monitoring PDCCH when the first timer is running, and receiving a second message on the PDCCH in response to transmitting the first message, in accordance with embodiments of the present invention.

FIG. 14 is a flow diagram of a method of a UE comprising receiving a first signaling of triggering a random access procedure, wherein the first signaling indicates a first information associated with a specific device type of device types, and determining whether to trigger the random access procedure, in response to receiving the first signaling, based on at least whether the UE belongs to the specific device type associated with the first information, in accordance with embodiments of the present invention.

FIG. 15 is a flow diagram of a method of a UE comprising receiving a first signaling of triggering a random access procedure, triggering the random access procedure in response to receiving the first signaling, and performing a transmission indicating or providing a third information during the random access procedure, wherein the third information indicates a device type of the UE and the device type of the UE is differentiated by or associated with any of: a method to perform the transmission, equipped with amplification, energy storage, power level, and/or device size, in accordance with embodiments of the present invention.

### DETAILED DESCRIPTION

The invention described herein can be applied to or implemented in exemplary wireless communication systems and devices described below. In addition, the invention is described mainly in the context of the 3GPP architecture reference model. However, it is understood that with the disclosed information, one skilled in the art could easily adapt for use and implement aspects of the invention in a 3GPP2 network architecture as well as in other network architectures.

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A (Long Term Evolution Advanced) wireless access, 3GPP2 UMB (Ultra Mobile Broadband), WIMAX®, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: [1] RP-234058, “Study on solutions for Ambient IoT (Internet of Things) in NR.”; [2] 3GPP TR 38.848 V18.0.0 (2023-09) 3GPP; TSG RAN; Study on Ambient IoT (Internet of Things) in RAN (Release 18); [3] 3GPP TS 38.321 V17.6.0 (2023-09) 3GPP; TSG RAN; NR; MAC protocol specification (Release 17); [4] 3GPP TS 38.300 V17.6.0 (2023-09) 3GPP; TSG RAN; NR; NR and NG-RAN Overall Description (Release 17); [5] 3GPP TS 38.331 V17.6.0 (2023-09) 3GPP; TSG RAN; NR; RRC protocol specification (Release 17); and [6] 3GPP TS 38.213 V17.7.0 (2023-09) 3GPP; TSG RAN; NR; Physical layer procedures for control (Release 17). The standards and documents listed above are hereby expressly and fully incorporated herein by reference in their entirety.

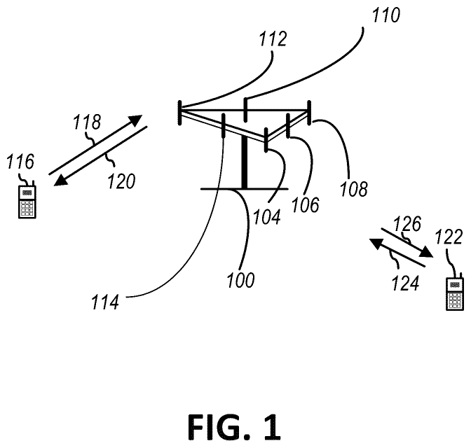

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal (AT) 116 is in communication with antennas 112 and 114, where antennas 112 and 114 transmit information to access terminal 116 over forward link 120 and receive information from AT 116 over reverse link 118. AT 122 is in communication with antennas 106 and 108, where antennas 106 and 108 transmit information to AT 122 over forward link 126 and receive information from AT 122 over reverse link 124. In a FDD system, communication links 118, 120, 124 and 126 may use different frequency for communication. For example, forward link 120 may use a different frequency than that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage normally causes less interference to access terminals in neighboring cells than an access network transmitting through a single antenna to all its access terminals.

The AN may be a fixed station or base station used for communicating with the terminals and may also be referred to as an access point, a Node B, a base station, an enhanced base station, an eNodeB, or some other terminology. The AT may also be called User Equipment (UE), a wireless communication device, terminal, access terminal or some other terminology.

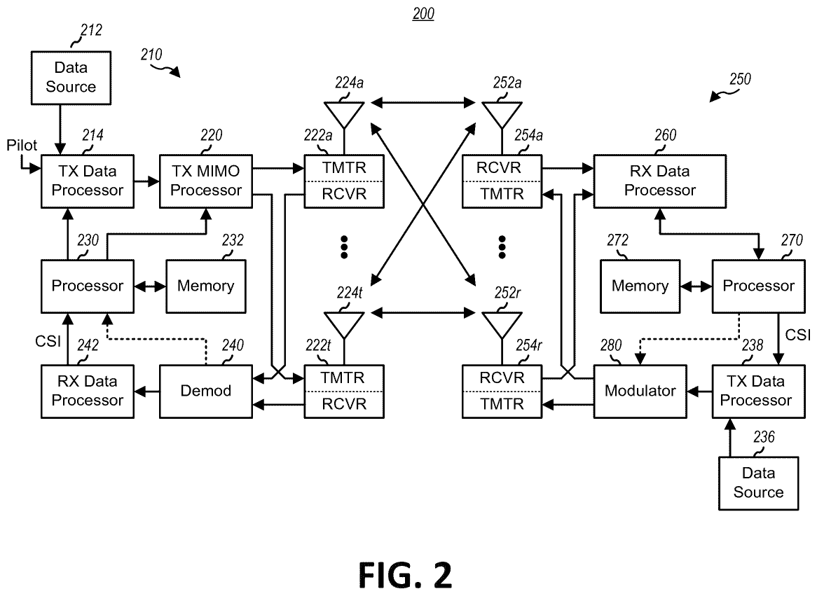

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230. A memory 232 is coupled to processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

Memory 232 may be used to temporarily store some buffered/computational data from 240 or 242 through Processor 230, store some buffed data from 212, or store some specific program codes. And Memory 272 may be used to temporarily store some buffered/computational data from 260 through Processor 270, store some buffed data from 236, or store some specific program codes.

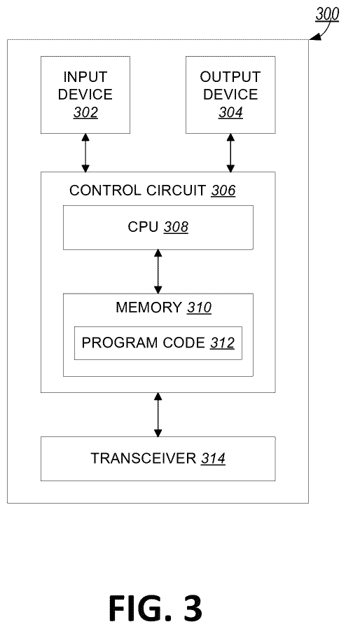

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

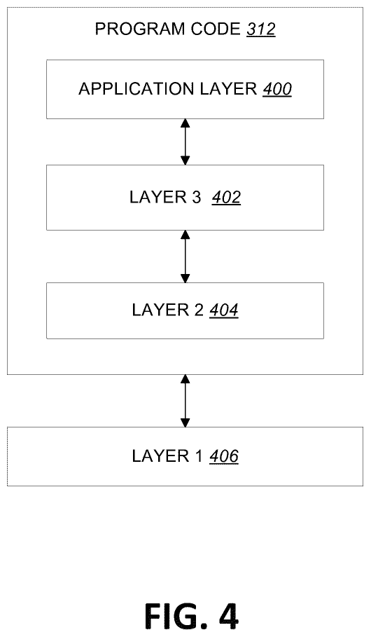

FIG. 4 is a simplified block diagram of the program code 312 shown in FIG. 3 in accordance with an embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

For LTE, LTE-A, or NR systems, the Layer 2 portion 404 may include a Radio Link Control (RLC) layer and a Medium Access Control (MAC) layer. The Layer 3 portion 402 may include a Radio Resource Control (RRC) layer.

Any two or more than two of the following paragraphs, (sub-) bullets, points, actions, or claims described in each invention paragraph or section may be combined logically, reasonably, and properly to form a specific method.

Any sentence, paragraph, (sub-) bullet, point, action, or claim described in each of the following invention paragraphs or sections may be implemented independently and separately to form a specific method or apparatus. Dependency, e.g., “based on”, “more specifically”, “example”, etc., in the following invention disclosure is just one possible embodiment which would not restrict the specific method or apparatus.

The study item of ambient Internet of Things (IoT) has been approved in RAN plenary #102 meeting. The description is specified in [1] RP-234058 as below:

### 3 Justification

In recent years, IoT has attracted much attention in the wireless communication world. More ‘things’ are expected to be interconnected for improving productivity efficiency and increasing comforts of life. Further reduction of size, complexity, and power consumption of IoT devices can enable the deployment of tens or even hundreds of billion IoT devices for various applications and provide added value across the entire value chain. It is impossible to power all the IoT devices by battery that needs to be replaced or recharged manually, which leads to high maintenance cost, serious environmental issues, and even safety hazards for some use cases (e.g., wireless sensor in electric power and petroleum industry).

Most of the existing wireless communication devices are powered by battery that needs to be replaced or recharged manually. The automation and digitalization of various industries open numbers of new markets requiring new IoT technologies of supporting batteryless devices with no energy storage capability or devices with energy storage that do not need to be replaced or recharged manually. The form factor of such devices must be reasonably small to convey the validity of target use cases.

TR 22.840 is being developed by SA1 to capture use cases, traffic scenarios, device constraints of ambient power-enabled Internet of Things and identify new potential service requirements as well as new KPIs. SA1 are considering devices being either battery-less or with limited energy storage capability (i.e., using a capacitor) and the energy is provided through the harvesting of radio waves, light, motion, heat, or any other power source that could be seen suitable.

Considering the limited size and complexity required by practical applications for batteryless devices with no energy storage capability or devices with limited energy storage that do not need to be replaced or recharged manually, the output power of energy harvester is typically from 1 μW to a few hundreds of μW. Existing cellular devices may not work well with energy harvesting due to their peak power consumption of higher than 10 mW.

An example type of application in TR 22.840 is asset identification, which presently has to resort mainly to barcode and RFID in most industries. The main advantage of these two technologies is the ultra-low complexity and small form factor of the tags. However, the limited reading range of a few meters usually requires handheld scanning which leads to labor intensive and time-consuming operations, or RFID portals/gates which leads to costly deployments. Moreover, the lack of interference management scheme results in severe interference between RFID readers and capacity problems, especially in case of dense deployment. It is hard to support large-scale network with seamless coverage for RFID.

TSG RAN has completed a Rel-18 RAN-level SI on Ambient IoT, which provides a terminological and scoping framework for future discussions of Ambient IoT. This has defined representative use cases, deployment scenarios, connectivity topologies, Ambient IoT devices, design targets, and required functionalities; it also conducted a preliminary feasibility assessment, and gave recommendations for down-selection in setting the scope of a further WG-level study.

Since existing technologies cannot meet all the requirements of target use cases, a new IoT technology is recommended to open new markets within 3GPP systems, whose number of connections and/or device density can be orders of magnitude higher than existing 3GPP IoT technologies. The new IoT technology shall provide complexity and power consumption orders of magnitude lower than the existing 3GPP LPWA technologies (e.g. NB-IoT and eMTC), and shall address use cases and scenarios that cannot otherwise be fulfilled based on existing 3GPP LPWA IoT technologies.

### 4 Objective

### 4.1 Objective of SI or Core Part WI or Testing Part WI

This study targets a further assessment at RAN WG-level of Ambient IoT, a new 3GPP IoT technology, suitable for deployment in a 3GPP system, which relies on ultra-low complexity devices with ultra-low power consumption for the very-low end IoT applications. The study shall provide clear differentiation, i.e. addressing use cases and scenarios that cannot otherwise be fulfilled based on existing 3GPP LPWA IoT technology e.g. NB-IoT including with reduced peak Tx power.

### General Scope

The definitions provided in TR 38.848 are taken into this SI, and the following are the exclusive general scope:
A. The overall objective shall be to study a harmonized air interface design with minimized differences (where necessary) for Ambient IoT to enable the following devices:
   i. ˜1 μW peak power consumption, has energy storage, initial sampling frequency offset (SFO) up to 10^{X} ppm, neither DL nor UL amplification in the device. The device's UL transmission is backscattered on a carrier wave provided externally.
   ii. ≤a few hundred μW peak power consumption¹, has energy storage, initial sampling frequency offset (SFO) up to 10^{X} ppm, both DL and/or UL amplification in the device. The device's UL transmission may be generated internally by the device, or be backscattered on a carrier wave provided externally.
   X is to be decided in WGs.
   Coverage design target: Maximum distance of 10-50 m with device indoors as per TR 38.848: “ . . . a range that WGs can sub-select within”.
   For Topologies 1 & 2 (UE as intermediate node under NW control) per TR 38.848, with no RRC states, no mobility (i.e. at least no cell selection/re-selection-like function), no HARQ, no ARQ.
   NOTE 1: It is to be understood that “≤a few hundred μW” means WGs are not tasked with setting a particular value, and that it will be for WG discussions to determine if a presented design with corresponding power consumption satisfies the “≤a few hundred μW” requirement.
B. Deployment Scenarios with the following characteristics, referenced to the tables in Clause 4.2.2 of TR 38.848:
   Deployment scenario 1 with Topology 1
      Basestation and coexistence characteristics: Micro-cell, co-site
   Deployment scenario 2 with Topology 2 and UE as intermediate node, under network control
      Basestation and coexistence characteristics: Macro-cell, co-site
      The location of intermediate node is indoor
C. FR1 licensed spectrum in FDD.
D. Spectrum deployment in-band to NR, in guard-band to LTE/NR, in standalone band(s).
E. Traffic types DO-DTT, DT, with focus on rUC1 (indoor inventory) and rUC4 (indoor command).
   From RAN #104, the study will assess whether the harmonized air interface design (per bullet ‘A’ above) can address the DO-A (Device-originated autonomous) use case, only to identify which part(s) of the harmonized air interface design (per bullet ‘A’ above) is/are not sufficient for the DO-A use case.

Transmission from Ambient IoT device (including backscattering when used) can occur at least in UL spectrum.

The following objectives are set, within the General Scope:
1. Evaluation assumptions
2. Study necessary and feasible solutions for Ambient IoT as prescribed in the General Scope, including decisions on which functions, procedures, etc. are needed and not needed, and ensuring at least the required functionalities in Section 6.2 of TR 38.848.
   RAN2-led:
      Study and decide which functions are needed for an Ambient IoT compact protocol stack and lightweight signalling procedure to enable DO-DTT and DT data transmission, and study those functions.
         For example:
         Paging.
         Random access
         Data transmission, including necessary radio resource control aspects, respecting the limitation in the General Scope
         Interactions with upper layers

The description for ambient IoT could be found in TR 38.848 ([2] 3GPP TR 38.848 V18.0.0 (2023-09)):

### 4.2.1 Connectivity Topologies

### 4.2.1.0 Introduction

The following connectivity topologies for Ambient IoT networks and devices are defined for the purposes of the study. In all these topologies, the Ambient IoT device may be provided with a carrier wave from other node(s) either inside or outside the topology. The links in each topology may be bidirectional or unidirectional.

BS, UE, assisting node, or intermediate node could be multiple BSs or UEs, respectively. The mixture of indoor and outdoor placement of such nodes is regarded as a network implementation choice. Account would need to be taken of potential impact on device or node complexity. In the connectivity topologies, this does not imply the existence of multi-hop assisting or intermediate nodes.

### 4.2.1.1 Topology 1: BS↔Ambient IoT Device

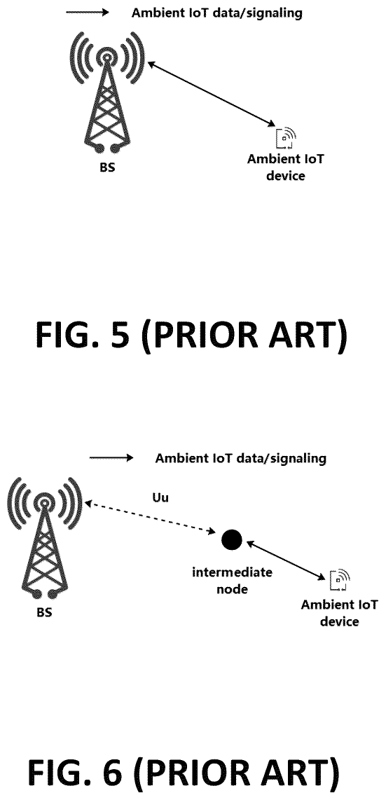

FIG. 5 is a Reproduction of FIG. 4.2.1.1-1: Topology 1, from 3GPP TR 38.848 V18.0.0.

In Topology 1, the Ambient IoT device directly and bidirectionally communicates with a basestation. The communication between the basestation and the ambient IoT device includes Ambient IoT data and/or signalling. This topology includes the possibility that the BS transmitting to the Ambient IoT device is a different from the BS receiving from the Ambient IoT device.

### 4.2.1.2 Topology 2: BS↔Intermediate Node↔Ambient IoT Device

FIG. 6 is a Reproduction of FIG. 4.2.1.2-1: Topology 2, from 3GPP TR 38.848 V18.0.0.

In Topology 2, the Ambient IoT device communicates bidirectionally with an intermediate node between the device and basestation. In this topology, the intermediate node can be a relay, IAB node, UE, repeater, etc. which is capable of Ambient IoT. The intermediate node transfers Ambient IoT data and/or signalling between BS and the Ambient IoT device.

### 4.3 Device Categorization

Ambient IoT devices are characterized in the study according to their energy storage capacity, and capability of generating RF signals for their transmissions.

The study considers that a device has either:
No energy storage at all; or
Limited energy storage

Relying on these storage capacities, the study considers the following set of Ambient IoT devices:
Device A: No energy storage, no independent signal generation/amplification, i.e. backscattering transmission.
Device B: Has energy storage, no independent signal generation, i.e. backscattering transmission. Use of stored energy can include amplification for reflected signals.
Device C: Has energy storage, has independent signal generation, i.e., active RF components for transmission.

A limited energy storage can be different among implementations within Device B or implementations within Device C, and different between Device B and Device C. Such storage is expected to be order(s) of magnitude smaller than an NB-IoT device would typically include.

The current random access (RA) procedure is specified in TS 38.321 ([3] 3GPP TS 38.321 V17.6.0 (2023-09)). The (current) RA procedure would be performed by a legacy UE:

### 5.1 Random Access Procedure

### 5.1.1 Random Access Procedure Initialization

The Random Access procedure described in this clause is initiated by a PDCCH order, by the MAC entity itself, or by RRC for the events in accordance with TS 38.300 [2]. There is only one Random Access procedure ongoing at any point in time in a MAC entity . . . .

When a Random Access procedure is initiated, UE selects a set of Random Access resources as specified in clause 5.1.1b and initialises the following parameters for the Random Access procedure according to the values configured by RRC for the selected set of Random Access resources:
prach-ConfigurationIndex: the available set of PRACH occasions for the transmission of the Random Access Preamble for Msg1. These are also applicable to the MSGA PRACH if the PRACH occasions are shared between 2-step and 4-step RA types;
1 msgA-PRACH-ConfigurationIndex: the available set of PRACH occasions for the transmission of the Random Access Preamble for MSGA in 2-step RA type;
preambleReceivedTargetPower: initial Random Access Preamble power for 4-step RA type;
msgA-PreambleReceivedTargetPower: initial Random Access Preamble power for 2-step RA type;
msgA-RSRP-ThresholdSSB: an RSRP threshold for the selection of the SSB for 2-step RA type;
rsrp-ThresholdSSB-SUL: an RSRP threshold for the selection between the NUL carrier and the SUL carrier;
msgA-RSRP-Threshold: an RSRP threshold for selection between 2-step RA type and 4-step RA type when both 2-step and 4-step RA type Random Access Resources are configured in the UL BWP;
rsrp-ThresholdMsg3: an RSRP threshold for Msg3 repetition (see clause 5.1.1b);
FeatureCombination: feature or a combination of features associated with a set of Random Access resources;
featurePriorities: priorities for features, such as RedCap, Slicing, etc. (see clause 5.1.1d);
msgA-TransMax: The maximum number of MSGA transmissions when both 4-step and 2-step RA type Random Access Resources are configured;
ra-PreambleIndex: Random Access Preamble;
ra-ssb-OccasionMaskIndex: defines PRACH occasion(s) associated with an SSB in which the MAC entity may transmit a Random Access Preamble (see clause 7.4);
msgA-SSB-SharedRO-MaskIndex: Indicates the subset of 4-step RA type PRACH occasions shared with 2-step RA type PRACH occasions for each SSB. If 2-step RA type PRACH occasions are shared with 4-step RA type PRACH occasions and msgA-SSB-SharedRO-MaskIndex is not configured, then all 4-step RA type PRACH occasions are available for 2-step RA type (see clause 7.4);
ssb-SharedRO-MaskIndex: defines PRACH occasions, on which preambles are allocated for a feature or a combination of features, associated with an SSB in which the MAC entity may transmit a Random Access Preamble (see clause 7.4);
ra-OccasionList: defines PRACH occasion(s) associated with a CSI-RS in which the MAC entity may transmit a Random Access Preamble;
ra-PreambleStartIndex: the starting index of Random Access Preamble(s) for on-demand SI request;
startPreambleForThisPartition: the first preamble associated with the set of Random Access Resources applicable to the Random Access procedure;
preambleTransMax: the maximum number of Random Access Preamble transmission;
msgA-PUSCH-ResourceGroupA: defines MSGA PUSCH resources that the UE shall use when performing MSGA transmission using Random Access Preambles group A;
msgA-PUSCH-ResourceGroupB: defines MSGA PUSCH resources that the UE shall use when performing MSGA transmission using Random Access Preambles group B;
msgA-PUSCH-Resource-Index: identifies the index of the PUSCH resource used for MSGA in case of contention-free Random Access with 2-step RA type;
ra-ResponseWindow: the time window to monitor RA response(s) (SpCell only);
ra-ContentionResolutionTimer: the Contention Resolution Timer (SpCell only);
msgB-ResponseWindow: the time window to monitor RA response(s) for 2-step RA type (SpCell only).

When the Random Access procedure is initiated on a Serving Cell, the MAC entity shall:
1> perform the BWP operation as specified in clause 5.15;
1> select the set of Random Access resources applicable to the current Random Access procedure according to clause 5.1.1b;
1> perform initialization of variables specific to Random Access type as specified in clause 5.1.1a;
1> if RA_TYPE is set to 2-stepRA:
   2> perform the Random Access Resource selection procedure for 2-step RA type (see clause 5.1.2a).
1> else:
   2> perform the Random Access Resource selection procedure (see clause 5.1.2).

### 5.1.1b Selection of the Set of Random Access Resources for the Random Access Procedure

The MAC entity shall:
1> if neither contention-free Random Access Resources nor Random Access Resources for SI request have been provided for this Random Access procedure and one or more of the features including RedCap and/or Slicing and/or SDT and/or MSG3 repetition is applicable for this Random Access procedure:
   2> if none of the sets of Random Access resources are available for any feature applicable to the current Random Access procedure (as specified in clause 5.1.1c):
      3> select the set(s) of Random Access resources that are not associated with any feature indication (as specified in clause 5.1.1c) for this Random Access procedure.
   2> else if there is one set of Random Access resources available which can be used for indicating all features triggering this Random Access procedure:
      3> select this set of Random Access resources for this Random Access procedure.
   2> else (i.e. there are one or more sets of Random Access resources available that are configured with indication(s) for a subset of all features triggering this Random Access procedure):
      3> select a set of Random Access resources from the available set(s) of Random Access resources based on the priority order indicated by upper layers as specified in clause 5.1.1d for this Random Access Procedure.
1> else if contention-free Random Access Resources have been provided for this Random Access procedure and RedCap is applicable for the current Random Access procedure and there is one set of Random Access resources available that is only configured with RedCap indication:
   2> select this set of Random Access resources for this Random Access procedure.
1> else:
   2> select the set of Random Access resources that are not associated with any feature indication (as specified in clause 5.1.1c) for the current Random Access procedure.

### 5.1.1c Availability of the Set of Random Access Resources

The MAC entity shall for each set of configured Random Access resources for 4-step RA type and for each set of configured Random Access resources for 2-step RA type:
1> if redCap is set to true for a set of Random Access resources:
   2> consider the set of Random Access resources as not available for a Random Access procedure for which RedCap is not applicable.
1> if smallData is set to true for a set of Random Access resources:
   2> consider the set of Random Access resources as not available for the Random Access procedure which is not triggered for RA-SDT.
1> if NSAG-List is configured for a set of Random Access resources:
   2> consider the set of Random Access resources as not available for the Random Access procedure unless it is triggered for any one of the NSAG-ID(s) in the NSAG-List.
1> if msg3-Repetitions is set to true for a set of Random Access resources:
   2> consider the set of Random Access resources as not available for the Random Access procedure if Msg3 repetition is not applicable.
1> if a set of Random Access resources is not configured with FeatureCombination:
   2> consider the set of Random Access resources to not associated with any feature.

### 5.1.2 Random Access Resource Selection

If the selected RA_TYPE is set to 4-stepRA, the MAC entity shall:
1> else if the ra-PreambleIndex has been explicitly provided by PDCCH; and
1> if the ra-PreambleIndex is not 0b000000:
   2> set the PREAMBLE_INDEX to the signalled ra-PreambleIndex;
   2> select the SSB signalled by PDCCH. Attorney Docket No.: 5328.142US02
1> else (i.e. for the contention-based Random Access preamble selection):
   2> if at least one of the SSBs with SS-RSRP above rsrp-ThresholdSSB is available:
      3> select an SSB with SS-RSRP above rsrp-ThresholdSSB.
   2> else:
      3> select any SSB.
   2> select a Random Access Preamble randomly with equal probability from the Random Access Preambles associated with the selected SSB and the selected Random Access Preambles group;
   2> set the PREAMBLE_INDEX to the selected Random Access Preamble.
1> else if an SSB is selected above:
   2> determine the next available PRACH occasion from the PRACH occasions corresponding to the selected SSB permitted by the restrictions given by the ra-ssb-OccasionMaskIndex if configured, or ssb-SharedRO-MaskIndex if configured, or indicated by PDCCH (the MAC entity shall select a PRACH occasion randomly with equal probability amongst the consecutive PRACH occasions according to clause 8.1 of TS 38.213 [6] regardless the FR2 UL gap, corresponding to the selected SSB; the MAC entity may take into account the possible occurrence of measurement gaps and MUSIM gaps when determining the next available PRACH occasion corresponding to the selected SSB).
1> perform the Random Access Preamble transmission procedure (see clause 5.1.3).

### 5.1.2a Random Access Resource Selection for 2-Step RA Type

If the selected RA_TYPE is set to 2-stepRA, the MAC entity shall:
1> if the contention-free 2-step RA type Resources associated with SSBs have been explicitly provided in rach-ConfigDedicated and at least one SSB with SS-RSRP above msgA-RSRP-ThresholdSSB amongst the associated SSBs is available:
   2> select an SSB with SS-RSRP above msgA-RSRP-ThresholdSSB amongst the associated SSBs;
   2> set the PREAMBLE_INDEX to a ra-PreambleIndex corresponding to the selected SSB.
1> else (i.e. for the contention-based Random Access Preamble selection):
   2> if at least one of the SSBs with SS-RSRP above msgA-RSRP-ThresholdSSB is available:
      3> select an SSB with SS-RSRP above msgA-RSRP-ThresholdSSB.
   2> else:
      3> select any SSB.
   2> select a Random Access Preamble randomly with equal probability from the 2-step RA type Random Access Preambles associated with the selected SSB and the selected Random Access Preambles group;
   2> set the PREAMBLE_INDEX to the selected Random Access Preamble.
1> determine the next available PRACH occasion from the PRACH occasions corresponding to the selected SSB permitted by the restrictions given by the msgA-SSB-SharedRO-MaskIndex if configured, or ra-ssb-OccasionMaskIndex if configured, or ssb-SharedRO-MaskIndex if configured (the MAC entity shall select a PRACH occasion randomly with equal probability among the consecutive PRACH occasions allocated for 2-step RA type according to clause 8.1 of TS 38.213 [6] regardless the FR2 UL gap, corresponding to the selected SSB; the MAC entity may take into account the possible occurrence of measurement gaps and MUSIM gaps when determining the next available PRACH occasion corresponding to the selected SSB);
1> if the Random Access Preamble was not selected by the MAC entity among the contention-based Random Access Preamble(s):
   2> select a PUSCH occasion from the PUSCH occasions configured in msgA-CFRA-PUSCH corresponding to the PRACH slot of the selected PRACH occasion, according to msgA-PUSCH-Resource-Index corresponding to the selected SSB;
   2> determine the UL grant and the associated HARQ information for the MSGA payload in the selected PUSCH occasion;
   2> deliver the UL grant and the associated HARQ information to the HARQ entity.
1> else:
   2> select a PUSCH occasion corresponding to the selected preamble and PRACH occasion according to clause 8.1A of TS 38.213 [6];
   2> determine the UL grant for the MSGA payload according to the PUSCH configuration associated with the selected Random Access Preambles group and determine the associated HARQ information;
   2> if the selected preamble and PRACH occasion is mapped to a valid PUSCH occasion as specified in clause 8.1A of TS 38.213 [6]:
      3> deliver the UL grant and the associated HARQ information to the HARQ entity.
1> perform the MSGA transmission procedure (see clause 5.1.3a).

### 5.1.3 Random Access Preamble Transmission

The MAC entity shall, for each Random Access Preamble:
1> if PREAMBLE_TRANSMISSION_COUNTER is greater than one; and
1> if the notification of suspending power ramping counter has not been received from lower layers; and
1> if LBT failure indication was not received from lower layers for the last Random Access Preamble transmission; and
   2> increment PREAMBLE_POWER_RAMPING_COUNTER by 1.
1> except for contention-free Random Access Preamble for beam failure recovery request, compute the RA-RNTI associated with the PRACH occasion in which the Random Access Preamble is transmitted;
1> instruct the physical layer to transmit the Random Access Preamble using the selected PRACH occasion, corresponding RA-RNTI (if available), PREAMBLE_INDEX, and PREAMBLE_RECEIVED_TARGET_POWER.

### 5.1.3a MSGA Transmission

The MAC entity shall, for each MSGA:
1> if PREAMBLE_TRANSMISSION_COUNTER is greater than one; and
1> if the notification of suspending power ramping counter has not been received from lower layers; and
1> if LBT failure indication was not received from lower layers for the last MSGA Random Access Preamble transmission; and
1> if SSB selected is not changed from the selection in the last Random Access Preamble transmission:
   2> increment PREAMBLE_POWER_RAMPING_COUNTER by 1.
1> if this is the first MSGA transmission within this Random Access procedure:
   2> if the transmission is not being made for the CCCH logical channel:
      3> indicate to the Multiplexing and assembly entity to include a C-RNTI MAC CE in the subsequent uplink transmission.
   2> if the Random Access procedure was initiated for SpCell beam failure recovery and spCell-BFR-CBRA with value true is configured:
      3> if there is at least one Serving Cell of this MAC entity configured with two BFD-RS sets:
         4> indicate to the Multiplexing and assembly entity to include an Enhanced BFR MAC CE or a Truncated Enhanced BFR MAC CE in the subsequent uplink transmission.
      3> else:
         4> indicate to the Multiplexing and assembly entity to include a BFR MAC CE or a Truncated BFR MAC CE in the subsequent uplink transmission.
   2> else if the Random Access procedure was initiated for beam failure recovery of both BFD-RS sets of SpCell:
      3> indicate to the Multiplexing and assembly entity to include an Enhanced BFR MAC CE or a Truncated Enhanced BFR MAC CE in the subsequent uplink transmission.
   2> obtain the MAC PDU to transmit from the Multiplexing and assembly entity according to the HARQ information determined for the MSGA payload (see clause 5.1.2a) and store it in the MSGA buffer.
1> compute the MSGB-RNTI associated with the PRACH occasion in which the Random Access Preamble is transmitted;
1> instruct the physical layer to transmit the MSGA using the selected PRACH occasion and the associated PUSCH resource of MSGA (if the selected preamble and PRACH occasion is mapped to a valid PUSCH occasion), using the corresponding RA-RNTI, MSGB-RNTI, PREAMBLE_INDEX, PREAMBLE_RECEIVED_TARGET_POWER, msgA-PreambleReceivedTargetPower, and the amount of power ramping applied to the latest MSGA preamble transmission (i.e. (PREAMBLE_POWER_RAMPING_COUNTER−1)×PREAMBLE_POWER_RAMPING_STEP);

### 5.1.4 Random Access Response Reception

Once the Random Access Preamble is transmitted and regardless of the possible occurrence of a measurement gap, the MAC entity shall:
3> start the ra-Response Window configured in RACH-ConfigCommon at the first PDCCH occasion as specified in TS 38.213 [6] from the end of the Random Access Preamble transmission.
2> monitor the PDCCH of the SpCell for Random Access Response(s) identified by the RA-RNTI while the ra-Response Window is running.
1> if notification of a reception of a PDCCH transmission on the search space indicated by recoverySearchSpaceld is received from lower layers on the Serving Cell where the preamble was transmitted; and
1> if PDCCH transmission is addressed to the C-RNTI; and
1> if the contention-free Random Access Preamble for beam failure recovery request was transmitted by the MAC entity:
   2> consider the Random Access procedure successfully completed.
1> else if a valid (as specified in TS 38.213 [6]) downlink assignment has been received on the PDCCH for the RA-RNTI and the received TB is successfully decoded:
   2> if the Random Access Response contains a MAC subPDU with Random Access Preamble identifier corresponding to the transmitted PREAMBLE_INDEX (see clause 5.1.3):
      3> consider this Random Access Response reception successful.
   2> if the Random Access Response reception is considered successful:
      3> if the Random Access Response includes a MAC subPDU with RAPID only:
         4> consider this Random Access procedure successfully completed;
         4> indicate the reception of an acknowledgement for SI request to upper layers.
      3> else:
         4> apply the following actions for the Serving Cell where the Random Access Preamble was transmitted:
         6> process the received UL grant value and indicate it to the lower layers.
         4> if the Random Access Preamble was not selected by the MAC entity among the contention-based Random Access Preamble(s):
         5> consider the Random Access procedure successfully completed.
         4> else:
         5> set the TEMPORARY_C-RNTI to the value received in the Random Access Response;
         5> if this is the first successfully received Random Access Response within this Random Access procedure:
         6> if the transmission is not being made for the CCCH logical channel:
         7> indicate to the Multiplexing and assembly entity to include a C-RNTI MAC CE in the subsequent uplink transmission.
         6> obtain the MAC PDU to transmit from the Multiplexing and assembly entity and store it in the Msg3 buffer.

### 5.1.4a MSGB Reception and Contention Resolution for 2-Step RA Type

Once the MSGA preamble is transmitted, regardless of the possible occurrence of a measurement gap, the MAC entity shall:
1> start the msgB-ResponseWindow at the PDCCH occasion as specified in TS 38.213 [6], clause 8.2A;
1> monitor the PDCCH of the SpCell for a Random Access Response identified by MSGB-RNTI while the msgB-ResponseWindow is running;
1> if C-RNTI MAC CE was included in the MSGA:
   2> monitor the PDCCH of the SpCell for Random Access Response identified by the C-RNTI while the msgB-ResponseWindow is running.
1> if notification of a reception of a PDCCH transmission of the SpCell is received from lower layers:
   2> if the C-RNTI MAC CE was included in MSGA:
      3> if the Random Access procedure was initiated for SpCell beam failure recovery or for beam failure recovery of both BFD-RS sets of SpCell (as specified in clause 5.17) and the PDCCH transmission is addressed to the C-RNTI:
         4> consider this Random Access Response reception successful;
         4> stop the msgB-Response Window;
         4> consider this Random Access procedure successfully completed.
      3> else:
         4> if a downlink assignment has been received on the PDCCH for the C-RNTI and the received TB is successfully decoded:
         5> if the MAC PDU contains the Absolute Timing Advance Command MAC CE:
         6> process the received Timing Advance Command (see clause 5.2);
         6> consider this Random Access Response reception successful;
         6> stop the msgB-ResponseWindow;
         6> consider this Random Access procedure successfully completed and finish the disassembly and demultiplexing of the MAC PDU.
   2> if a valid (as specified in TS 38.213 [6]) downlink assignment has been received on the PDCCH for the MSGB-RNTI and the received TB is successfully decoded:
      3> if the MSGB contains a fallbackRAR MAC subPDU; and
      3> if the Random Access Preamble identifier in the MAC subPDU matches the transmitted PREAMBLE_INDEX (see clause 5.1.3a):
         4> consider this Random Access Response reception successful;
         4> apply the following actions for the SpCell:
         5> if the Random Access Preamble was not selected by the MAC entity among the contention-based Random Access Preamble(s):
         6> consider the Random Access procedure successfully completed;
         6> process the received UL grant value and indicate it to the lower layers.
         5> else:
         6> set the TEMPORARY_C-RNTI to the value received in the Random Access Response;
         6> if the Msg3 buffer is empty:
         7> obtain the MAC PDU to transmit from the MSGA buffer and store it in the Msg3 buffer;
         6> process the received UL grant value and indicate it to the lower layers and proceed with Msg3 transmission.
      3> else if the MSGB contains a successRAR MAC subPDU; and
      3> if the CCCH SDU was included in the MSGA and the UE Contention Resolution Identity in the MAC subPDU matches the CCCH SDU:
         4> stop msgB-Response Window;
         5> set the C-RNTI to the value received in the successRAR;
         4> consider this Random Access Response reception successful;
         4> consider this Random Access procedure successfully completed;

### 5.1.5 Contention Resolution

Once Msg3 is transmitted the MAC entity shall:
1> else if Msg3 transmission (i.e. initial transmission or HARQ retransmission) is transmitted on a non-terrestrial network:
   2> start or restart the ra-ContentionResolutionTimer in the first symbol after the end of the Msg3 transmission plus the UE-gNB RTT.
1> else:
   2> start or restart the ra-ContentionResolutionTimer in the first symbol after the end of the Msg3 transmission.
1> monitor the PDCCH while the ra-ContentionResolutionTimer is running regardless of the possible occurrence of a measurement gap;
1> if notification of a reception of a PDCCH transmission of the SpCell is received from lower layers:
   2> if the C-RNTI MAC CE was included in Msg3:
      3> if the Random Access procedure was initiated by a PDCCH order and the PDCCH transmission is addressed to the C-RNTI; or
      3> if the Random Access procedure was initiated by the MAC sublayer itself or by the RRC sublayer and the PDCCH transmission is addressed to the C-RNTI and contains a UL grant for a new transmission:
         4> consider this Contention Resolution successful;
         4> stop ra-ContentionResolutionTimer;
         4> discard the TEMPORARY_C-RNTI;
         4> consider this Random Access procedure successfully completed.
   2> else if the CCCH SDU was included in Msg3 and the PDCCH transmission is addressed to its TEMPORARY_C-RNTI:
      3> if the MAC PDU is successfully decoded:
         4> stop ra-ContentionResolutionTimer;
         4> if the MAC PDU contains a UE Contention Resolution Identity MAC CE; and
         4> if the UE Contention Resolution Identity in the MAC CE matches the CCCH SDU transmitted in Msg3:
         5> consider this Contention Resolution successful and finish the disassembly and demultiplexing of the MAC PDU;
         6> set the C-RNTI to the value of the TEMPORARY_C-RNTI;
         5> discard the TEMPORARY_C-RNTI;
         5> consider this Random Access procedure successfully completed.
         4> else:
         5> discard the TEMPORARY_C-RNTI;
         5> consider this Contention Resolution not successful and discard the successfully decoded MAC PDU.

The general description of RA procedures is specified in TS 38.300 ([4] 3GPP TS 38.300 V17.6.0 (2023-09)):

### 9.2.6 Random Access Procedure

The random access procedure is triggered by a number of events:
Initial access from RRC_IDLE;
SDT in RRC_INACTIVE (see clause 18);

Two types of random access procedure are supported: 4-step RA type with MSG1 and 2-step RA type with MSGA. Both types of RA procedure support contention-based random access (CBRA) and contention-free random access (CFRA) as shown on FIG. 9.2.6-1 below.

The UE selects the type of random access at initiation of the random access procedure based on network configuration:
when CFRA resources are not configured, an RSRP threshold is used by the UE to select between 2-step RA type and 4-step RA type;
when CFRA resources for 4-step RA type are configured, UE performs random access with 4-step RA type;
when CFRA resources for 2-step RA type are configured, UE performs random access with 2-step RA type.

The network does not configure CFRA resources for 4-step and 2-step RA types at the same time for a Bandwidth Part (BWP). CFRA with 2-step RA type is only supported for handover.

The MSG1 of the 4-step RA type consists of a preamble on PRACH. After MSG1 transmission, the UE monitors for a response from the network within a configured window. For CFRA, dedicated preamble for MSG1 transmission is assigned by the network and upon receiving random access response from the network, the UE ends the random access procedure as shown in FIG. 9.2.6-1 (c). For CBRA, upon reception of the random access response, the UE sends MSG3 using the UL grant scheduled in the response and monitors contention resolution as shown in FIG. 9.2.6-1 (a). If contention resolution is not successful after MSG3 (re)transmission(s), the UE goes back to MSG1 transmission.

The MSGA of the 2-step RA type includes a preamble on PRACH and a payload on PUSCH. After MSGA transmission, the UE monitors for a response from the network within a configured window. For CFRA, dedicated preamble and PUSCH resource are configured for MSGA transmission and upon receiving the network response, the UE ends the random access procedure as shown in FIG. 9.2.6-1 (d). For CBRA, if contention resolution is successful upon receiving the network response, the UE ends the random access procedure as shown in FIG. 9.2.6-1 (b); while if fallback indication is received in MSGB, the UE performs MSG3 transmission using the UL grant scheduled in the fallback indication and monitors contention resolution as shown in FIG. 9.2.6-2. If contention resolution is not successful after MSG3 (re)transmission(s), the UE goes back to MSGA transmission.

If the random access procedure with 2-step RA type is not completed after a number of MSGA transmissions, the UE can be configured to switch to CBRA with 4-step RA type.

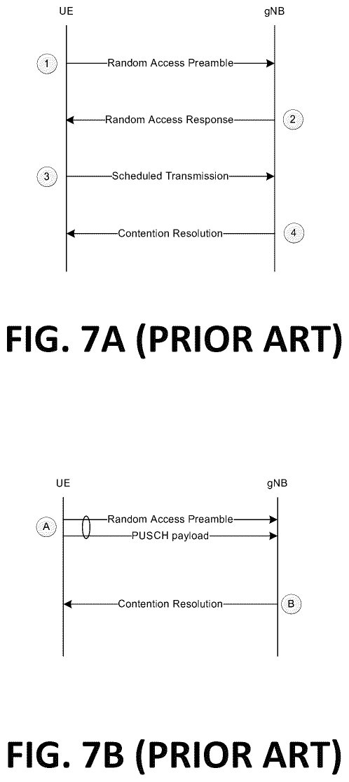

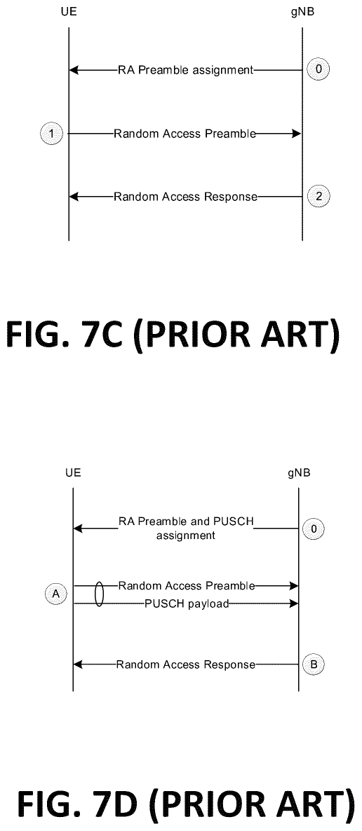

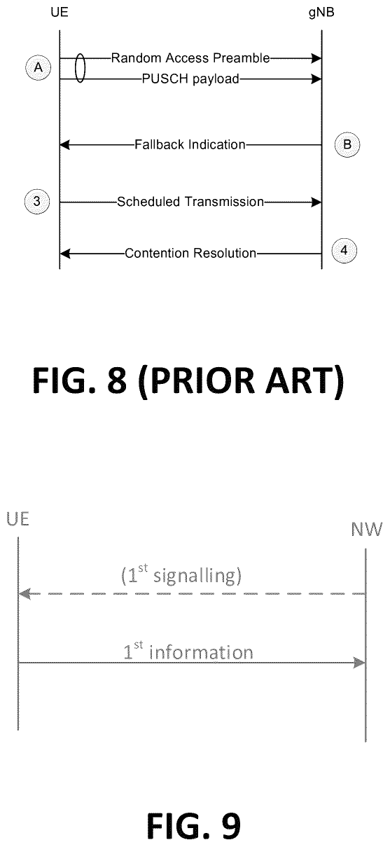

FIG. 7A is a Reproduction of FIG. 9.2.6-1: Random Access Procedures—(a) CBRA with 4-Step RA Type, from 3GPP TS 38.300 V17.6.0.
FIG. 7B is a Reproduction of FIG. 9.2.6-1: Random Access Procedures—(b) CBRA with 2-Step RA Type, from 3GPP TS 38.300 V17.6.0.
FIG. 7C is a Reproduction of FIG. 9.2.6-1: Random Access Procedures—(c) CFRA with 4-Step RA Type, from 3GPP TS 38.300 V17.6.0.
FIG. 7D is a Reproduction of FIG. 9.2.6-1: Random Access Procedures—(d) CFRA with 2-Step RA Type, from 3GPP TS 38.300 V17.6.0.
FIG. 8 is a Reproduction of FIG. 9.2.6-2: Fallback for CBRA with 2-Step RA Type, from 3GPP TS 38.300 V17.6.0.

For random access in a cell configured with SUL, the network can explicitly signal which carrier to use (UL or SUL). Otherwise, the UE selects the SUL carrier if and only if the measured quality of the DL is lower than a broadcast threshold. UE performs carrier selection before selecting between 2-step and 4-step RA type. The RSRP threshold for selecting between 2-step and 4-step RA type can be configured separately for UL and SUL. Once started, all uplink transmissions of the random access procedure remain on the selected carrier.

The network can associate a set of RACH resources with feature(s) applicable to a Random Access procedure: Network Slicing (see clause 16.3), RedCap (see clause 16.13), SDT (see clause 18), and N_{R} coverage enhancement (see clause 19). A set of RACH resources associated with a feature is only valid for random access procedures applicable to at least that feature; and a set of RACH resources associated with several features is only valid for random access procedures having at least all of these features. The UE selects the set(s) of applicable RACH resources, after uplink carrier (i.e. NUL or SUL) and BWP selection and before selecting the RA type.

Some configurations related to RA in current standard are specified in TS 38.331 ([5] 3GPP TS 38.331 V17.6.0 (2023-09)):

### Paging

The Paging message is used for the notification of one or more UEs.

### Direction: Network to UE

Paging message

| | |
|---|---|
| Paging ::= | SEQUENCE { |
| pagingRecordList | PagingRecordList |

OPTIONAL, -- Need N
...
}

| | |
|---|---|
| Paging-v1700-IEs ::= | SEQUENCE { |
| pagingRecordList-v1700 | PagingRecordList-v1700 |

OPTIONAL, -- Need N
...
}

| | |
|---|---|
| PagingRecordList ::= | SEQUENCE (SIZE(1..maxNrofPageRec)) OF PagingRecord |
| PagingRecordList-v1700 ::= | SEQUENCE (SIZE(1..maxNrofPageRec)) OF PagingRecord-v1700 |

...

| PagingRecord ::= | SEQUENCE { | |
|---|---|---|
| ue-Identity | PagingUE-Identity, | |
| accessType | ENUMERATED {non3GPP} | OPTIONAL, -- Need N |

...
}

| PagingRecord-v1700 ::= | SEQUENCE { | |
|---|---|---|
| pagingCause-r17 | ENUMERATED {voice} | OPTIONAL -- Need N |

}

| | |
|---|---|
| PagingUE-Identity ::= | CHOICE { |
| ng-5G-S-TMSI | NG-5G-S-TMSI, |
| fullI-RNTI | I-RNTI-Value, |

...
}
PagingRecord field descriptions
accessType
Indicates whether the Paging message is originated due to the PDU sessions from the non-3GPP access.
pagingCause
Indicates whether the Paging message is originated due to IMS voice. If this field is present, it implies that the
corresponding paging entry is for IMS voice. If upper layers indicate the support of paging cause and if this field is not
present but paging RecordList-v1700 is present, it implies that the corresponding paging entry is for a service other than
IMS voice. Otherwise, paging cause is undetermined.

### BWP-UplinkCommon

The IE BWP-UplinkCommon is used to configure the common parameters of an uplink BWP. They are “cell specific” and the network ensures the necessary alignment with corresponding parameters of other UEs. The common parameters of the initial bandwidth part of the PCell are also provided via system information. For all other serving cells, the network provides the common parameters via dedicated signalling.

BWP-UplinkCommon information element

| | |
|---|---|
| BWP-UplinkCommon ::= | SEQUENCE { |
| genericParameters | BWP, |
| rach-ConfigCommon | SetupRelease { RACH-ConfigCommon } |

OPTIONAL, -- Need M
...

| | |
|---|---|
| msgA-ConfigCommon-r16 | SetupRelease { MsgA-ConfigCommon-r16 } |

OPTIONAL -- Cond SpCellOnly2
...

| | |
|---|---|
| additionalRACH-ConfigList-r17 | SetupRelease { AdditionalRACH-ConfigList-r17 } |

OPTIONAL, -- Cond SpCellOnly2

| | |
|---|---|
| rsrp-ThresholdMsg3-r17 | RSRP-Range |

OPTIONAL, -- Need R

| | |
|---|---|
| numberOfMsg3-RepetitionsList-r17 | SEQUENCE (SIZE (4)) OF NumberOfMsg3-Repetitions-r17 |

OPTIONAL, -- Cond Msg3Rep
...
}

| | |
|---|---|
| AdditionalRACH-ConfigList-r17 ::= | SEQUENCE (SIZE(1..maxAdditionalRACH-r17)) OF AdditionalRACH- |

Config-r17

| | |
|---|---|
| AdditionalRACH-Config-r17 ::= | SEQUENCE { |
| rach-ConfigCommon-r17 | RACH-ConfigCommon |

OPTIONAL, -- Need R

| | |
|---|---|
| msgA-ConfigCommon-r17 | MsgA-ConfigCommon-r16 |

OPTIONAL, -- Need R
...
}

| | |
|---|---|
| NumberOfMsg3-Repetitions-r17::= | ENUMERATED {n1, n2, n3, n4, n7, n8, n12, n16} |

BWP-UplinkCommon field descriptions
additionalRACH-ConfigList
List of feature or feature combination-specific RACH configurations, i.e. the RACH configurations configured in addition
to the one configured by rach-ConfigCommon and by msgA-ConfigCommon. The network associates all possible
preambles of an additional RACH configuration to one or more feature(s) or feature combination(s). The network does
not configure this list to have more than 16 entries. If both rach-ConfigCommon and msgA-ConfigCommon are
configured for a specific FeatureCombination, the network always provides them in the same additionalRACH-Config.
msgA-ConfigCommon
Configuration of the cell specific PRACH and PUSCH resource parameters for transmission of MsgA in 2-step random
access type procedure. The NW can configure msgA-ConfigCommon only for UL BWPs if the linked DL BWPs (same
bwp-Id as UL-BWP) are the initial DL BWPs or DL BWPs containing the SSB associated to the initial DL BWP or for
RedCap UEs DL BWPs associated with nonCellDefiningSSB or the RedCap-specific initial downlink BWP.
rach-ConfigCommon
Configuration of cell specific random access parameters which the UE uses for contention based and contention free
random access as well as for contention based beam failure recovery in this BWP. The NW configures SSB-based RA
(and hence RACH-ConfigCommon) only for UL BWPs if the linked DL BWPs (same bwp-Id as UL-BWP) are the initial DL
BWPs or DL BWPs containing the SSB associated to the initial DL BWP or for RedCap UEs DL BWPs associated with
nonCellDefiningSSB or the RedCap-specific initial downlink BWP. The network configures rach-ConfigCommon,
whenever it configures contention free random access (for reconfiguration with sync or for beam failure recovery). For
RedCap-specific initial uplink BWP, rach-ConfigCommon is always configured when msgA-ConfigCommon is configured
in this BWP.

### MsgA-ConfigCommon

The IE MsgA-ConfigCommon is used to configure the PRACH and PUSCH resource for transmission of MsgA in 2-step random access type procedure.

### MsgA-PUSCH-Config

The IE MsgA-PUSCH-Config is used to specify the PUSCH allocation for MsgA in 2-step random access type procedure.

### RACH-ConfigGeneric

The IE RACH-ConfigGeneric is used to specify the random-access parameters both for regular random access as well as for beam failure recovery.

### RACH-ConfigGenericTwoStepRA

The IE RACH-ConfigGenericTwoStepRA is used to specify the 2-step random access type parameters.

In TS 38.213 ([6] 3GPP TS 38.213 V17.7.0 (2023-09)), RA procedure is specified:

### 8 Random Access Procedure

Prior to initiation of the physical random access procedure, Layer 1 receives from higher layers a set of SS/PBCH block indexes and provides to higher layers a corresponding set of RSRP measurements.

Prior to initiation of the physical random access procedure, Layer 1 may receive from higher layers an indication to perform a Type-1 random access procedure, as described in clauses 8.1 through 8.4, or a Type-2 random access procedure as described in clauses 8.1 through 8.2A.

Prior to initiation of the physical random access procedure, Layer 1 receives the following information from the higher layers:
Configuration of physical random access channel (PRACH) transmission parameters (PRACH preamble format, time resources, and frequency resources for PRACH transmission).
Parameters for determining the root sequences and their cyclic shifts in the PRACH preamble sequence set (index to logical root sequence table, cyclic shift (N_{CS}), and set type (unrestricted, restricted set A, or restricted set B)).

From the physical layer perspective, the Type-1 L1 random access procedure includes the transmission of random access preamble (Msg1) in a PRACH, random access response (RAR) message with a PDCCH/PDSCH (Msg2), and when applicable, the transmission of a PUSCH scheduled by a RAR UL grant, and PDSCH for contention resolution.

From the physical layer perspective, the Type-2 L1 random access procedure includes the transmission of random access preamble in a PRACH and of a PUSCH (MsgA) and the reception of a RAR message with a PDCCH/PDSCH (MsgB), and when applicable, the transmission of a PUSCH scheduled by a fallback RAR UL grant, and PDSCH for contention resolution.

If a random access procedure is initiated by a PDCCH order to the UE, a PRACH transmission is with a same SCS as a PRACH transmission initiated by higher layers.

If a UE is configured with two UL carriers for a serving cell and the UE detects a PDCCH order, the UE uses the

UL/SUL indicator field value from the detected PDCCH order to determine the UL carrier for the corresponding PRACH transmission.

### 8.1 Random Access Preamble

Physical random access procedure is triggered upon request of a PRACH transmission by higher layers or by a PDCCH order. A configuration by higher layers for a PRACH transmission includes the following:
A configuration for PRACH transmission [4, TS 38.211].
A preamble index, a preamble SCS, P_{PRACH,target}, a corresponding RA-RNTI, and a PRACH resource.

A PRACH is transmitted using the selected PRACH format with transmission power P_{PRACH,b,f,c} (i), as described in clause 7.4, on the indicated PRACH resource.

For a PRACH transmission by a UE triggered by a PDCCH order, the PRACH mask index field [5, TS 38.212], if the value of the random access preamble index field is not zero, indicates the PRACH occasion for the PRACH transmission where the PRACH occasions are associated with the SS/PBCH block index indicated by the SS/PBCH block index field of the PDCCH order. If the UE is provided K_{cell,offset} by cellSpecificKoffset, the PRACH occasion is after slot n+2^{μ}·K_{cell,offset} where n is the slot of the UL BWP for the PRACH transmission that overlaps with the end of the PDCCH order reception assuming T_{TA}=0, and μ is the SCS configuration for the PRACH transmission. If the PDCCH reception for the PDCCH order includes two PDCCH candidates from two linked search space sets based on searchSpaceLinkingId, as described in clause 10.1, the last symbol of the PDCCH reception is the last symbol of the PDCCH candidate that ends later. The PDCCH reception includes the two PDCCH candidates also when the UE is not required to monitor one of the two PDCCH candidates as described in clauses 10 (except clause 10.4), 11.1, 11.1.1 and 17.2.

For the indicated preamble index, the ordering of the PRACH occasions is
First, in increasing order of frequency resource indexes for frequency multiplexed PRACH occasions
Second, in increasing order of time resource indexes for time multiplexed PRACH occasions within a PRACH slot
Third, in increasing order of indexes for PRACH slots

### 8.1a PUSCH for Type-2 Random Access Procedure

For a Type-2 random access procedure, a UE transmits a PUSCH, when applicable, after transmitting a PRACH. The UE encodes a transport block provided for the PUSCH transmission using redundancy version number 0. The PUSCH transmission is after the PRACH transmission by at least N symbols where N=2 for μ=0 or μ=1, N=4 for μ=2 or μ=3, N=16 for μ=5, N=32 for μ=6, and u is the SCS configuration for the active UL BWP.

A UE does not transmit a PUSCH in a PUSCH occasion if the PUSCH occasion associated with a DMRS resource is not mapped to a preamble of valid PRACH occasions or if the associated PRACH preamble is not transmitted as described in clause 7.5 or clause 11.1 or clause 15 or clause 17.2. A UE can transmit a PRACH preamble in a valid PRACH occasion if the PRACH preamble is not mapped to a valid PUSCH occasion.

A mapping between one or multiple PRACH preambles and a PUSCH occasion associated with a DMRS resource is per PUSCH configuration provided by MsgA-PUSCH-Resource.

A UE determines time resources and frequency resources for PUSCH occasions in an active UL BWP from msgA-PUSCH-Config or separateMsgA-PUSCH-Config for the active UL BWP. If the active UL BWP is not the initial UL BWP and msgA-PUSCH-Config or separateMsgA-PUSCH-Config is not provided for the active UL BWP, the UE uses the msgA-PUSCH-Config or separateMsgA-PUSCH-Config provided for the initial UL BWP.

A PUSCH occasion for PUSCH transmission is defined by a frequency resource and a time resource, and is associated with a DMRS resource. The DMRS resources are provided by msgA-DMRS-Config.

Each consecutive number of N_{preamble} preamble indexes from valid PRACH occasions in a PRACH slot
first, in increasing order of preamble indexes within a single PRACH occasion
second, in increasing order of frequency resource indexes for frequency multiplexed PRACH occasions
third, in increasing order of time resource indexes for time multiplexed PRACH occasions within a PRACH slot are mapped to a valid PUSCH occasion and the associated DMRS resource
first, in increasing order of frequency resource indexes f_{id} for frequency multiplexed PUSCH occasions
second, in increasing order of DMRS resource indexes within a PUSCH occasion, where a DMRS resource index DMRS_{id} is determined first in an ascending order of a DMRS port index and second in an ascending order of a DMRS sequence index [4, TS 38.211]
third, in increasing order of time resource indexes t_{id} for time multiplexed PUSCH occasions within a PUSCH slot
fourth, in increasing order of indexes for Nₛ PUSCH slots
   where N_{preamble}=ceil(T_{preamble}/T_{PUSCH}), T_{preamble} is a total number of valid PRACH occasions per association pattern period multiplied by the number of preambles per valid PRACH occasion provided by rach-ConfigCommonTwoStepRA, and T_{PUSCH} is a total number of valid PUSCH occasions per PUSCH configuration per association pattern period multiplied by the number of DMRS resource indexes per valid PUSCH occasion provided by msgA-DMRS-Config.

A PUSCH occasion is valid if it does not overlap in time and frequency with any valid PRACH occasion associated with either a Type-1 random access procedure or a Type-2 random access procedure . . . .

### 8.2 Random Access Response-Type-1 Random Access Procedure

In response to a PRACH transmission, a UE attempts to detect a DCI format 1_0 with CRC scrambled by a corresponding RA-RNTI during a window controlled by higher layers [11, TS 38.321]. The window starts at the first symbol of the earliest CORESET the UE is configured to receive PDCCH for Type1-PDCCH CSS set, as defined in clause 10.1, that is at least one symbol, after the last symbol of the PRACH occasion corresponding to the PRACH transmission, where the symbol duration corresponds to the SCS for Type1-PDCCH CSS set as defined in clause 10.1. If N_{TA,adj}^{UE} or N_{TA,adj}^{common}, as defined in [4, TS 38.211], is not zero, the window starts after an additional T_{TA}+k_{mac} msec where T_{TA} is defined in [4, TS 38.211] and k_{mac} is provided by k_{mac} or k_{mac}=0 if k_{mac} is not provided. The length of the window in number of slots, based on the SCS for Type1-PDCCH CSS set, is provided by ra-ResponseWindow.

If the UE detects the DCI format 1_0 with CRC scrambled by the corresponding RA-RNTI and LSBs of a SFN field in the DCI format 1_0, if included and applicable, are same as corresponding LSBs of the SFN where the UE transmitted PRACH, and the UE receives a transport block in a corresponding PDSCH within the window, the UE passes the transport block to higher layers. The higher layers parse the transport block for a random access preamble identity (RAPID) associated with the PRACH transmission. If the higher layers identify the RAPID in RAR message(s) of the transport block, the higher layers indicate an uplink grant to the physical layer. This is referred to as random access response (RAR) UL grant in the physical layer.

A RAR UL grant schedules a PUSCH transmission from the UE. The contents of the RAR UL grant, starting with the MSB and ending with the LSB, are given in Table 8.2-1.

If the value of the frequency hopping flag is 0, the UE transmits the PUSCH without frequency hopping; otherwise, the UE transmits the PUSCH with frequency hopping.

The UE determines the MCS of the PUSCH transmission from the first sixteen indexes of the applicable MCS index table for PUSCH as described in [6, TS 38.214].

TABLE 8.2-1
Random Access Response Grant Content field size

| RAR grant field | Number of bits |
|---|---|
| Frequency hopping flag | 1 |
| PUSCH frequency | 12, for operation with shared spectrum |
| resource allocation | channel access in FR1 or for FR2-2 when |
| | ChannelAccessMode2-r17 is provided |
| | 14, otherwise |
| PUSCH time resource | 4 |
| allocation | |
| MCS | 4 |
| TPC command for PUSCH | 3 |
| CSI request | 1 |
| ChannelAccess-CPext | 2, for operation with shared spectrum |
| | channel access in FR1 or for FR2-2 when |
| | ChannelAccessMode2-r17 is provided |
| | 0, otherwise |

### 8.2A Random Access Response-Type-2 Random Access Procedure

In response to a transmission of a PRACH and a PUSCH, or to a transmission of only a PRACH if the PRACH preamble is mapped to a valid PUSCH occasion, a UE attempts to detect a DCI format 1_0 with CRC scrambled by a corresponding MsgB-RNTI during a window controlled by higher layers [11, TS 38.321]. The window starts at the first symbol of the earliest CORESET the UE is configured to receive PDCCH for Type1-PDCCH CSS set, as defined in clause 10.1, that is at least one symbol, after the last symbol of the PUSCH occasion corresponding to the PRACH transmission, where the symbol duration corresponds to the SCS for Type1-PDCCH CSS set. If N_{TA,adj}^{UE} or N_{TA,adj}^{common}, as defined in [4, TS 38.211], is not zero, the window starts after an additional T_{TA}+k_{mac} msec where T_{TA} is defined in [4, TS 38.211] and k_{mac} is provided by k_{mac} or k_{mac}=0 if k_{mac} is not provided. The length of the window in number of slots, based on the SCS for Type1-PDCCH CSS set, is provided by msgB-ResponseWindow.

In response to a transmission of a PRACH, if the PRACH preamble is not mapped to a valid PUSCH occasion, a UE attempts to detect a DCI format 1_0 with CRC scrambled by a corresponding MsgB-RNTI during a window controlled by higher layers [11, TS 38.321]. The window starts at the first symbol of the earliest CORESET the UE is configured to receive PDCCH for Type1-PDCCH CSS set, as defined in clause 10.1, that is at least one symbol, after the last symbol of the PRACH occasion corresponding to the PRACH transmission, where the symbol duration corresponds to the SCS for Type1-PDCCH CSS set. The length of the window in number of slots, based on the SCS for Type1-PDCCH CSS set, is provided by msgB-ResponseWindow.

If the UE detects the DCI format 1_0, with CRC scrambled by the corresponding MsgB-RNTI and LSBs of a SFN field in the DCI format 1_0, if applicable, are same as corresponding LSBs of the SFN where the UE transmitted PRACH, and the UE receives a transport block in a corresponding PDSCH within the window, the UE passes the transport block to higher layers. The higher layers indicate to the physical layer
an uplink grant if the RAR message(s) is for fallbackRAR and a random access preamble identity (RAPID) associated with the PRACH transmission is identified, and the UE procedure continues as described in clauses 8.2, 8.3, and 8.4 when the UE detects a RAR UL grant, or
transmission of a PUCCH with HARQ-ACK information having ACK value if the RAR message(s) is for successRAR, where
   a PUCCH resource for the transmission of the PUCCH is indicated by PUCCH resource indicator field of 4 bits in the successRAR from a PUCCH resource set that is provided by pucch-ResourceCommon

If the UE detects the DCI format 1_0 with CRC scrambled by a C-RNTI and a transport block in a corresponding PDSCH within the window, the UE transmits a PUCCH with HARQ-ACK information having ACK value if the UE correctly detects the transport block or NACK value if the UE incorrectly detects the transport block and the time alignment timer is running [11, TS 38.321].

If the UE detects a DCI format 1_0 with CRC scrambled by the corresponding MsgB-RNTI and receives a transport block within the window in a corresponding PDSCH, the UE may assume same DM-RS antenna port quasi co-location properties, as described in [6, TS 38.214], as for a SS/PBCH block the UE used for PRACH association, as described in clause 8.1, regardless of whether or not the UE is provided TCI-State for the CORESET where the UE receives the PDCCH with the DCI format 1_0.

### 8.3 PUSCH Scheduled by RAR UL Grant

An active UL BWP with SCS configuration u, as described in clause 12 and in [4, TS 38.211], for a PUSCH transmission scheduled by a RAR UL grant is indicated by higher layers.

The frequency domain resource allocation is by uplink resource allocation type 1 [6, TS 38.214]. For an initial UL BWP size of N_{BWP}^{size} RBs, a UE processes the frequency domain resource assignment field as follows

A UE transmits a transport block in a PUSCH scheduled by a RAR UL grant in a corresponding RAR message using redundancy version number 0, if the PUSCH transmission is without repetitions. If a TC-RNTI is provided by higher layers, the scrambling initialization of the PUSCH corresponding to the RAR UL grant in clause 8.2 is by TC-RNTI. Otherwise, the scrambling initialization of the PUSCH corresponding to the RAR UL grant in clause 8.2 is by C-RNTI.

Msg3 PUSCH retransmissions, if any, of the transport block, are scheduled by a DCI format 0_0 with CRC scrambled by a TC-RNTI provided in the corresponding RAR message [11, TS 38.321].

8.4 PDSCH with UE Contention Resolution Identity

In response to a PUSCH transmission scheduled by a RAR UL grant when a UE has not been provided a C-RNTI, the UE attempts to detect a DCI format 1_0 with CRC scrambled by a corresponding TC-RNTI scheduling a PDSCH that includes a UE contention resolution identity [11, TS 38.321]. In response to the PDSCH reception with the UE contention resolution identity, the UE transmits HARQ-ACK information in a PUCCH. The PUCCH transmission is within a same active UL BWP as the PUSCH transmission. A minimum time between the last symbol of the PDSCH reception and the first symbol of the corresponding PUCCH transmission with the HARQ-ACK information is equal to N_{T,1}+0.5 msec. N_{T,1} is a time duration of N₁ symbols corresponding to a PDSCH processing time for UE processing capability 1 when additional PDSCH DM-RS is configured. For μ=0, the UE assumes N_{1,0}=14 [6, TS 38.214].

When detecting a DCI format in response to a PUSCH transmission scheduled by a RAR UL grant, as described in [11, TS 38.321], or corresponding PUSCH retransmission scheduled by a DCI format 0_0 with CRC scrambled by a TC-RNTI provided in the corresponding RAR message [11, TS 38.321], the UE may assume the PDCCH carrying the DCI format has the same DM-RS antenna port quasi co-location properties, as described in [6, TS 38.214], as for a SS/PBCH block the UE used for PRACH association, as described in clause 8.1, regardless of whether or not the UE is provided TCI-State for the CORESET where the UE receives the PDCCH with the DCI format.

The following table of abbreviations is provided for portions of the disclosure below:
D2R: (Ambient Internet of Things (A-IoT)) Device to Reader;
PDRCH: Physical (Ambient IoT) Device (to) Reader Channel;
PRDCH: Physical Reader (to Ambient IoT) Device Channel; and
R2D: Reader to (Ambient IoT) Device.

In the 3GPP RAN1 #116 meeting, there are some agreements on Ambient IoT.

For the purposes of the study, RAN1 uses the following terminologies:
Device 1: ˜1 μW peak power consumption, has energy storage, initial Sampling Frequency Offset (SFO) up to 10× ppm, neither Downlink (DL) nor Uplink (UL) amplification in the device. The device's UL transmission is backscattered on a carrier wave provided externally.
Device 2a: ≤a few hundred μW peak power consumption, has energy storage, initial SFO up to 10^{X} ppm, both DL and/or UL amplification in the device. The device's UL transmission is backscattered on a carrier wave provided externally.
Device 2b: ≤a few hundred u W peak power consumption, has energy storage, initial SFO up to 10× ppm, both DL and/or UL amplification in the device. The device's UL transmission is generated internally by the device.

From the RAN1 perspective, at least when a response is expected from multiple devices that are intended to be identified, an A-IoT contention-based access procedure initiated by the reader is used.

For A-IoT contention-based access procedures, at least slotted-ALOHA based access is studied.

For ambient IoT devices, a dedicated physical broadcast channel for R2D, e.g. Physical Broadcast Channel (PBCH)-like, is not considered for study.

For ambient IoT devices, at least for R2D data transmission, a physical channel (PRDCH) is studied:
System information (if defined) is transmitted on the PRDCH.
FFS Whether/how control information is transmitted on the PRDCH.
Note: the naming of PRDCH is used for the sake of the study.

For ambient IoT devices, at least for D2R data transmission, a physical channel (PDRCH) is studied along with the following:
Response transmitted from the device to reader during an contention-based access procedure is transmitted on the PDRCH.
   FFS: Details of response.
FFS (for further study) Whether/how/what D2R control information (if defined) is transmitted on the PDRCH.
Note: the naming of PDRCH is used for the sake of the study.

In recent years, more devices are expected to be interconnected in the wireless communication world for improving productivity, efficiency, and increasing comforts of life. However, powering all the IoT devices by battery that needs to be replaced or recharged manually would lead to high maintenance cost, environmental issues, and safety hazards for some use cases, e.g., wireless sensors in electrical power. Further reduction of size, complexity, and power consumption of IoT devices can enable the deployment for various applications (e.g., automated manufacturing, smart home).

On the other hand, barcode and Radio Frequency Identification (RFID) have limited the reading range of a few meters which usually requires handheld scanning. It would lead to labor intensive and time-consuming operations. Also, the lack of an interference management scheme would result in severe interference between RFID readers and capacity problems, especially in the case of dense deployment. It is hard to support a large-scale network with seamless coverage for RFID. In contrast, study of ambient IoT investigates the feasibility of a new IoT technology within 3rd Generation Partnership Project (3GPP) systems.

An ambient IoT device/User Equipment (UE) would have ultra-low complexity, very small device size and a long life cycle. The ambient IoT device/UE would have complexity and power consumption orders of magnitude lower than the existing 3GPP Low Power Wide Area (LPWA) technologies (e.g., Narrowband (NB)-IoT, enhanced Machine-Type Communication (eMTC)). The ambient IoT device/UE may not have energy storage or may have energy storage. The energy of ambient IoT device/UE may be provided through the harvesting of radio waves, light, motion, heat, or any other power source that could be suitable. The energy and/or power source may be provided one-shot (e.g., unexpected or aperiodically), periodically or continuously. In one embodiment, the power/energy of the Ambient IoT device/UE may be provided from a carrier wave from the network and/or an intermediate node. In Topology 1, the Ambient IoT device/UE would directly and bidirectionally communicate with a base station. In Topology 2, the Ambient IoT device/UE would communicate bidirectionally with an intermediate node (e.g., a UE or a relay node) between the Ambient IoT device/UE and the base station. The UL transmission of the ambient IoT device/UE may be generated internally by the device/UE, or be backscattered on the carrier wave provided externally. More details regarding the ambient IoT (device/UE) could be found in the study item [1] RP-234058 and [2] 3GPP TR 38.848 V18.0.0.

The traffic type of an ambient IoT UE may be Device Originated-Device Terminated Triggered (DO-DTT) or Device Terminated (DT). The DO-DTT or DT transmission of an ambient IoT UE is triggered by a network (or an external device). In New Radio (NR), a paging procedure could be used for triggering a Mobile Terminated (MT) transmission. However, for an ambient IoT UE, the paging procedure may not be suitable (or feasible) to trigger a DO-DTT or DT transmission. The reason(s) may include: the ambient IoT UE may not monitor paging (at least for quite a period of time) due to power consumption, the ambient IoT UE may not be able to monitor paging due to lack of configuration such as 5G-S-Temporary Mobile Subscription Identifier (5G-S-TMSI) to derive the paging occasion, the ambient IoT UE may not decode a legacy paging message successfully due to large message size, the ambient IoT UE may not establish a Radio Resource Control (RRC) connection in response to paging due to no RRC state (possibly). Therefore, how to trigger a DO-DTT or DT transmission for an ambient IoT UE should be considered.

Since ambient IoT UEs would have very low capability, it is important for the network to schedule these UEs to perform data transmission properly, e.g., providing proper frequency resources and/or repetition number. The different ambient IoT UEs would have different capabilities on transmission (e.g., Downlink (DL)/Uplink (UL) amplification, method to generate transmission). It would be beneficial for the Network (NW) to have some knowledge of the UEs to determine transmission resources.

A first UE may receive a (first) signaling from a network node (or a second UE). The first UE may perform (or initiate) a transmission (or procedure) in response to (or based on) the (first) signaling.

A network node may transmit a (first) signaling to a first UE. A second UE may transmit a (first) signaling to a first UE. The (first) signaling may be used to trigger the first UE to perform (or initiate) the transmission (or procedure).

The transmission (or procedure) may be (or include) an uplink transmission, a sidelink transmission, a transmission to the network node, and/or a transmission to the second UE. The network node may receive the transmission from the first UE. The second UE may receive the transmission from the first UE.

The transmission (or procedure) may be (or include) a data transmission, a DT transmission, a DO-DTT transmission, a Small Data Transmission (SDT), and/or a Random Access (RA) transmission or procedure. The transmission may be associated to the procedure.

The (first) signaling may be (or include) a common signaling. The (first) signaling may be (or include) a cell-specific signaling. The (first) signaling may be (or include) a broadcast signaling. The (first) signaling may be received by multiple UEs (or a group of UEs), e.g., in a UE group. The (first) signaling may be (or include) system information. The (first) signaling may be (or include) paging.

The (first) signaling may be (or include) a dedicated signaling. The (first) signaling may be (or include) a UE-specific signaling. The (first) signaling may be (or include) RRC signaling (e.g., RRC configuration message).

The (first) signaling may be (or include) a Non-Access Stratum (NAS) signaling. The (first) signaling may be (or include) an RRC signaling (e.g., RRC configuration message). The (first) signaling may be (or include) a Medium Access Control (MAC) signaling (e.g., MAC Control Element (CE)). The (first) signaling may be (or include) a Physical Layer (PHY) signaling (e.g., Physical Downlink Control Channel (PDCCH), Downlink Control Information (DCI)). The (first) signaling may be (or include) a PDCCH order.

The (first) signaling may be (or include) a carrier wave (signal) and/or interrogation signal. The (first) signaling may be used to trigger (or indicate) a transmission (or reception) of the UE (e.g., the first UE, the second UE). The transmission from the UE may be (or include) a backscattering transmission (or reception) or may be generated internally by the UE. The (first) signaling may be used to provide power source and/or energy to the UE. The (first) signaling may be used to trigger (or indicate) an RA procedure (or initial access) of the UE.

One or more information may be included in the (first) signaling. The information may (be used to) indicate which/what (kind of) UE(s) should respond to the (first) signaling. The information may (be used to) indicate which/what (kind of) UE(s) is allowed to perform (or initiate) a (data) transmission or reception, e.g., a (data) transmission or reception in response to the (first) signaling or the information. The information may (be used to) indicate configuration(s) to be used for a (subsequent) (data) transmission or reception (or procedure).

One or more of the following information may be included in the (first) signaling:

### A Set of UEs

The information may indicate (at least) a set of UEs. The information may be (or include) a range of UE Identities (IDs).

The information may indicate (at least) a distance range of UEs, e.g., the UEs with the distance range. The information may be (or include) a distance range and/or receive power range of the signaling. The information may indicate a threshold (for received power or pathloss). The UE may determine/derive the distance range from the received power of the signaling. The UE may determine/derive whether the UE belongs to the set of UEs based on a comparison between received power (of the signaling) and the threshold, e.g., the UE determines the UE belongs to the set of UEs if the received power is equal to or is larger than the threshold. The UE may determine/derive whether the UE belongs to the set of UEs based on a comparison between estimated pathloss (based on the signaling) and the threshold, e.g., the UE determines the UE belongs to the set of UEs if the estimated pathloss is equal to or is smaller than the threshold. The distance range may be centered at/by the network node or the second UE.

The information may indicate (at least) a group of UEs. The information may indicate (at least) a UE group. The information may be (or include) a group ID.

The information may indicate (at least) a set of UE groups. The information may be (or include) a range of UE group IDs.

The information may be used to identify a set of UE(s). The information may indicate which (set of) UE(s) should respond to the (first) signaling.

### A Specific UE

The information may indicate (at least) a specific UE. The information may be (or include) a UE ID.

The information may be used to identify a UE. The information may indicate which UE should respond to the (first) signaling.

### Assistance Information

The information may indicate (at least) a UE type. The information may indicate (at least) a device type.

The information may indicate (at least) (a threshold for) a power level.

The information may indicate (at least) a repetition number for a UL transmissions, e.g., Msg1, preamble, Msg3, MSGA, and/or etc.

The information may indicate (at least) a (UL) data type. The information may indicate (at least) a (UL) data size.

The information may indicate (at least) an area scope.

The information may indicate what (kind of) UE(s) should respond to the (first) signaling. For example, the UE which fulfills the condition indicated by the information should respond to the (first) signaling. The UE which does not fulfill the condition indicated by the information should not respond to the (first) signaling. For example, the UE belonging to what is indicated by the information should respond to the (first) signaling. The UE not belonging to what is indicated by the information should not respond to the (first) signaling.

### Scheduling Information

The information may indicate (at least) scheduling information. The information may indicate (at least) resource(s) for a (subsequent) (data) transmission or reception. The information may be (or include) a UL grant. The information may be (or include) a configured grant. The information may be (or include) a DL assignment.

### RA Related Information

The information may indicate (at least) information related to a random access procedure. The information may be (or include) a dedicated preamble(s) and/or preamble/Random Access Channel (RACH) occasion(s).

The UE may perform (or initiate) an RA procedure in response to (receiving) the (first) signaling. The UE may perform (or initiate) an RA procedure based on the information.

### Configuration

The information may indicate (at least) (which set of) configuration to be used (or applied). The UE may be pre-configured with multiple (set of) configurations. The UE may determine to use a specific (set of) configuration in response to (receiving) the (first) signaling. The UE may determine to use a specific (set of) configuration based on the information.

One or more parameters of the following configuration(s) may be included in the (first) signaling: Configuration related to RA The configuration may be (or include) any of: 4-step RA configuration, 2-step RA configuration, contention-based RA configuration, contention-free RA configuration, RA resource configuration, RA preamble configuration, dedicated preamble(s), RA preamble group configuration, RACH-ConfigCommon, Physical Random Access Channel (PRACH) configuration, RACH-ConfigCommonTwoStepRA, RACH-ConfigDedicated, RACH-ConfigGeneric, and/or RACH-ConfigGenericTwoStepRA.

The UE (e.g., ambient IoT UE, the first UE) may be configured with multiple RA configurations for a cell. Alternatively and/or additionally, a cell may provide or indicate multiple RA configurations (for ambient IoT). The UE may be configured with multiple RA resources groups. Alternatively and/or additionally, the cell may provide or indicate multiple RA resources groups (for ambient IoT). The UE may be configured with multiple RA configuration groups. Alternatively and/or additionally, the cell may provide or indicate multiple RA configuration groups (for ambient IoT). The multiple RA configurations, RA resources group, and/or RA configuration groups may be configured on different Bandwidth Parts (BWPs). The multiple RA configurations, RA resources groups, and/or RA configuration groups may be configured on a same BWP. The RA configuration, RA resources group, and/or RA configuration group may correspond to, be associated with, and/or be used by (one or more) UEs and/or a first factor.

### Configuration Related to Downlink Control Signaling

The configuration may be (or include) any of: PDCCH configuration, Control Resource Set (CORESET) configuration, search space configuration, PDCCH-Config, PDCCH-ConfigCommon, PDCCH-ConfigSIB1, PDCCH-ServingCellConfig, ControlResourceSet, ControlResourceSetId, ControlResourceSetZero, SearchSpace, SearchSpaceId, and/or SearchSpaceZero.

The UE (e.g., ambient IoT UE, the first UE) may be configured with one (or more) PDCCH configuration, CORESET configuration, and/or search space configuration. The UE may not be allowed to configure more than one PDCCH configuration, CORESET configuration, and/or search space configuration. The UE may be pre-configured with one (or more) PDCCH configuration, CORESET configuration, and/or search space configuration. The UE may use (or apply) a pre-configured (or fixed) value for the configuration. The UE may not require the configuration. The UE may not require the network to provide the configuration.

### Configuration Related to Paging

The configuration may be (or include) any of: paging cycle configuration, paging frame configuration, paging occasion configuration, PCCH-config, and/or (default) PagingCycle.

The UE (e.g., ambient IoT UE, the first UE) may be configured with at least a configuration related to paging. The UE may be pre-configured with at least a configuration related to paging. The UE may use (or apply) a pre-configured (or fixed) value for the configuration. The UE may not require the configuration related to paging. The UE may not require the network to provide the configuration related to paging.

### Configuration Related to System Information

The configuration may be (or include) any of: system information scheduling configuration, system information modification configuration, system information request configuration, BCCH-config, SI-SchedulingInfo, and/or SI-RequestConfig.

The UE (e.g., ambient IoT UE, the first UE) may be configured with at least a configuration related to system information. The UE may be pre-configured with at least a configuration related to system information. The UE may use (or apply) a pre-configured (or fixed) value for the configuration. The UE may not require the configuration related to system information. The UE may not require the network to provide the configuration related to system information.

### Configuration Related to Data Transmission or Reception

The configuration may be (or include) any of: PUSCH-Config, PUSCH-ConfigCommon, PUSCH-ServingCellConfig, PDSCH-Config, PDSCH-ConfigCommon, PDSCH-ServingCellConfig, Semi-Persistent Scheduling (SPS) configuration, configured grant configuration, and/or Hybrid Automatic Repeat Request (HARQ) configuration.

The UE (e.g., ambient IoT UE, the first UE) may be configured with at least a configuration related to data transmission or reception. The UE may be pre-configured with at least the configuration. The UE may use (or apply) a pre-configured (or fixed) value for the configuration. The UE may not require the configuration. The UE may not require the network to provide the configuration.

### Configuration Related to Small Data Transmission

The configuration may be (or include) any of: SDT-Config, SDT-MAC-PHY-CG-Config, SDT-ConfigCommonSIB, MT-SDT-ConfigCommonSIB, CG-SDT-Configuration, and/or SDT configuration.

The UE (e.g., ambient IoT UE, the first UE) may be configured with at least a configuration related to small data transmission. The UE may be pre-configured with at least the configuration. The UE may use (or apply) a pre-configured (or fixed) value for the configuration. The UE may not require the configuration. The UE may not require the network to provide the configuration.

### Miscellaneous

The configuration may be (or include) any of: configuration related to uplink control information, PUCCH-ConfigCommon, scheduling request configuration, and/or Sounding Reference Signal (SRS) configuration.

The configuration may be (or include): Packet Data Convergence Protocol (PDCP) configuration, Radio Link Control (RLC) configuration, RLC channel configuration, logical channel configuration, and/or radio bearer configuration.

The configuration may be (or include): Buffer Status Report (BSR) configuration, Power Headroom Report (PHR) configuration, Discontinuous Reception (DRX) configuration, MAC-CellGroupConfig, timing advance configuration, Timing Advance (TA) timer configuration, TA report configuration, and/or radio link monitoring configuration.

The configuration may be (or include): measurement configuration, measurement gap configuration, measurement object configuration, and/or measurement report configuration.

The UE (e.g., ambient IoT UE, the first UE) may be configured with at least the configuration. The UE may be pre-configured with at least the configuration. The UE may use (or apply) a pre-configured (or fixed) value for the configuration. The UE may not require the configuration. The UE may not require the network to provide the configuration.

The configuration(s) described above may be per BWP of one or more BWPs of a cell for the UE(s). Alternatively, the configuration(s) described above may be common to one or more BWPs of a cell for the UE(s).

For another type of UE (e.g., normal UE, non-ambient IoT UE, the second UE), the UE may receive the configuration(s) by system information and/or a dedicated RRC signaling (e.g., RRC reconfiguration).

The traffic type of an ambient IoT UE may be DO-DTT or DT. The DO-DTT or DT transmission of an ambient IoT UE is triggered by a network (or an external device). For a DT transmission, the network could know when DT data as arrived and the data size such that the network could trigger and schedule the DT transmission properly. However, for a DO-DTT transmission, the network may not know when data has arrived and the corresponding data size. The network may not trigger and schedule the DO-DTT transmission properly.

A first UE may provide (or transmit) (at least) a (first) information to a network node (or a second UE). The (first) information may be included in a (second) signaling. The (first) information and/or the (second) signaling may be transmitted by the first UE to the network node (or the second UE). An example is shown in FIG. 9.

The first UE may perform (or initiate) a transmission including the (first) information. The transmission may be the (second) signaling. The transmission may be a data transmission. The first UE may transmit the (first) information and/or the (second) signaling in response to (or based on) a (first) signaling. The first UE may transmit the (first) information and/or the (second) signaling during a procedure. The procedure may be triggered by the (first) signaling. The procedure may be a random access procedure. The procedure may be a small data transmission procedure.

The (second) signaling may be (or include) an RRC message (e.g., RRC setup request). The (second) signaling may be (or include) a MAC signaling (e.g., MAC CE). The (second) signaling may be (or include) a PHY signaling (e.g., Physical Uplink Control Channel (PUCCH), Uplink Control Information (UCI)). The (second) signaling may be (or include) uplink control information. The (second) signaling may be (or include) a NAS message.

A first UE may receive a (first) signaling from a network node (or a second UE). The first UE may perform (or initiate) a transmission (or procedure) in response to (or based on) the (first) signaling.

A network node may transmit a (first) signaling to a first UE. A second UE may transmit a (first) signaling to a first UE. The (first) signaling may be used to trigger the first UE to perform (or initiate) an (uplink) transmission (or procedure).

The transmission (or procedure) may be (or include) an uplink transmission, a sidelink transmission, a transmission to the network node, and/or a transmission to the second UE. The network node may receive the transmission from the first UE. The second UE may receive the transmission from the first UE.

The transmission (or procedure) may be (or include) a data transmission, a DT transmission, a DO-DTT transmission, an SDT, and/or an RA transmission or procedure. The transmission may be associated to the procedure.

The (first) signaling may be (or include) a common signaling. The (first) signaling may be (or include) a cell-specific signaling. The (first) signaling may be (or include) a broadcast signaling. The (first) signaling may be received by multiple UEs (or a group of UEs), e.g., in a UE group. The (first) signaling may be (or include) system information. The (first) signaling may be (or include) paging.

The (first) signaling may be (or include) a dedicated signaling. The (first) signaling may be (or include) a UE-specific signaling. The (first) signaling may be (or include) RRC signaling (e.g., RRC configuration message).

The (first) signaling may be (or include) an RRC signaling (e.g., RRC configuration message). The (first) signaling may be (or include) a MAC signaling (e.g., MAC CE). The (first) signaling may be (or include) a PHY signaling (e.g., PDCCH, DCI). The (first) signaling may be (or include) a PDCCH order.

The (first) signaling may be (or include) a carrier wave (signal) and/or interrogation signal. The (first) signaling may be used to trigger (or indicate) a transmission (or reception) of the UE (e.g., the first UE, the second UE). The transmission from the UE may be (or include) a backscattering transmission (or reception) or may be generated internally by the UE. The (first) signaling may be used to provide power source and/or energy to the UE. The (first) signaling may be used to trigger (or indicate) an RA procedure (or initial access) of the UE.

One or more information may be included in the (first) signaling. The information may (be used to) indicate which/what (kind of) UE(s) should respond to the (first) signaling. The information may (be used to) indicate which/what (kind of) UE(s) is allowed to perform (or initiate) a (data) transmission or reception, e.g., a (data) transmission or the (second) signaling in response to the (first) signaling or the information. The information may (be used to) indicate configuration(s) to be used for a (subsequent) (data) transmission or reception (or procedure).

The (first) information and/or first factor may be (or include or indicate or related to) one or more of the following information. The (first) information may be used to derive one or more of the following information. The (first) information may indicate one or more of the following information. The network node (or the second UE) may derive one or more of the following information based on the (first) information. Alternatively and/or additionally, one or more assistance information mentioned above (e.g., the assistance information included in the (first) signaling) is illustrated in more detail in the following. Whether the (first) information includes or indicates one or more of the following information may depend on whether one or more of the following information is changed compared to the (first) information provided (or transmitted) last time, e.g., not include or indicate if it is the same. The (first) information may include or indicate one or more of the following information (which is omitted this time) is the same as that provided (or transmitted) last time.

### UE Type (or Device Type)

The UE may indicate its UE type (or device type) in the transmission (explicitly or implicitly).

There may be two or more types of the UE (or device). The UE types (device types) may be differentiated by at least energy storage, method to perform UL transmission, power level, and/or device size. Preferably in certain embodiments, the method to perform UL transmission may be generated internally by the device/UE or be backscattered on the carrier wave (signal) provided externally.

For example, a first type UE (or device) may be a device A or device B, e.g., as considered in [2] 3GPP TR 38.848 V18.0.0. The first type UE (or device) may have (or be equipped with) battery or energy storage. The first type UE (or device) may not have (or be equipped with) battery or energy storage. The first type UE (or device) may not have (or be equipped with) DL/UL amplification. The first type UE (or device) may be a passive or semi-passive device. The first type UE (or device) may generate UL transmission by backscattering. The first type UE (or device) may perform backscattering transmission. The first type UE (or device) may not be able to generate UL transmission (internally) by itself. The first type UE (or device) may not have capability to generate signal without backscattering.

For example, a second type UE (or device) may be a device C, e.g., as considered in [2] 3GPP TR 38.848 V18.0.0. The second type UE (or device) may have (or be equipped with) battery or energy storage. The second type UE (or device) may have (or be equipped with) DL/UL amplification. The second type UE (or device) may be an active device. The second type UE (or device) may generate UL transmission by backscattering. The second type UE (or device) may perform backscattering transmission. The second type UE (or device) may be able to generate UL transmission (internally) by itself. The second type UE (or device) may have capability to generate signal without backscattering.

### Power Level

The UE may indicate its power level in the transmission (explicitly or implicitly). The UE may indicate a parameter related to power level in the transmission.

The power level may comprise any one or more of the following embodiments. The UE may utilize same or different power level embodiment(s) for different RA resources selection (step(s)), e.g., determination of BWP, determination of RA resources/configuration group, determination of RA type, determination of RA preamble, determination of RACH occasion(s), and/or determination of Physical Uplink Shared Channel (PUSCH) occasion(s). There may be one or more thresholds for power level. The power level may be determined by threshold(s). The threshold(s) for power level may be configured by the network or be derived by the UE. The threshold(s) for power level may be determined based on the following embodiments and/or a (selected) RA resources/configuration.

In one embodiment, the power level may be a received power of a signal/channel transmitted from the network. The power level may be a received power of a carrier-wave (signal) transmitted from the network.

In one embodiment, the power level may be a (downlink) pathloss derived/determined based on at least the received power of the signal/channel transmitted from the network. The power level may be a (downlink) pathloss derived/determined based on at least the received power of the carrier-wave (signal) transmitted from the network.

In one embodiment, the power level may be an expected/derived/determined UE transmit power for backscattering transmission (e.g., the first transmission and/or the third transmission).

In one embodiment, the power level may be an expected/derived/determined UE transmit power for UL transmission generated internally by the UE (e.g., the first transmission and/or the third transmission).

In one embodiment, the power level may be a maximum UE transmit power (e.g., for the first transmission and/or the third transmission).

In one embodiment, the power level may be the amount of the UE's battery power/stored power/available power. The UE may estimate/determine/derive how much the battery power/stored power/available power are utilizable/available for performing the (corresponding) RA procedure.

In one embodiment, the power level may be a predefine/(pre-) configured/indicated power. The indicated power can be indicated by the network or by the higher layer of the UE. Preferably in certain embodiments, the predefine/(pre-) configured/indicated power can be a guaranteed or required power (amount or capacity) for enabling/activating/starting the (corresponding) RA procedure. Preferably in certain embodiments, the predefine/(pre-) configured/indicated power can be an expected/estimated power consumption (amount) for completing the (corresponding) RA procedure.

In one embodiment, the power level may be a power difference between the (downlink) pathloss and the expected/derived/determined/maximum UE transmit power. The (downlink) pathloss may be derived/determined based on at least received power of the signal/channel, e.g., a carrier wave (signal), from the network. The expected/derived/determined UE transmit power may be for backscattering transmission or for UL transmission generated internally by the UE.

In one embodiment, the power level may be a power difference between battery power/stored power/available power and the expected/derived/determined/maximum UE transmit power. The expected/derived/determined UE transmit power may be for backscattering transmission or for UL transmission generated internally by the UE. The UE may estimate/determine/derive how much the battery power/stored power/available power are utilizable for performing (corresponding) RA procedure.

In one embodiment, the power level may be a power difference between a predefine/(pre-) configured/indicated power and the expected/derived/determined/maximum UE transmit power. The indicated power can be indicated by the network or by the higher layer of the UE. Preferably in certain embodiments, the predefine/(pre-) configured/indicated power can be a guaranteed or required power (amount or capacity) for enabling/activating/starting the (corresponding) RA procedure. Preferably in certain embodiments, the predefine/(pre-) configured/indicated power can be an expected/estimated power consumption (amount) for completing the (corresponding) RA procedure. The expected/derived/determined UE transmit power may be for backscattering transmission or for UL transmission generated internally by the UE.

### (UL) Data Type (or Transmission Type)

The UE may indicate its data type (or transmission type) in the transmission (explicitly or implicitly). The data type (or transmission type) may indicate the type of the transmission (or data). The data type (or transmission type) may indicate a use case, traffic scenario, service type, Quality of Service (QOS), logical channel (group), and/or topology. The data type (or transmission type) may be (or include): data, signaling, DO, DO-DTT, DT, one-shot, data burst, periodic, aperiodic, delay tolerant, and/or emergency.

The (UL) data types may be differentiated by at least a use case, traffic scenario, service type, QoS, logical channel (group), and/or topology. The (UL) data type may be indicated by the network or indicated by the higher layer of the UE. The UE may initiate or trigger the RA procedure for transmitting the UL data.

### (UL) Data Size

The UE may indicate a data size in the transmission (explicitly or implicitly).

The (UL) data size may be calculated/derived/determined by the UE. The (UL) data size may be corresponding to the (UL) data type. The UL data size may be (potential) Transport Block Size (TBS) of a MSGA payload and/or a Msg3. The UL data size may be (potential) TBS of the first transmission in the RA procedure. The (UL) data size may be a TBS of ambient IoT information (or data). The UE may initiate or trigger the RA procedure for transmitting the UL data.

### UE ID

The UE may indicate its UE ID in the transmission (explicitly or implicitly). The UE ID may be used to identify a UE (e.g., in an area). The UE ID may be stored by the UE. The UE ID may be a temporary ID.

A UE may be assigned a UE ID. The UE may be predefined or (pre-) configured (e.g., by the UE) the UE ID. The UE may be configured with or indicate (e.g., by the NW) the UE ID. The UE may calculate, select, derive, or determine the UE ID by itself. The UE ID may be a random value. The UE ID may ue-Identity.

### UE Group (ID)

The UE may indicate its UE group ID in the transmission (explicitly or implicitly).

There may be multiple UE groups. A UE may be assigned or associated with a UE group. The UE may be predefined or (pre-) configured (e.g., by the UE) with the UE group. The UE may be configured or indicated (e.g., by the NW) with the UE group. The UE may receive a group ID and/or a value to derive/determine the group ID via paging, System Information Block (SIB) and/or PDCCH.

The multiple UEs may be assigned to different UE groups based on the UE types. The UEs with the same UE type may be in a same UE group. The UEs with the same UE type may be in different UE groups. A UE group may comprise UEs with the same or different UE type.

The multiple UEs may be assigned to or associated with different UE groups based on the UE ID. For example, a UE may be assigned to or associated with a UE group, wherein the UE group ID of the UE group may be decided/derived/determined based on at least the UE ID of the UE and a value. Preferably in certain embodiments, the UE group ID of the UE may be decided/derived/determined by the UE ID mod the value. The value may be the number of UE groups. The value may be provided by the NW or be pre-defined or be (pre-) configured. The UE group ID of the UE may be decided by a formula using the UE ID.

The multiple UEs may be assigned to different UE groups based on location. Preferably in certain embodiments, the UEs in a same location and/or same position range may be distributed to a same UE group. A UE may determine/derive its location or range based on a received carrier wave (signal). More specifically, the UE may determine/derive its location or range from a network/intermediate node based on a received power of a carrier wave (signal) transmitted from the network/intermediate node. The UEs in the same location and/or the same range may mean the UEs with the same received power range of the carrier wave (signal). Preferably and/or alternatively in certain embodiments, the UEs in a same location and/or same position range may be distributed to different UE groups. The UEs among the range which could receive the same power source, carrier wave, and/or NW signal may be (randomly) distributed to different UE groups.

### Cause

The cause of the (first or second) signaling (or the transmission) may be provided (or indicated). The cause may indicate at least one or more of the following: a DO-DTT (transmission), a Device Terminated (DT) (transmission), a Device Originated (DO) transmission, a first type data (transmission), a second type data (transmission), a (service/measurement/status) report (transmission), a signaling (transmission), a first type UE (transmission), a second type UE (transmission), an ambient IoT (transmission), and/or a non-ambient IoT (transmission).

The cause of the (first or second) signaling (or the transmission) may indicate the transmission type (e.g., DO-DTT, DT, DO). The cause of the (first or second) signaling (or the transmission) may indicate the data type (as described above). The cause of the (first or second) signaling (or the transmission) may indicate the UE type (as described above). The cause of the (first or second) signaling (or the transmission) may indicate whether the UE is an ambient IoT UE or is capable of ambient IoT.

### Position or Location Information

The position (or location) of the UE may be provided (or indicated). The information may be (or include or indicate) a coordinate of the UE. The information may be (or include or indicate) an area where the UE is located. The information may be (or include or indicate) an area ID. The area may be (or include) a cell, a tracking area, or a range of area scope.

### Information Related to (Data) Traffic

Information related to (data) traffic of the UE may be provided (or indicated). The information may be (or include or indicate) at least one or more of the following: a traffic pattern, time information related to data (or packet) arrival, how long the (next) data is expected to arrive, latency requirement of data (or packet), priority of the data (or packet), importance of the data (or packet), the expected time of (next) data arrival, (expected) data inter-arrival time, a period of data arrival.

### Information Related to UE Wake Up

Information related to UE wake up may be provided (or indicated). The information may be (or include or indicate) at least one or more of the following: (expected or preferred) wake up time of the UE, time information related to UE wake up, information related to UE active time, the time that the UE will wake up (or wish to wake up), how long until the next time the UE will wake up. The UE wake up may represent that the UE monitors a DL signaling (e.g., carrier wave) or PDCCH.

### (Required) TB Size

Information related to (required) Transport Block (TB) size may be provided (or indicated). The UE may not perform data segmentation (e.g., RLC segmentation). The UE may need to be allocated (or scheduled) with a UL grant with TB size which can accommodate an upper layer Service Data Unit (SDU). The (required) TB size may be a minimum size that the UE can use to perform a (data) transmission. The TB size may be a preferred value that the UE can use to perform a (data) transmission.

### (Required) Repetition Number

Information related to (required) repetition number (used) for an uplink transmission (e.g., Msg1, preamble, Msg3, MSGA, and/or etc.) may be provided (or indicated).

### Acknowledgement

Information for acknowledgement may be provided (or indicated). The acknowledgement may be used to acknowledge the reception of the (first) signaling. The acknowledgement may be used to acknowledge a previous reception (or transmission).

Threshold(s) for the first factor may be indicated or configured by the NW. Alternatively, the threshold(s) may be determined by the UE. Alternatively, the threshold(s) may be fixed.

The first UE may be an ambient IoT UE. The first UE may not be a normal (or legacy) UE. The first UE may be a first type of UE. The first UE may be a first type of ambient IoT UE.

The second UE may not be an ambient IoT UE. The second UE may be a normal (or legacy) UE. The second UE may be an intermediate node. The second UE may be a second type of UE. The second UE may be a second type of ambient IoT UE.

The first UE and the second UE may be different. The first UE and the second UE may be of different UE types.

The first UE (or UE type) and the second UE (or UE type) may be differentiated based on at least a first factor. The first factor may be one or more of the (assistance) information mentioned above.

To solve the issue, the UE (e.g., ambient IoT UE) could determine whether to trigger a random access procedure based on whether the UE belongs to a device type indicated in the first signaling. In response to (receiving) a first signaling of triggering random access procedure, the UE may determine whether to trigger the random access procedure based on whether the UE belongs to the device type indicated in the first signaling.

Alternatively and/or additionally, the UE (e.g., ambient IoT UE) could trigger a random access procedure and indicate whether it is able to generate transmission by itself or not and/or whether the UE is equipped with (DL/UL) amplification or not. In response to (receiving) a first signaling of triggering random access procedure, the UE may trigger the random access procedure and perform a first transmission providing an information indicating whether the UE is able to generate (the) transmission by itself or not and/or whether the UE is equipped with (DL/UL) amplification or not.

In one example, the UE may receive a first signaling of triggering a random access procedure, wherein the first signaling indicates a first information of a device type. In response to (receiving) the first signaling, the UE may determine whether to trigger the random access procedure based on whether the UE belongs to the device type. There may be more than one type of ambient IoT device. The first signaling may indicate which UE is allowed to trigger the random access procedure. In response to (receiving) the first signaling, the UE may trigger the random access procedure if at least the UE belongs to the device type. In response to (receiving) the first signaling, the UE may not trigger the random access procedure if at least the UE does not belong to the device type.

In one example, the UE may receive a first signaling of triggering a random access procedure. In response to (receiving) the first signaling, the UE may trigger the random access procedure and perform a transmission indicating or providing a third information during the random access procedure. The third information may indicate whether the UE is able to generate (the) transmission by itself or not. The third information may indicate whether the UE is equipped with DL/UL amplification or not. The third information may indicate the UE belonging to which type of more than one type of ambient IoT device.

In the above two examples, the first signaling may be an ambient IoT paging message. The first signaling may indicate a second information of a group ID of the UE. The UE may be an ambient IoT device. The more than one type of ambient IoT device may be differentiated by a method to perform (the) transmission. The (more than one) device type may include at least a first device type and a second device type. A device of the first device type may be able to generate transmission by itself. A device of the second device type may generate transmission by backscattering. The device of the first device type may have or be equipped with (DL/UL) amplification. The device of the second device type may not have or may not be equipped with (DL/UL) amplification.

In one example, the UE receives a first signaling of triggering a random access procedure, wherein the first signaling indicates a first information associated with a (specific) device type (of device types). In response to (receiving) the first signaling, the UE determines whether to trigger the random access procedure based on whether the UE belongs to the (specific) device type associated with the first information. The first signaling is an ambient IoT paging message and/or a paging message. The random access procedure is an ambient IoT random access procedure. The first signaling is transmitted from a reader. The reader is a network node, an intermediate node, or another UE.

In one example, in response to (receiving) the first signaling, the UE triggers the random access procedure if at least the UE belongs to the (specific) device type associated with the first information. In response to (receiving) the first signaling, the UE does not trigger the random access procedure if at least the UE does not belong to the (specific) device type associated with the first information.

In one example, the UE receives a second information indicated by the first signaling, wherein the second information indicates a group ID of the UE or a set of UEs. In response to (receiving) the first signaling, the UE triggers the random access procedure if at least the UE belongs to the specific device type associated with the first information, the first signaling indicates the second information of the group ID of the UE, and/or the UE belongs to the set of UEs.

In one example, the UE receives the first signaling indicating a second information of a group ID of the UE. In response to (receiving) the first signaling, the UE triggers the random access procedure if at least the UE belongs to the (specific) device type associated with the first information and the first signaling indicates the second information of the group ID of the UE. In response to (receiving) the first signaling, the UE does not trigger the random access procedure if the UE does not belong to the (specific) device type associated with the first information or if the first signaling does not indicate the second information of the group ID of the UE.

In one example, the UE receives the first signaling indicating the second information indicating a set of UEs. In response to (receiving) the first signaling, the UE triggers the random access procedure if at least the UE belongs to the (specific) device type associated with the first information and the UE belongs to the set of UEs. In response to (receiving) the first signaling, the UE does not trigger the random access procedure if the UE does not belong to the (specific) device type associated with the first information or if the UE does not belong to the set of UEs.

In one example, the UE receives the first signaling indicating which one or more UEs is allowed to trigger the random access procedure. In response to (receiving) the first signaling, the UE triggers the random access procedure if at least the UE belongs to the (specific) device type associated with the first information and the UE belongs to the one or more UEs. In response to (receiving) the first signaling, the UE does not trigger the random access procedure if the UE does not belong to the (specific) device type associated with the first information or if the UE does not belong to the one or more UEs.

In one example, the device type includes at least one of a first device type and a second device type.

In one example, a UE belonging to the first device type is able to generate (the) transmission by itself. A UE belonging to the second device type generates (the) transmission by backscattering.

In one example, a UE belonging to the first device type has or is equipped with amplification. A UE belonging to the second device type does not have or is not equipped with amplification.

In one example, the first device type and the second device type are differentiated by at least any of energy storage, power level, and/or device size.

In one example, the UE receives a first signaling of triggering a random access procedure. In response to (receiving) the first signaling, the UE triggers the random access procedure. The UE performs a transmission indicating or providing a third information during the random access procedure. The third information indicates a device type of the UE. The device type of the UE is differentiated by or associated with any of a method to perform (the) transmission, equipped with amplification, energy storage, power level, and/or device size. The first signaling is an ambient IoT paging message and/or a paging message. The random access procedure is an ambient IoT random access procedure. The first signaling is transmitted from a reader. The first transmission is transmitted to the reader during the random access procedure. The reader is a network node, an intermediate node, or another UE.

In one example, the third information indicates the UE belonging to which type of more than one type of ambient IoT device. The more than one type of ambient IoT device is differentiated by any of a method to perform (the) transmission, equipped with amplification, energy storage, power level, and/or device size.

In one example, the third information indicates the device type of the UE comprising any of: generating (the) transmission by itself or generating (the) transmission by backscattering, equipped with amplification or not equipped with amplification, or differentiation by energy storage, power level, and/or device size.

The UE may indicate whether it is an ambient IoT UE or a legacy UE explicitly via the first transmission. The UE may indicate which UE type it is explicitly via the first transmission. The UE may indicate whether it is an ambient IoT UE or a legacy UE implicitly by the selected BWP, RA resources, RA group, RA type, RA preamble (group), and/or RACH occasion. The UE may indicate which UE type it is implicitly by the selected BWP, RA resources, RA group, RA type, RA preamble (group), and/or RACH occasion.

The UE may receive configurations related to ambient IoT. The UE may receive RA configurations and/or RA resources. The RA resources may comprise BWP, RA resources/configuration group, RA preamble (group), RACH occasion(s), and/or PUSCH occasion(s).

In an RA procedure, the UE may fallback or switch an RA resource (selection), as mentioned above. The UE may fallback or switch an RA resource (selection) if, when, or in response to a transmission counter (e.g., PREAMBLE_TRANSMISSION_COUNTER) is above or is equal to the configured value, receiving the second transmission or a fourth transmission comprising an indication, and/or expiry of a response window (e.g., msgB-ResponseWindow, ra-ResponseWindow) and/or a contention resolution timer (e.g., ra-ContentionResolutionTimer). The UE may select another RA resource and/or perform another RA resource selection (step).

Throughout the present disclosure, the “RA procedure” may be replaced by “(initial) access procedure”.

Throughout the present disclosure, the “RA procedure” may be changed/represented/replaced as a UE (or ambient IoT) data transmitting procedure, UE (or ambient IoT) response procedure, or UE (or ambient IoT) reporting procedure.

Throughout the present disclosure, the “RA” may be replaced by “access”.

Throughout the present disclosure, the “MSGA” or “MSGA payload” may be replaced by “(uplink) data and/or signaling”.

Throughout the present disclosure, the “PRACH” may be replaced by “channel for random access” or “PRACH for ambient IoT”.

Throughout the present disclosure, the “PUSCH” may be replaced by “uplink shared channel” or “PUSCH for ambient IoT”.

Throughout the present disclosure, the “PDCCH” may be replaced by “downlink control channel”, “downlink control information”, or “PDCCH for ambient IoT”.

Throughout the present disclosure, the Physical Downlink Shared Channel (“PDSCH”) may be replaced by “downlink shared channel” or “PDSCH for ambient IoT”.

Throughout the present disclosure, the “BWP” may be replaced by “sub-band of/in a cell” or “subset of the total cell bandwidth of a cell”.

Throughout the present disclosure, the “RACH” may be replaced by “access channel” or “RACH for ambient IoT”.

Throughout the present disclosure, the “cell” may be replaced by “intermediate node”.

Throughout the present disclosure, the network (node) may be changed/represented/replaced as intermediate node.

The UE may be referred to as the UE, an Access Spectrum (AS) layer of the UE, an A-IoT layer of the UE, an RRC layer of the UE, a MAC entity of the UE, or physical layer of the UE.

Throughout the present disclosure, the UE may be an ambient IoT device/UE. The UE may be a device used for ambient IoT. The UE may be a device capable of ambient IoT. The UE may be an N_{R} device. The UE may be a Long Term Evolution (LTE) device. The UE may be an IoT device. The UE may be a wearable device. The UE may be a sensor. The UE may be a stationary device. The UE may be a tag. Throughout the present disclosure, the following may be interchangeable: (ambient IoT) UE, (ambient IoT) device. Throughout the present disclosure, the following may be interchangeable: normal UE, legacy UE.

The UE may not be a legacy UE. The legacy UE may be a non-ambient IoT device. The legacy UE may perform different procedures from the ambient IoT UE. The UE may be a legacy UE with capability to perform an ambient IoT procedure.

The network may be a network node. The network (node) may be a base station. The network (node) may be an access point. The network (node) may be an Evolved Node B (eNB). The network (node) may be a Next Generation Node B (gNB). The network (node) may be a gateway.

Various examples and embodiments of the present invention are described below. For the methods, alternatives, concepts, examples, and embodiments detailed above and herein, the following aspects and embodiments are possible.

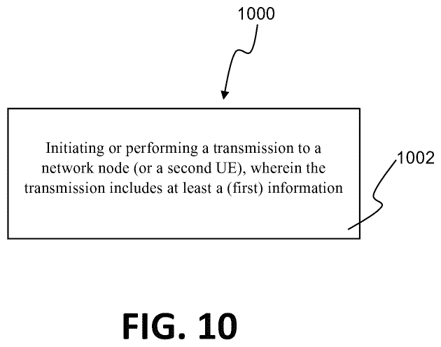

Referring to FIG. 10, with this and other concepts, systems, and methods of the present invention, a method 1000 for a first UE in a wireless communication system comprises initiating or performing a transmission to a network node (or a second UE), wherein the transmission includes at least a (first) information (step 1002).

In various embodiments, the (first) information includes a device type and/or a UE type.

In various embodiments, the (first) information includes a data type and/or a data size.

In various embodiments, the (first) information includes a UE ID and/or a UE group ID.

In various embodiments, the (first) information includes a cause value.

In various embodiments, the (first) information includes a location information.

In various embodiments, the (first) information includes a time information (related to data arrival).

In various embodiments, the (first) information includes a time information (related to UE wake up).

In various embodiments, the (first) information includes a required TB size.

In various embodiments, the (first) information includes an acknowledgement.

Referring back to FIGS. 3 and 4, in one or more embodiments from the perspective of a first UE in a wireless communication system, the device 300 includes a program code 312 stored in memory 310 of the transmitter. The CPU 308 could execute program code 312 to: (i) initiate or perform a transmission to a network node (or a second UE), wherein the transmission includes at least a (first) information. Moreover, the CPU 308 can execute the program code 312 to perform all of the described actions, steps, and methods described above, below, or otherwise herein.

Referring back to FIGS. 3 and 4, in one or more embodiments from the perspective of a reader in a wireless communication system, the device 300 includes a program code 312 stored in memory 310 of the transmitter. The CPU 308 could execute program code 312 to: (i) initiate or perform a transmission to a network node (or a second UE), wherein the transmission includes at least a (first) information. Moreover, the CPU 308 can execute the program code 312 to perform all of the described actions, steps, and methods described above, below, or otherwise herein.

Currently, when an RA procedure is initiated, the UE selects a carrier (e.g., Supplementary Uplink (SUL), Normal Uplink (NUL)), performs BWP operation and then sets an RA type (e.g., 2-step RA, 4-step RA). The UE sets the RA types based on RA configurations and Reference Signal Received Power (RSRP) of a downlink pathloss reference. The UE would select a Synchronization Signal Block (SSB) (or Channel State Information Reference Signal (CSI-RS)). The selected SSB (or CSI-RS) may be utilized as the downlink pathloss reference, e.g., the UE derives/determines DL pathloss based on RSRP of the selected SSB (or CSI-RS). The UE would select an RA preamble and RACH occasion associated with the selected SSB (or CSI-RS). The UE would select an RA preamble from two RA preamble groups based on UL data size.

Due to characteristics of ambient IoT UE, the RA procedures and RA resources would be different from a legacy UE. In an RA procedure (e.g., for ambient IoT), the UE (e.g., ambient IoT UE/device) may transmit a first transmission to the NW. The NW may transmit a second transmission to the UE in response to reception/detection of the first transmission. In response to or after transmitting the first transmission, the UE may receive a second transmission from the NW. Alternatively, there is no response in response to the first transmission. In other words, the RA procedure is completed in response to transmitting the first transmission. After receiving the second transmission, the UE may or may not transmit a third transmission to the NW. In the case that the UE transmits the third transmission to the NW, the NW may transmit a fourth transmission to the UE in response to reception of the third transmission. In response to or after transmitting the third transmission, the UE may receive a fourth transmission from the NW.

The first transmission may be a Msg1 and/or MSGA (transmission). The first transmission may include an RA preamble transmission and/or MSGA payload transmission. Preferably in certain embodiments, the first transmission may comprise a first preamble transmission and/or a first uplink data transmission. The first transmission may include a transmission via PRACH and/or a transmission via PUSCH.

The second transmission may be a Msg2, RAR, and/or MSGB (transmission). The second transmission may be an NW response to the first transmission. Preferably in certain embodiments, the second transmission may comprise a first downlink control transmission and/or a first downlink data transmission. The second transmission may include a transmission via PDCCH and/or PDSCH. The second transmission may provide/indicate a UL grant for scheduling UL resource(s).

The third transmission may be a Msg3 (transmission). The third transmission may be uplink transmission using the UL grant/resource(s) provided/indicated by the second transmission. Preferably in certain embodiments, the third transmission may comprise a second uplink data transmission. The third transmission may include a transmission via PUSCH.

The fourth transmission may be a Msg4 (transmission). The fourth transmission may be an NW response to the third transmission. Preferably in certain embodiments, the fourth transmission may comprise a second downlink control transmission and/or a second downlink data transmission. The fourth transmission may include a transmission via PDCCH and/or a transmission via PDSCH.

The RA resources selections (steps) may be performed in any order. A second kind of RA resources selection (step) may depend on a first kind of RA resource selection (step). The RA resources selection(s) (step(s)) may be performed before the first transmission. The RA resources selection(s) (step(s)) may be performed after, when, or in response to initiating or triggering the RA procedure.

In an RA procedure (e.g., for ambient IoT), the UE may not perform UL carrier selection. The UE may not select a UL carrier (e.g., SUL, NUL). The UE may not be configured with supplementary uplink. The UE may not evaluate the RSRP of the downlink pathloss reference with a RSRP threshold for SUL (e.g., rsrp-ThresholdSSB-SUL). The UE may not select RA resources based on a UL carrier. Preferably in certain embodiments, the UE may determine a UL carrier based on frequency (e.g., DL carrier or DL frequency band) of a received/detected carrier wave (signal). For instance, the UL carrier is associated with or corresponds to the frequency (e.g., DL carrier or DL frequency band) of the received/detected carrier wave (signal).

In an RA procedure (e.g., for ambient IoT), the UE may not perform SSB selection and/or CSI-RS selection. The UE may not select an SSB/CSI-RS. The UE may not be configured with parameter(s) associated with beam. The UE may not be (explicitly) provided SSBs and/or CSI-RSs. The UE may not evaluate the Synchronization Signal Reference Signal Received Power (SS-RSRP) with an RSRP threshold for SSB (e.g., rsrp-ThresholdSSB, msgA-RSRP-ThresholdSSB). The UE may not evaluate the CSI-RSRP with an RSRP threshold for CSI-RS (e.g., rsrp-ThresholdCSI-RS). The UE may not select RA resources based on SSB/CSI-RS. Alternatively, RA resource(s)/configuration is (only) allowed to be associated with a specific or same SSB. The UE may (always) select the specific or same SSB.

One or more of the above RA resources selection/step could be combined.

The above RA resources selections (steps) may be performed based on a first factor. The first factor may be one or more of the following information as described above: UE type, power level, data type, data size, UE ID, and/or UE group.

Association(s) between the first factor and RA resource(s) may be indicated or configured by NW. Alternatively, the association(s) may be determined by the UE. Alternatively, the association(s) may be fixed.

One or more of the above embodiment(s), concept(s), method(s), example(s) of the first factor could be combined.

Throughout the present disclosure, the BWP may be referred to and/or be replaced by an initial BWP.

The UE may be configured with one or more BWPs of a cell. Alternatively and/or additionally, a cell may include or indicate more than one BWP (for ambient IoT). The BWP may be a BWP configured with RA resources and/or an RA configuration (for ambient IoT). The BWP may be a BWP configured with PRACH occasions (for ambient IoT). The BWP may be a BWP that the UE could perform the RA procedure. The BWP may be initialUplinkBWP. The UE may be configured with different BWPs in different bands and/or frequencies of a cell. The UE may be configured with multiple BWPs with spectrum deployment in-band to an NR cell. There may be different/separate RA configurations and/or RA resources configured on the more than one BWPs. The RA configuration and/or RA resources may correspond to, be associated with, and/or be used by (one or more) the UE and/or first factor. The BWP may be UL BWP.

The UE may perform BWP selection in an RA procedure, e.g., after or in response to triggering the RA procedure. After or in response to selecting an initial BWP, the UE may perform other kind(s) of RA resources selection(s) (step(s)) (e.g., based on the selected initial BWP) and/or perform the first transmission (e.g., on the selected BWP). When the UE selects a BWP of a cell, the UE may switch (active) BWP of the cell. When the UE selects a BWP of a cell, the UE may deactivate a current BWP and/or activate the selected BWP of the cell. The UE may select a BWP based on the first factor. After the BWP of a cell is selected, the UE does not switch the BWP of the cell during the RA procedure. Alternative, the UE is allowed to switch the BWP of the cell, e.g., based on the first factor, during the RA procedure.

For example, the UE may select a first BWP of a cell if at least the UE is a first type UE. The UE may select a second BWP of the cell if at least the UE is a second type UE.

For example, the UE may select a BWP based on one or more thresholds for power level. The UE may select a first BWP of a cell or a second BWP of the cell based on different power levels. The UE may select a BWP if at least a threshold (for power level) is fulfilled. The UE may not select a BWP if at least the threshold is not fulfilled. The UE may select a BWP once the threshold is fulfilled. The UE may not select a BWP until the threshold is fulfilled. Preferably in certain embodiments, the UE may select a second initial BWP if a second threshold is fulfilled. The UE may select a first initial BWP if the second threshold is not fulfilled and/or if a first threshold is fulfilled.

For example, the UE may select a first BWP of a cell for a first UL data type. The UE may select a second BWP of the cell for a second UL data type.

For example, the UE may select a BWP based on a threshold for UL data size. The UE may select a first BWP of a cell or a second BWP of the cell based on different UL data sizes.

For example, the UE may select a BWP based on (a formula using) its UE ID. The UE may select a first BWP of a cell or a second BWP of the cell based on (a formula using) its UE ID. For example, (UE ID) mod (number of BWPs of a cell among which the UE is to select one) could be used to derive or could be equal to an (index of) BWP to be selected by the UE.

For example, the UE may select a BWP based on (a formula using) its UE group (ID). The UE may select a first BWP of a cell or a second BWP of the cell based on its UE group (ID). The UE may select a first BWP of a cell or a second BWP of the cell based on a formula using its UE group ID. For example, (UE group ID) mod (number of BWPs of a cell among which the UE is to select one) could be used to derive or could be equal to an (index of) BWP to be selected by the UE.

For example, the UE may select a BWP based on (a formula using) its UE ID and its UE group (ID).

For example, the UE may select a BWP randomly (with equal probability) from more than one BWP of a cell.

Preferably in certain embodiments, the BWP (in above or below) may be changed/represented/replaced by frequency (sub-) band or frequency resource set.

Preferably in certain embodiments, when the UE receives/detects a carrier wave (signal), the UE may derive/determine a BWP, a (initial) frequency (sub-) band or a (initial) frequency resource set based on at least frequency (e.g., DL carrier or DL frequency band). Preferably in certain embodiments, the UE may derive/determine a BWP, a (initial) frequency (sub-) band or (initial) frequency resource set based on at least BWP, frequency (sub-) band or frequency resource set information provided from network.

Throughout the present disclosure, the RA configuration may be referred to and/or be replaced by an RA configuration group, an RA resource(s) and/or an RA resource group.

The UE may be configured with multiple RA configurations for a cell. Alternatively and/or additionally, a cell may provide or indicate multiple RA configurations (for ambient IoT). The UE may be configured with multiple RA resources groups. Alternatively and/or additionally, the cell may provide or indicate multiple RA resources groups (for ambient IoT). The UE may be configured with multiple RA configuration groups. Alternatively and/or additionally, the cell may provide or indicate multiple RA configuration groups (for ambient IoT). The multiple RA configurations, RA resources group, and/or RA configuration groups may be configured on different BWPs. The multiple RA configurations, RA resources group, and/or RA configuration groups may be configured on a same BWP. The RA configuration, RA resources group, and/or RA configuration group may correspond to, be associated with, and/or be used by the (one or more) UE and/or first factor.

The RA configuration/resources group may be defined, configured, or selected based on the first factor. The RA configuration/resources group may be associated with a power level, e.g., determined by one or more thresholds. Each power level may be associated with and/or configured with a (separate) RA configuration or a group of RA resources of a cell. The RA configuration group may be associated with a data size level, e.g., determined by one or more thresholds. Each data size level may be associated with and/or configured with an (separate) RA configuration or a group of RA resources of a cell.

The UE may select an RA configuration, RA resources group, and/or RA configuration group, e.g., after or in response to triggering the RA procedure, selecting a BWP, selecting an RA type. After or in response to selecting an RA configuration, the UE may perform other kind(s) of RA resources selection(s) (step(s)) (e.g., based on the selected RA configuration) and/or perform the first transmission (e.g., using the selected RA configuration). The UE may select an RA configuration, RA resources group, and/or RA configuration group of the cell based on the first factor.

For example, the UE may select a first RA configuration of a cell if at least the UE is a first type UE. The UE may select a second RA configuration of the cell if at least the UE is a second type UE.

For example, the UE may select an RA configuration based on one or more thresholds for power level. The UE may select a first RA configuration of a cell or a second RA configuration of the cell based on different power levels. The UE may select a first RA configuration of a cell, a second RA configuration of the cell, or a third RA configuration of the cell based on different power levels. The UE may select an RA configuration if at least a threshold (for power level) is fulfilled. The UE may not select an RA configuration if at least the threshold is not fulfilled. The UE may select an RA configuration once the threshold is fulfilled. The UE may not select an RA configuration until the threshold is fulfilled. Preferably in certain embodiments, the UE may select a second RA configuration if a second threshold is fulfilled. The UE may select a first RA configuration if the second threshold is not fulfilled and/or if a first threshold is fulfilled.

For example, the UE may select a first RA configuration of a cell for a first UL data type. The UE may select a second RA configuration of the cell for a second UL data type.

For example, the UE may select an RA configuration based on a threshold for UL data size. The UE may select a first RA configuration of a cell or a second RA configuration of the cell based on a different UL data size. The UE may select a first RA configuration of a cell, a second RA configuration of the cell, and/or a third RA configuration of the cell based on a different UL data size.

For example, the UE may select an RA configuration based on (a formula using) its UE ID. The UE may select a first RA configuration of a cell or a second RA configuration of the cell based on (a formula using) its UE ID. For example, (UE ID) mod (number of RA configurations of a cell among which the UE is to select one) could be used to derive or could be equal to an (index of) RA configuration to be selected by the UE.

For example, the UE may select an RA configuration based on (a formula using) its UE group (ID). The UE may select a first RA configuration of a cell or a second RA configuration of the cell based on its UE group (ID). The UE may select a first RA configuration of a cell or a second RA configuration of the cell based on a formula using its UE group ID. For example, (UE group ID) mod (number of RA configuration of a cell among which the UE is to select one) could be used to derive or could be equal to a (index of) BWP to be selected by the UE.

For example, the UE may select an RA configuration based on (a formula using) its UE ID and its UE group (ID).

For example, the UE may select an RA configuration randomly (with equal probability) from multiple RA configurations of a cell.

The UE may be configured with 2-step RA and/or 4-step RA. Alternatively and/or additionally, a cell may include or indicate a 2-step RA configuration and/or 4-step RA configuration (for ambient IoT). The UE may be (always) configured with both a 2-step RA and 4-step RA. The UE may be (always) configured with a 2-step RA without a 4-step RA. The UE may not use or support a 4-step RA. The UE may not be (allowed to) configure a 4-step RA. Alternatively and/or additionally, a cell may not be (allowed to) include or indicate a 4-step RA configuration (for ambient IoT). The UE may perform a 2-step RA for the RA procedure. The 2-step RA may not include the third transmission or the fourth transmission. The UE may perform a 4-step RA for the RA procedure. The 2-step RA may be an RA type with (at least) the first transmission and the second transmission. The 4-step RA may be an RA type with (at least) the first transmission, the second transmission, the third transmission, and the fourth transmission. In a 2-step RA procedure, the UE may transmit UL data/signaling in the first transmission. In a 4-step RA procedure, the UE may not transmit UL data/signaling in the first transmission. In a 4-step RA procedure, the UE may transmit UL data/signaling in the third transmission. The RA type may correspond to, be associated with, and/or be used by (one or more) UE and/or first factor.

The UE may select an RA type, e.g., after or in response to triggering the RA procedure, selecting a BWP, selecting an RA configuration/resources group. After or in response to selecting an RA type, the UE may perform other kind(s) of RA resources selection(s) (step(s)) (e.g., based on the selected RA type) and/or perform the first transmission. The UE may (always) select 2-step RA. The UE may select an RA type not based on an RSRP of a downlink pathloss reference. The UE may not select an RA type based on the RSRP of the downlink pathloss reference. The UE may not select an RA type based on an RSRP threshold e.g., (msgA-RSRP-Threshold). The UE may select an RA type based on the first factor.

For example, the UE may select a first RA type for a first type UE. The UE may select a second RA type for a second type UE. When/if the UE is a first type UE, the UE may select the first RA type for the first type UE. When/if the UE is a second type UE, the UE may select the second RA type for the second type UE.

For example, the UE may select an RA type based on one or more thresholds for power level. The UE may select a first RA type or a second RA type based on a different power level. The UE may select an RA type if the threshold is fulfilled. The UE may not select an RA type if the threshold is not fulfilled. The UE may select an RA type once the threshold is fulfilled. The UE may not select an RA type until the threshold is fulfilled.

For example, the UE may select a first RA type for a first UL data type. The UE may select a second RA type for a second UL data type.

For example, the UE may select an RA type based on a threshold for UL data size. The UE may select a first RA type or a second RA type based on a different UL data size.

For example, the UE may select a first RA type or a second RA type based on a formula using its UE ID.

For example, the UE may select a first RA type or a second RA type based on its UE group (ID). The UE may select a first RA type or a second RA type based on a formula using its UE group ID.

The UE may be configured with one or more RA preamble groups of a cell, e.g., in an RA configuration. The RA preamble group may correspond to, be associated with, and/or be used by the (one or more) UE and/or first factor. An RA preamble group may include a set of RA preambles or RA preamble indexes.

The UE may perform RA preamble (group) selection in an RA procedure, e.g., after or in response to triggering the RA procedure, selecting a BWP, selecting an RA configuration/resources group, setting an RA type. The UE may select an RA preamble group then (randomly) select an RA preamble (index) among the selected RA preamble group. After or in response to selecting an RA preamble (group), the UE may perform other kind(s) of RA resources selection(s) (step(s)) (e.g., based on the selected RA preamble (group)) and/or perform the first transmission (e.g., using the selected RA preamble). The UE may select an RA preamble (group) based on NW indication, e.g., via SIB, paging, or PDCCH. The UE may select an RA preamble (group) based on the first factor.

For example, the UE may select a first RA preamble group (in an RA configuration) of a cell if at least the UE is a first type UE. The UE may select a second RA preamble group (in the RA configuration) of the cell if at least the UE is a second type UE.

For example, the UE may select an RA preamble group based on one or more thresholds for power level. The UE may select a first RA preamble group (in an RA configuration) of a cell or a second RA preamble group (in the RA configuration) of the cell based on different power levels. The UE may select a first RA preamble group (in an RA configuration) of a cell, a second RA preamble group (in the RA configuration) of the cell and/or a third RA preamble group (in the RA configuration) of the cell based on different power levels. The UE may select an RA preamble (group or index) if at least the threshold is fulfilled. The UE may not select an RA preamble (group or index) if at least the threshold is not fulfilled. The UE may select an RA preamble (group or index) once the threshold is fulfilled. The UE may not select an RA preamble (group or index) until the threshold is fulfilled. Preferably in certain embodiments, the UE may select a second RA preamble (group or index) if a second threshold is fulfilled. The UE may select a first RA preamble (group or index) if the second threshold is not fulfilled and/or if a first threshold is fulfilled.

For example, the UE may select a first RA preamble group (in an RA configuration) of a cell for a first UL data type. The UE may select a second RA preamble group (in the RA configuration) of the cell for a second UL data type. The UE may select a third RA preamble group (in the RA configuration) of the cell for a third UL data type.

For example, the UE may select an RA preamble group based on a threshold for UL data size. The UE may select a first RA preamble group (in an RA configuration) of a cell or a second RA preamble group (in the RA configuration) of the cell based on different UL data sizes. The UE may select a first RA preamble group (in an RA configuration) of a cell, a second RA preamble group (in the RA configuration) of the cell, and/or a third RA preamble group (in the RA configuration) of the cell based on different UL data sizes.

For example, the UE may select an RA preamble (group or index) based on (a formula using) its UE ID. The UE may select a first RA preamble (group or index) (in an RA configuration) of a cell or a second RA preamble (group or index) (in the RA configuration) of the cell based on (a formula using) its UE ID. The UE may select a first RA preamble (group or index) (in an RA configuration) of a cell, a second RA preamble (group or index) (in the RA configuration) of the cell, and/or a third RA preamble (group or index) (in the RA configuration) of the cell based on (a formula using) its UE ID. For example, (UE ID) mod (number of RA preamble group (in an RA configuration) of a cell among which the UE is to select one) could be used to derive or could be equal to an (index of) RA preamble group to be selected by the UE. For example, (UE ID) mod (number of RA preamble index (in an RA preamble group) (in an RA configuration) of a cell among which the UE is to select one) could be used to derive or could be equal to an (index of) RA preamble index to be selected by the UE.

For example, the UE may select an RA preamble (group or index) based on (a formula using) its UE group (ID). The UE may select a first RA preamble (group or index) (in an RA configuration) of a cell or a second RA preamble (group or index) (in the RA configuration) of the cell based on its UE group (ID). The UE may select a first RA preamble (group or index) (in an RA configuration) of a cell, a second RA preamble (group or index) (in the RA configuration) of the cell, and/or a third RA preamble (group or index) (in the RA configuration) of the cell based on its UE group (ID). The UE may select a first RA preamble (group or index) (in an RA configuration) of a cell or a second RA preamble (group or index) (in the RA configuration) of the cell based on a formula using its UE group ID. The UE may select a first RA preamble (group or index) (in an RA configuration) of a cell, a second RA preamble (group or index) (in the RA configuration) of the cell, and/or a third RA preamble (group or index) (in the RA configuration) of the cell based on a formula using its UE group ID. For example, (UE group ID) mod (number of RA preamble group (in an RA configuration) of a cell among which the UE is to select one) could be used to derive or could be equal to an (index of) RA preamble group to be selected by the UE. For example, (UE group ID) mod (number of RA preamble index (in an RA preamble group) (in an RA configuration) of a cell among which the UE is to select one) could be used to derive or could be equal to an (index of) RA preamble index to be selected by the UE.

For example, the UE may select an RA preamble (group or index) based on (a formula using) its UE ID and its UE group (ID).

For example, the UE may select an RA preamble group randomly (with equal probability) from more than one RA preamble group (in an RA configuration) of a cell.

For example, the UE may select an RA preamble index randomly (with equal probability) from more than one RA preamble index (in an RA preamble group) (in an RA configuration) of a cell.

The number of RA preamble(s) may be different in each RA preamble group.

The UE may use an RA preamble group with more RA preambles if it has lower power, e.g., based on a power level. The UE may use an RA preamble group with more RA preambles if it has higher power, e.g., based on a power level. The UE may use an RA preamble group with more RA preambles if it has more critical data, e.g., based on a data type. The UE may use an RA preamble group with more RA preambles if it has less available data, e.g., based on a UL data size. The UE may use an RA preamble group with more RA preambles if it has more available data, e.g., based on a UL data size. The UE may use an RA preamble group with more RA preambles if it is in a UE group with more UEs, e.g., based on a UE group ID.

The UE may use an RA preamble group with less RA preambles if it has higher power, e.g., based on a power level. The UE may use an RA preamble group with less RA preambles if it has lower power, e.g., based on a power level. The UE may use an RA preamble group with less RA preambles if it has less critical data, e.g., based on data type. The UE may use an RA preamble group with less RA preambles if it has less available data, e.g., based on a UL data size. The UE may use an RA preamble group with less RA preambles if it has more available data, e.g., based on a UL data size. The UE may use an RA preamble group with less RA preambles if it is in a UE group with less UEs, e.g., based on a UE group ID.

The RACH occasions (ROs) and/or PUSCH occasions may be configured/included in an RA configuration (of a cell). The RACH occasion(s) and/or PUSCH occasion(s) may correspond to, be associated with, and/or be used by the (one or more) UE and/or first factor. The RACH occasion(s) may be a time/frequency resource for a RACH transmission. The PUSCH occasion(s) may be a time/frequency resource for a PUSCH transmission.

The UE may perform an RO and/or PUSCH occasion(s) selection in an RA procedure, e.g., after or in response to triggering the RA procedure, selecting a BWP, selecting an RA configuration/resources group, setting an RA type, selecting an RA preamble, selecting RO(s). After or in response to selecting RO(s) and/or PUSCH occasion(s), the UE may perform other kind(s) of RA resources selection(s) (step(s)) (e.g., based on the selected RO(s) and/or PUSCH occasion(s)) and/or perform the first transmission (e.g., using the selected RO(s) and/or PUSCH occasion(s)). The UE may select RO(s) and/or PUSCH occasion(s) based on and/or associated with the selected RA preamble (group or index). The UE may select the closest RO(s) and/or PUSCH occasion(s) based on and/or associated with the selected RA resources/configuration. The UE may (randomly) select RO(s) and/or PUSCH occasion(s) among the closest N RO(s) and/or PUSCH occasion(s) based on and/or associated with the selected RA resources/configuration. N may be indicated or configured by the NW. Alternatively, N may be determined by the UE. Alternatively, N may be fixed. N may be related to the number of UE groups. N may be an integer and/or larger than 1 (or 2 or 3). The UE may select RO(s) and/or PUSCH occasion(s) based on the first factor.

For example, the UE may select a first RO(s) and/or PUSCH occasion(s) (in an RA configuration) of a cell if at least the UE is a first type UE. The UE may select a second RO(s) and/or PUSCH occasion(s) (in the RA configuration) of the cell if at least the UE is a second type UE.

For example, the UE may select RO(s) and/or PUSCH occasion(s) based on one or more thresholds for power level. The UE may select first RO(s) and/or PUSCH occasion(s) (in an RA configuration) of a cell or second RO(s) and/or PUSCH occasion(s) (in the RA configuration) of the cell based on different power levels. The UE may select first RO(s) and/or PUSCH occasion(s) (in an RA configuration) of a cell, second RO(s) and/or PUSCH occasion(s) (in the RA configuration) of the cell and/or third RO(s), and/or PUSCH occasion(s) (in the RA configuration) of the cell based on different power levels. The UE may select RO(s) and/or PUSCH occasion(s) if at least the threshold is fulfilled. The UE may not select RO(s) and/or PUSCH occasion(s) if at least the threshold is not fulfilled. The UE may select RO(s) and/or PUSCH occasion(s) once the threshold is fulfilled. The UE may not select RO(s) and/or PUSCH occasion(s) until the threshold is fulfilled. Preferably in certain embodiments, the UE may select second RO(s) and/or PUSCH occasion(s) if a second threshold is fulfilled. The UE may select first RO(s) and/or PUSCH occasion(s) if the second threshold is not fulfilled and/or if a first threshold is fulfilled.

For example, the UE may select first RO(s) and/or PUSCH occasion(s) (in an RA configuration) of a cell for a first UL data type. The UE may select second RO(s) and/or PUSCH occasion(s) (in the RA configuration) of the cell for a second UL data type. The UE may select third RO(s) and/or PUSCH occasion(s) (in the RA configuration) of the cell for a third UL data type.

For example, the UE may select RO(s) and/or PUSCH occasion(s) based on a threshold for UL data size. The UE may select first RO(s) and/or PUSCH occasion(s) (in an RA configuration) of a cell or second RO(s) and/or PUSCH occasion(s) (in the RA configuration) of the cell based on different UL data sizes. The UE may select first RO(s) and/or PUSCH occasion(s) (in an RA configuration) of a cell, second RO(s) and/or PUSCH occasion(s) (in the RA configuration) of the cell, and/or third RO(s) and/or PUSCH occasion(s) (in the RA configuration) of the cell based on different UL data sizes.

For example, the UE may select RO(s) and/or PUSCH occasion(s) based on (a formula using) its UE ID. The UE may select first RO(s) and/or PUSCH occasion(s) (in an RA configuration) of a cell or second RO(s) and/or PUSCH occasion(s) (in the RA configuration) of the cell based on (a formula using) its UE ID. The UE may select first RO(s) and/or PUSCH occasion(s) (in an RA configuration) of a cell, second RO(s) and/or PUSCH occasion(s) (in the RA configuration) of the cell, and/or third RO(s) and/or PUSCH occasion(s) (in the RA configuration) of the cell based on (a formula using) its UE ID. For example, (UE ID) mod (number of RO(s) and/or PUSCH occasion(s) (in an RA configuration) of a cell among which the UE is to select one) could be used to derive or could be equal to an (index of) RO and/or PUSCH occasion to be selected by the UE.

For example, the UE may select RO(s) and/or PUSCH occasion(s) based on (a formula using) its UE group (ID). The UE may select first RO(s) and/or PUSCH occasion(s) (in an RA configuration) of a cell or second RO(s) and/or PUSCH occasion(s) (in the RA configuration) of the cell based on (a formula using) its UE group (ID). The UE may select first RO(s) and/or PUSCH occasion(s) (in an RA configuration) of a cell, second RO(s) and/or PUSCH occasion(s) (in the RA configuration) of the cell, and/or third RO(s) and/or PUSCH occasion(s) (in the RA configuration) of the cell based on (a formula using) its UE group (ID). For example, (UE group ID) mod (number of RO(s) and/or PUSCH occasion(s) (in an RA configuration) of a cell among which the UE is to select one) could be used to derive or could be equal to an (index of) RO and/or PUSCH occasion to be selected by the UE.

For example, the UE may select RO(s) and/or PUSCH occasion(s) based on (a formula using) its UE ID and its UE group (ID).

For example, the UE may select RO(s) and/or PUSCH occasion(s) randomly (with equal probability) from (a number of) ROs and/or PUSCH occasion(s) (in an RA configuration) of a cell.

In an RA procedure (e.g., for ambient IoT), the UE may perform one or more selections (step(s)) of the following kinds of RA resources (e.g., resources selection(s) for the first transmission):
(initial) (UL) BWP (for ambient IoT);
RA resources/configuration (group) (for ambient IoT);
RA/transmission type (for ambient IoT), e.g., based on the first factor;
RA preamble (group and/or index) (for ambient IoT);
RACH occasion (for ambient IoT);
PUSCH occasion (for ambient IoT); and/or
PDRCH occasion (for ambient IoT).

Throughout the present disclosure, the “DL” may be replaced by “Reader to Device (R2D).” A DL transmission may be, be referred to, and/or be supplemented by a transmission from a reader to a device and/or an R2D transmission. A DL data may be, be referred to, and/or be supplemented by a data available on a reader side, a data to be transmitted from a reader to a device, and/or a R2D data. A DL transmission and/or DL data may comprise an indication, configuration, signal/signaling/signalling, and/or message from a reader.

Throughout the present disclosure, the “UL” may be replaced by “Device to Reader (D2R).” A UL transmission may be, be referred to, and/or be supplemented by a transmission from a device to a reader and/or a D2R transmission. A UL data may be, be referred to, and/or be supplemented by a data available on a device side, a data to be transmitted from a device to a reader, and/or a D2R data. A UL transmission and/or UL data may comprise an indication, signal/signaling, and/or message from a device. A UL grant may be one or more resources provided from the reader/NW/intermediate node, used by the device/UE, and/or used to transmit/perform D2R transmission.

Throughout the present disclosure, the reader may be and/or may be replaced by the NW/intermediate node, UE, and/or intermediate node. Throughout the present disclosure, the device may be and/or may be replaced by the UE and/or intermediate node. The device may be referred to as an ambient IoT device. The “UE” may comprise a reader and/or device. The “NW/intermediate node” may comprise a reader.

The UE/device may receive carrier wave(s) from a reader. The UE/device may receive carrier wave(s) from a node other than the reader.

Throughout the present disclosure, the “RA (random access)” may be, be replaced by, and/or be referred to as an access procedure performed by the (ambient IoT) UE/device. The resource(s) and/or configuration(s) for the access procedure may comprise PDRCH resource(s), occasion(s), frequency, and/or band, e.g., for D2R transmission. The resource(s) and/or configuration(s) for the access procedure may comprise a parameter, random number, group number, and/or assistance information, e.g., for D2R transmission.

Throughout the present disclosure, the “2-step RA” may be, may be replaced by, and/or may be referred to as a 2-step access procedure performed by the (ambient IoT) UE/device.

Throughout the present disclosure, the “4-step RA” may be, may be replaced by, and/or may be referred to as a 4-step access procedure performed by the (ambient IoT) UE/device.

The UE may perform a procedure of RA, (initial) access, (ambient IoT) response/report, and/or (R2D/D2R) transmission. The procedure may be a procedure described above. The UE may access the NW/intermediate node, receive signaling/message/configuration, and/or transmit (D2R) data via the procedure. The UE may receive a signaling from the NW/intermediate node (e.g., from a reader). The signaling may be a signaling described above. The signaling may be a query, paging, indication, and/or an R2D message.

In response to (receiving) the signaling, the UE may trigger/perform the procedure and/or the following transmission. In the procedure, the UE may transmit a first transmission to the NW/intermediate node. The NW/intermediate node may transmit a second transmission to the UE in response to reception/detection of the first transmission. In response to or after transmitting the first transmission, the UE may receive a second transmission from the NW/intermediate node. In response to (receiving) the second transmission, the UE may transmit a third transmission to the NW/intermediate node. The NW/intermediate node may transmit a fourth transmission to the UE in response to reception of the third transmission. The NW/intermediate node may not transmit the fourth transmission to the UE in response to reception of the third transmission. In response to or after transmitting the third transmission, the UE may or may not receive a fourth transmission from the NW/intermediate node. In response to (receiving) the fourth transmission, the UE may transmit a fifth transmission to the NW/intermediate node.

The first transmission in the procedure may be/comprise information of a random number, information of a preamble number, and/or information of an (access) ID selected/generated/determined by the UE.

The second transmission in the procedure may be a response to the first transmission and/or an acknowledge. The second transmission may indicate, identify, and/or correspond to the first transmission. The second transmission may provide resource(s) for the following D2R transmissions, e.g., the third transmission.

The third transmission in the procedure may be/comprise information of a device/UE ID, report, assistance information, D2R data, and/or information from the UE.

The fourth transmission in the procedure may be a response to the third transmission, an acknowledge, DL/R2D command, R2D data, and/or a scheduling. The fourth transmission may indicate, identify, and/or correspond to the third transmission. The fourth transmission may provide resource(s) for the following D2R transmissions. The fourth transmission may indicate, notify, and/or allow the fifth transmission.

The fifth transmission in the procedure may be/comprise a feedback (of the fourth transmission), report, assistance information, D2R data, and/or information from the UE.

The first transmission, third transmission, and fifth transmission may be D2R transmissions and/or PDRCH transmissions. The signaling, second transmission, and fourth transmission may be R2D transmissions and/or PRDCH transmissions. The signaling and second transmission may be broadcast, provided, and/or transmitted to one or multiple UEs. The second transmission and fourth transmission may be provided and/or transmitted to a dedicated UE. The fourth transmission and/or the fifth transmission may be a subsequent transmission during or after the procedure.

Throughout the present disclosure, a Msg1 and/or MSGA may be replaced by a first transmission. Throughout the present disclosure, a Msg2, RAR, and/or MSGB may be replaced by a second transmission. Throughout the present disclosure, a MSGA and/or Msg3 may be replaced by a third transmission. Throughout the present disclosure, a MSGB and/or Msg4 may be replaced by a fourth transmission. Throughout the present disclosure, a Msg5 may be replaced by a fifth transmission.

An identity of the UE and/or a UE ID may be or comprise a random number, temporary number, preamble number (e.g., RAPID), and/or ID selected/generated/determined by the UE. An identity of the UE and/or a UE ID may be or comprise a device ID, UE ID, group ID, Contention Resolution Identity, and/or Radio Network Temporary Identifier (RNTI) of the UE. The (access) ID comprised in the first transmission may be different from the device/UE ID comprised in the third transmission.

Throughout the present disclosure, the following may be interchangeable: “initiate a procedure”, “perform a procedure”, “trigger a procedure” and/or “execute a procedure.”

Throughout the present disclosure, the Common Control Channel (“CCCH”), “PRACH”, “RACH”, “PUSCH” and/or “PUCCH” may be, be comprised by, be replaced by, and/or be referred to “physical device to reader channel”, a channel for transmission from device to reader, and/or PDRCH. Throughout the present disclosure, the “PDSCH” and/or “PDCCH” may be, be comprised by, be replaced by, and/or be referred to “physical reader to device channel”, a channel for transmission from reader to device, and/or PRDCH. A D2R transmission may be transmitted via a PDRCH. A R2D transmission may be transmitted via a PRDCH.

Throughout the present disclosure, the “RA resource(s)/configuration(s)”, “UL resource(s)/configuration(s)” and/or “resource(s)/configuration(s)” may be, be replaced by, and/or be referred to resource(s)/configuration(s) for D2R transmission (e.g., as described above). The resource(s) and/or configuration(s) may comprise PDRCH (transmission) resource(s), occasion(s), channel resource(s), frequency resources, and/or (sub-) band(s), e.g., for D2R transmission. The resource(s) and/or configuration(s) may comprise a parameter, random number, group number, and/or assistance information, e.g., for D2R transmission.

The UE may monitor/receive the PRDCH in the procedure of RA, (initial) access and/or (R2D/D2R) transmission.

The UE may utilize same or different power level embodiment(s) for different RA resources selection (step(s)), e.g., determination of PDRCH occasion(s).

A UE may determine/derive its location or range based on a R2D signal/channel, and/or PRDCH. More specifically, the UE may determine/derive its location or range from a network/intermediate node based on a R2D signal/channel, and/or PRDCH transmitted from the network/intermediate node. The UEs in the same location and/or the same range may mean the UEs with the same received power range of the R2D signal/channel, and/or PRDCH. Preferably and/or alternatively in certain embodiments, the UEs in a same location and/or same position range may be distributed to different UE groups. The UEs among the range which could receive the same NW signal (e.g., R2D signal/channel, PRDCH) may be (randomly) distributed to different UE groups.

Preferably, the BWP (in above or below) may be changed/represented/replaced by system bandwidth/band and/or transmission bandwidth/band. The BWP, bandwidth and/or band may be for R2D and/or D2R.

Preferably in certain embodiments, when the UE receives/detects a PRDCH and/or R2D signal/channel, the UE may derive/determine a BWP, an (initial) frequency (sub-) band, or (initial) frequency resource set based on at least frequency (e.g., DL carrier or DL frequency band).

The RACH occasions (ROs) or PDRCH occasions may be configured/included in an RA configuration (of a cell). The RACH occasion(s) or PDRCH occasions may correspond to, be associated with, and/or be used by the (one or more) UE and/or first factor. The RACH occasion(s) may be a time and/or frequency resource for a RACH transmission or a D2R transmission. The PDRCH occasion(s) may be a time and/or frequency resource for a PDRCH transmission or a D2R transmission. In the following, the RO(s) may be replaced by PDRCH occasion(s).

The PDRCH occasions may be configured/included in an RA configuration (of a cell). The PDRCH occasion(s) may correspond to, be associated with, and/or be used by the (one or more) UE and/or first factor. The PDRCH occasion(s) may be a time/frequency resource for a PDRCH transmission or a D2R transmission.

The UE may perform PDRCH occasion(s) selection in an RA procedure, e.g., after or in response to triggering the RA procedure, selecting a BWP, selecting an RA configuration/resources group, setting an RA type, selecting an RA preamble, selecting RO(s). After or in response to selecting PDRCH occasion(s), the UE may perform other kind(s) of RA resources selection(s) (step(s)) (e.g., based on the selected PDRCH occasion(s)) and/or perform the first transmission (e.g., using the selected PDRCH occasion(s)). The UE may select PDRCH occasion(s) based on and/or associated with the selected RA preamble (group or index) and/or RO(s). The UE may select the closest PDRCH occasion(s) based on and/or associated with the selected RA resources/configuration (e.g., RA preamble, RO(s)). The UE may (randomly) select PDRCH occasion(s) among the closest N PDRCH occasion(s) based on and/or associated with the selected RA resources/configuration (e.g., RA preamble, RO(s)). N may be indicated or configured by the NW.

Alternatively, N may be determined by the UE. Alternatively, N may be fixed. N may be related to the number of UE groups. N may be an integer and/or larger than 1 (or 2 or 3). The UE may select PDRCH occasion(s) based on the first factor.

For example, the UE may select a first PDRCH occasion(s) (in an RA configuration) of a cell if at least the UE is a first type UE. The UE may select a second PDRCH occasion(s) (in the RA configuration) of the cell if at least the UE is a second type UE.

For example, the UE may select PDRCH occasion(s) based on one or more thresholds for power level. The UE may select first PDRCH occasion(s) (in an RA configuration) of a cell or second PDRCH occasion(s) (in the RA configuration) of the cell based on different power levels. The UE may select first PDRCH occasion(s) (in an RA configuration) of a cell, second PDRCH occasion(s) (in the RA configuration) of the cell and/or third PDRCH occasion(s) (in the RA configuration) of the cell based on different power levels. The UE may select PDRCH occasion(s) if at least the threshold is fulfilled. The UE may not select PDRCH occasion(s) if at least the threshold is not fulfilled. The UE may select PDRCH occasion(s) once the threshold is fulfilled. The UE may not select PDRCH occasion(s) until the threshold is fulfilled. Preferably in certain embodiments, the UE may select second PDRCH occasion(s) if a second threshold is fulfilled. The UE may select first PDRCH occasion(s) if the second threshold is not fulfilled and/or if a first threshold is fulfilled.

For example, the UE may select first PDRCH occasion(s) (in an RA configuration) of a cell for a first UL data type. The UE may select second PDRCH occasion(s) (in the RA configuration) of the cell for a second UL data type. The UE may select third PDRCH occasion(s) (in the RA configuration) of the cell for a third UL data type.

For example, the UE may select PDRCH occasion(s) based on a threshold for UL data size. The UE may select first PDRCH occasion(s) (in an RA configuration) of a cell or second PDRCH occasion(s) (in the RA configuration) of the cell based on different UL data sizes. The UE may select first PDRCH occasion(s) (in an RA configuration) of a cell, second PDRCH occasion(s) (in the RA configuration) of the cell, and/or third PDRCH occasion(s) (in the RA configuration) of the cell based on different UL data sizes.

For example, the UE may select PDRCH occasion(s) based on (a formula using) its UE ID. The UE may select first PDRCH occasion(s) (in an RA configuration) of a cell or second PDRCH occasion(s) (in the RA configuration) of the cell based on (a formula using) its UE ID. The UE may select first PDRCH occasion(s) (in an RA configuration) of a cell, second PDRCH occasion(s) (in the RA configuration) of the cell, and/or third PDRCH occasion(s) (in the RA configuration) of the cell based on (a formula using) its UE ID. For example, (UE ID) mod (number of PDRCH occasion(s) (in an RA configuration) of a cell among which the UE is to select one) could be used to derive or could be equal to an (index of) RO to be selected by the UE.

For example, the UE may select PDRCH occasion(s) based on (a formula using) its UE group (ID). The UE may select first PDRCH occasion(s) (in an RA configuration) of a cell or second PDRCH occasion(s) (in the RA configuration) of the cell based on (a formula using) its UE group (ID). The UE may select first PDRCH occasion(s) (in an RA configuration) of a cell, second PDRCH occasion(s) (in the RA configuration) of the cell, and/or third PDRCH occasion(s) (in the RA configuration) of the cell based on (a formula using) its UE group (ID). For example, (UE group ID) mod (number of PDRCH occasion(s) (in an RA configuration) of a cell among which the UE is to select one) could be used to derive or could be equal to an (index of) RO to be selected by the UE.

For example, the UE may select PDRCH occasion(s) based on (a formula using) its UE ID and its UE group (ID).

For example, the UE may select PDRCH occasion(s) randomly (with equal probability) from (a number of) ROs (in an RA configuration) of a cell.

The RA resources may comprise PDRCH occasion(s).

Throughout the present disclosure, the “MSGA” or “MSGA payload” may be replaced by “PDRCH data/transmission/signaling”, “(D2R) data” and/or “(D2R) signaling”.

Throughout the present disclosure, the “PRACH” may be replaced by “PDRCH”.

Throughout the present disclosure, the “PUSCH” may be replaced by “PDRCH” or “physical channel for D2R (data/control) transmission”.

Throughout the present disclosure, the “PDCCH” may be replaced by “PRDCH” or “physical channel for R2D (data/control) transmission”.

Throughout the present disclosure, the “PDSCH” may be replaced by “PRDCH” or “physical channel for R2D (data) transmission”.

Throughout the present disclosure, the “BWP” may be replaced by “system bandwidth”, “channel bandwidth”, “transmission bandwidth”, “occupation bandwidth”.

Throughout the present disclosure, the “RACH” may be replaced by “PDRCH”.

Throughout the present disclosure, the “PDRCH” may be replaced by “physical channel for D2R (data) transmission”.

Throughout the present disclosure, the “PRDCH” may be replaced by “physical channel for R2D (data) transmission”.

Throughout the present disclosure, the (data and/or signaling) transmission from reader to device/UE may be via PRDCH. Throughout the present disclosure, the (data and/or signaling) transmission from device/UE to reader may be via PDRCH.

Throughout the present disclosure, the “downlink control information” may be replaced by R2D control information.

Throughout the present disclosure, the “uplink control information” may be replaced by D2R control information.

Throughout the present disclosure, the downlink control information may be transmitted via PRDCH or R2D command.

The UE (e.g., ambient IoT UE) may receive NW signaling, e.g., via paging, SIB, PDCCH order. In response to (receiving) the NW signaling, the UE may trigger an RA procedure. The signaling may be used to trigger (or indicate) an RA procedure (or initial access) of the UE. The signaling may be used to trigger (or indicate) a transmission (or reception) of the UE. The transmission from the UE may be (or include) a backscattering transmission (or reception) or may be generated internally by the UE. The signaling may be used to provide power source and/or energy to the UE. The signaling may be (or include) any of RRC signaling (e.g., RRC configuration message), MAC signaling (e.g., MAC CE), or PHY signaling (e.g., PDCCH, DCI). The signaling may be (or include) a carrier wave (signal) and/or interrogation signal.

The signaling may be a common signaling or a dedicated signaling. The common signaling may be (or include) a cell-specific configuration. The common signaling may be (or include) a configuration common for multiple UEs, a group of UEs, and/or a UE group. The common signaling may be (or include) a broadcast signaling, system information, and/or paging. The dedicated signaling may be (or include) a UE-specific configuration. The dedicated signaling may be (or include) a configuration dedicated for a (single) UE. The dedicated signaling may be (or include) RRC signaling (e.g., RRC configuration message). The dedicated signaling may be (or include) MAC signaling (e.g., MAC CE). The dedicated signaling may be (or include) PHY signaling (e.g., PDCCH, DCI).

Throughout the present disclosure, a UL transmission may be or may include a first transmission, a third transmission, and/or a subsequent UL transmission. The subsequent UL transmission may be a UL transmission after the first transmission or third transmission. The subsequent UL transmission may be a UL transmission after an RA procedure is completed. Throughout the present disclosure, a DL transmission may be or include a second transmission, a fourth transmission, and/or a subsequent DL transmission. The subsequent DL transmission may be a DL transmission after the second transmission or fourth transmission. The subsequent DL transmission may be a DL transmission after an RA procedure is completed.

The first time duration may be the time when a first/second timer is running. The first time duration may be a time window, e.g., to monitor RA response. The first timer, the first time duration, and/or the response window (as described below) may be ra-ResponseWindow. The second timer, the first time duration, and/or the response window (as described below) may be msgB-ResponseWindow. The first time duration may be started after or in response to the first transmission. The first time duration may be used to receive the second transmission for the UE. The first time duration may be used to transmit the second transmission for the NW.

The second time duration may be the time when a third timer is running. The third timer and/or the second time duration may be a contention resolution timer (e.g., ra-ContentionResolutionTimer). The second time duration may be started after or in response to the third transmission. The second time duration may be used to receive the fourth transmission for the UE. The second time duration may be used to transmit the fourth transmission for the NW.

The UE (e.g., ambient IoT UE) may transmit an RRC message and/or a CCCH message in the RA procedure. The CCCH may be a UL CCCH. The UE may transmit the RRC message and/or the CCCH message to the network, e.g., for initial access. The UE may transmit the RRC message and/or the CCCH message via a first transmission and/or a third transmission. The UE may include the RRC message and/or the CCCH message in the first transmission and/or the third transmission. The RRC message and/or the CCCH message may be an RRC setup request message (e.g., RRCSetupRequest). The RRC message and/or the CCCH message may not be the RRC setup request message. The RRC message and/or the CCCH message may be a (new) message including a first information. The (new) message may include UE ID, indication of cause and/or assistance information. The (new) message may be transmitted via CCCH. The (new) message may be not transmitted via CCCH. The UE may trigger an RRC (establishment) procedure. The UE may not trigger an RRC (establishment) procedure. The UE may establish or set up an RRC connection. The UE may not establish or set up an RRC connection. The RRC message and/or the CCCH message may be transmitted in an RRC (establishment) procedure. The RRC message and/or the CCCH message may be transmitted without an RRC (establishment) procedure. The RRC message and/or the CCCH message may be transmitted in an initial access (procedure) without triggering or establishing an RRC procedure and/or an RRC connection.

The UE (e.g., ambient IoT UE) may not transmit an RRC message and/or a CCCH message in the RA procedure. The UE may transmit a MAC CE to the network, e.g., for initial access. The UE may transmit the MAC CE via a first transmission and/or a third transmission. The UE may include the MAC CE in the first transmission and/or the third transmission. The UE may not include an RRC message and/or a CCCH message in the first transmission and/or the third transmission. The MAC CE may be and/or may include a first information. The MAC CE may be and/or include UE ID, indication of cause and/or assistance information. The MAC CE may be a UE ID MAC CE. The MAC CE may be a MAC CE for reporting the first information. The MAC CE may be a MAC CE for requesting resources for reporting the first information. The MAC CE may be a UE Contention Resolution Identity MAC CE. The UE may not trigger an RRC (establishment) procedure. The UE may not establish or set up an RRC connection.

According to a study item of ambient IoT ([1] RP-234058), an ambient IoT UE has limited energy storage (may be possibly even with no energy storage). Comparing an NR UE with power consumption of mW (e.g., maximum UE transmit power 23 dBm corresponds to 199.5 mW), output power of an ambient IoT UE may be typically from 1 μW to a few hundreds of u W. Considering the limited energy of an ambient IoT UE, it may not be a good choice for an ambient IoT UE to monitor PDCCH for a long time. Except output power consumption, power consumption due to PDCCH monitoring in an RA procedure (e.g., in the first/second time duration) may need to be enhanced.

To solve the issue, the UE (e.g., an ambient IoT UE) could monitor the PDCCH for (receiving) a DL transmission in a one-shot or a (limited/specific) time duration (shorter than the time duration for a legacy UE) (e.g., during an RA procedure). The ambient IoT UE could monitor the PDCCH for (receiving) the DL transmission in the (limited/specific) time duration. A legacy UE or non-ambient IoT UE may monitor the PDCCH for (receiving) MSG2, MSGB, MSG4, and/or NW response in another time duration. Generally, the another time duration is (assumed/expected to be) longer than the (limited/specific) time duration. The UE could start to monitor the PDCCH for (receiving) a DL transmission at a specific timing. The network could transmit the DL transmission in the (limited/specific) time duration. The DL transmission may be a second transmission and/or a fourth transmission. The time duration may be or may include the first time duration and/or the second time duration. The (limited/specific) time duration may start at the specific timing. The specific timing may be the start of the time duration.

In one or more examples, the (limited/specific) time duration may start at a specific timing after a UL transmission. The UL transmission may be or may include a first transmission or a third transmission. The UL transmission may be a first transmitted UL transmission in repetitions and/or a bundle. The UL transmission may be a last transmitted UL transmission in repetitions and/or a bundle. If the UE performs repetition/bundle of the UL transmissions, the specific timing may be derived/determined based on the first/initial one or the last one among the repetition/bundle of the UL transmissions. The UL transmission may be a new/initial transmission in an RA procedure. The UL transmission may be a retransmission in the RA procedure. The time duration may start (at a PDCCH occasion and/or in a symbol that) after the UL transmission plus a time offset. The time duration may start at a PDCCH occasion and/or in a symbol of the end of the UL transmission plus the time offset. The time duration may start at the first PDCCH occasion and/or in a symbol from the end of the UL transmission plus the time offset. The time duration may start at a PDCCH occasion and/or in a symbol that is after the end of the UL transmission plus the time offset. The time duration may not start (at a PDCCH occasion and/or in a symbol) upon the (corresponding) UL transmission.

The UE may (start to) monitor the PDCCH (at a PDCCH occasion and/or in a symbol that) after the UL transmission plus a time offset. The UE may (start to) monitor the PDCCH at a PDCCH occasion and/or in a symbol of the end of the UL transmission plus the time offset. The UE may (start to) monitor the PDCCH at the first PDCCH occasion and/or in a symbol from the end of the UL transmission plus the time offset. The UE may (start to) monitor the PDCCH at a PDCCH occasion and/or in a symbol that is after the end of the UL transmission plus the time offset.

The NW may (start to) transmit the PDCCH (at a PDCCH occasion and/or in a symbol that) after the UL transmission plus a time offset. The NW may (start to) transmit the PDCCH at a PDCCH occasion and/or in a symbol of the end of the UL transmission plus the time offset. The NW may (start to) transmit the PDCCH at the first PDCCH occasion and/or in a symbol from the end of the UL transmission plus the time offset. The NW may (start to) transmit the PDCCH at a PDCCH occasion and/or in a symbol that is after the end of the UL transmission plus the time offset.

In one or more examples, the time duration may start at a specific timing after receiving an the NW signaling. The time duration may start at the arrival time of the (next) NW signaling. The NW signaling may be or include a carrier wave (signal) and/or interrogation signal. The NW signaling may be NW signaling received before the UE triggers the RA procedure. The NW signaling may be NW signaling indicating the UE to trigger the RA procedure. The NW signaling may be NW signaling received after the UE triggers the RA procedure. The NW signaling may be NW signaling providing energy for the UE, e.g., to trigger the RA procedure, perform UL transmission(s), monitor the PDCCH, and/or receive DL transmission(s). The NW signaling may be or include a second transmission. The time duration may start (at a PDCCH occasion and/or in a symbol that) after receiving the NW signaling plus a time offset. The time duration may start at a PDCCH occasion and/or in a symbol of the end of the NW signaling plus the time offset. The time duration may start at the first PDCCH occasion and/or in a symbol from the end of the NW signaling plus the time offset. The time duration may start at a PDCCH occasion and/or in a symbol that is after the end of the NW signaling plus the time offset.

The UE may (start to) monitor the PDCCH (at a PDCCH occasion and/or in a symbol that) after receiving the NW signaling plus a time offset. The UE may (start to) monitor the PDCCH at a PDCCH occasion and/or in a symbol of the end of the NW signaling plus the time offset. The UE may (start to) monitor the PDCCH start at the first PDCCH occasion and/or in a symbol from the end of the NW signaling plus the time offset. The UE may (start to) monitor the PDCCH at a PDCCH occasion and/or in a symbol that is after the end of the NW signaling plus the time offset. The UE may not (start to) monitor the PDCCH upon an (corresponding) UL transmission.

The NW may (start to) transmit the PDCCH (at a PDCCH occasion and/or in a symbol that) after transmitting the NW signaling plus a time offset. The NW may (start to) transmit the PDCCH at a PDCCH occasion and/or in a symbol of the end of the NW signaling plus the time offset. The NW may (start to) transmit the PDCCH start at the first PDCCH occasion and/or in a symbol from the end of the NW signaling plus the time offset. The NW may (start to) transmit the PDCCH at a PDCCH occasion and/or in a symbol that is after the end of the NW signaling plus the time offset. The NW may not (start to) transmit the PDCCH upon reception of the UL transmission.

Throughout the present disclosure, the time offset may be a Round-Trip Time (RTT) and/or time delay. The specific timing and/or the time offset may be indicated, (pre-) defined, and/or (pre-) configured by the network. The specific timing and/or the time offset may be specified in a specification, e.g., TS 38.213 ([6] 3GPP TS 38.213 V17.7.0). The specific timing and/or the time offset may be calculated and/or derived by the UE. The specific timing and/or the time offset may be common for a group of ambient IoT UEs (which receive the same NW signal). The specific timing and/or the time offset may be dedicated/specific for each ambient IoT UE. The UE may monitor the PDCCH during the (limited/specific) time duration, e.g., in response that the UE performs the corresponding UL transmission(s). The UE may receive a DL transmission on the PDCCH or receive a DL transmission scheduled by the PDCCH during the time duration. The UE may not (start to) monitor the PDCCH upon the (corresponding) UL transmission. The UE may not monitor the PDCCH before the specific timing. The UE may not receive a DL transmission outside the time duration. The UE may not receive a DL transmission before the specific timing.

Alternatively and/or additionally, the UE may start the first timer, second timer, and/or third timer at the specific timing. The value of the first timer, second timer, and/or third timer for an ambient IoT UE may be shorter than the value for a legacy UE. The value of the first timer, second timer, and/or third timer for the ambient IoT UE may be fixed. The value of the first timer, second timer, and/or third timer for the ambient IoT UE may be the shortest configurable value of the timer. The UE may monitor the PDCCH when the first timer, second timer, and/or third timer is running. The UE may not monitor the PDCCH (e.g., for the second transmission or the fourth transmission) when the first timer, second timer, and/or third timer is not running. The NW may not transmit a DL transmission or response when the first timer, second timer, and/or third timer is not running.

In one or more examples, the UE may transmit a Msg1 to the network. After or in response to transmitting the Msg1, the UE may start a response window (e.g., ra-ResponseWindow) at a specific timing after (the end of) the Msg1 transmission. The specific timing may be the first PDCCH occasion from the end of the Msg1 transmission plus a time offset. The specific timing may be the arrival time of a next NW signaling. The specific timing may be configured and/or indicated by the network (e.g., in the NW signaling). The UE may monitor the PDCCH when the response window is running (or during the response window). The UE may receive an RAR from the network when the response window is running (or during the response window). In response to (receiving) the RAR, the UE may transmit a Msg3 to the network. After or in response to transmitting the Msg3, the UE may start a contention resolution timer (e.g., ra-ContentionResolutionTimer) at a specific timing after (the end of) the Msg3 transmission. The specific timing may the first symbol after the end of the Msg3 transmission plus a time offset. The specific timing may be the arrival time of a next NW signaling. The specific timing may be configured and/or indicated by the network (e.g., in the NW signaling). The UE may monitor the PDCCH when the contention resolution timer is running. The UE may receive a Msg4 from the network when the contention resolution timer is running.

In one or more examples, the UE may transmit a MSGA to the network. After or in response to transmitting the MSGA, the UE may start a response window (e.g., msgB-ResponseWindow) at a specific timing after (the end of) the MSGA transmission. The specific timing may be a PDCCH occasion of the end of the MSGA transmission plus a time offset. The specific timing may be the arrival time of a next NW signaling. The specific timing may be configured and/or indicated by the network (e.g., in the NW signaling). The UE may monitor the PDCCH when the response window is running (or during the response window). The UE may receive a MSGB from the network when the response window is running (or during the response window).

Alternatively and/or additionally, the UE may start the first timer, second timer, and/or third timer in response to the UL transmission. The UE may start a fourth timer in response to the UL transmission and/or the start of the first timer, second timer, and/or third timer. The fourth timer may represent as the time offset. The fourth timer may be a delay timer, prohibit timer, and/or inactive timer. The fourth timer may end at the specific timing. The fourth timer may expire at the specific timing. The UE may not monitor the PDCCH when/if (at least) the fourth timer is running. The UE may monitor the PDCCH when the first timer, second timer, and/or third timer is running and when/if (at least) the fourth timer is not running. The NW may not transmit a DL transmission or response when the fourth timer is running.

In one or more examples, the UE may transmit a Msg1 to the network. After or in response to transmitting the Msg1, the UE may start a response window (e.g., ra-ResponseWindow) at the first PDCCH occasion from the end of the Msg1 transmission. The UE may start a fourth timer with a first value (e.g., first time length value or first value of TTIs/occasions/symbols/milliseconds) at the first PDCCH occasion from the end of the Msg1 transmission. The UE may start the fourth timer at a timing configured and/or indicated by the network (e.g., in the NW signaling). The UE may monitor the PDCCH when the response window is running (or during the response window) and the fourth timer is not running. The UE may monitor the PDCCH during the response window when the fourth timer is not running. The UE may receive an RAR from the network after the fourth timer expires. In response to (receiving) the RAR, the UE may transmit a Msg3 to the network. After or in response to transmitting the Msg3, the UE may start a contention resolution timer (e.g., ra-ContentionResolutionTimer) at a first symbol after the end of the Msg3 transmission. The UE may start the fourth timer with a second value (e.g., second time length value or second value of TTIs/occasions/symbols/milliseconds) at the first PDCCH occasion from the end of the Msg3 transmission. The UE may start the fourth timer at a timing configured and/or indicated by the network (e.g., in the NW signaling). The UE may monitor the PDCCH when the contention resolution timer is running and the fourth timer is not running. The UE may receive a Msg4 from the network after the fourth timer expires. The first value and the second value may be the same. The first value and the second value may be different. The first value and the second value may be configured, indicated, and/or provided by the network. The first value and the second value may be derived by the UE.

In one or more examples, the UE may transmit a Msg1 to the network. After or in response to transmitting the Msg1, the UE may start a response window (e.g., ra-ResponseWindow) at the first PDCCH occasion from the end of the Msg1 transmission. The UE may start a fourth timer with a first value (e.g., first time length value or first value of TTIs/occasions/symbols/milliseconds) at the first PDCCH occasion from the end of the Msg1 transmission. The UE may start the fourth timer at a timing configured and/or indicated by the network (e.g., in the NW signaling). The UE may monitor the PDCCH when the response window is running (or during the response window) and the fourth timer is not running. The UE may monitor the PDCCH during the response window when the fourth timer is not running. The UE may receive an RAR from the network after the fourth timer expires. In response to (receiving) the RAR, the UE may transmit a Msg3 to the network. After or in response to transmitting the Msg3, the UE may start a contention resolution timer (e.g., ra-ContentionResolutionTimer) at a first symbol after the end of the Msg3 transmission. The UE may start another fourth timer with a second value (e.g., second time length value or second value of TTIs/occasions/symbols/milliseconds) at the first PDCCH occasion from the end of the Msg3 transmission. The UE may start the other/another fourth timer at a timing configured and/or indicated by the network (e.g., in the NW signaling). The UE may monitor the PDCCH when the contention resolution timer is running (or during the response window) and the other/another fourth timer is not running. The UE may receive a Msg4 from the network after the other/another fourth timer expires. The first value and the second value may be the same. The first value and the second value may be different. The first value and the second value may be configured, indicated, and/or provided by the network. The first value and the second value may be derived by the UE. The fourth timer and the another fourth timer may be the same timer. The fourth timer and the other/another fourth timer may be different timers.

In one or more examples, the UE may transmit a MSGA to the network. After or in response to transmitting the MSGA, the UE may start a response window (e.g., msgB-ResponseWindow) at the PDCCH occasion after the MSGA transmission. The UE may start a fourth timer a at the PDCCH occasion after the MSGA transmission. The UE may start the fourth timer at a timing configured and/or indicated by the network (e.g., in the NW signaling). The UE may monitor the PDCCH when the response window is running (or during the response window) and the fourth timer is not running. The UE may monitor the PDCCH during the response window when the fourth timer is not running. The UE may receive a MSGB from the network after the fourth timer expires.

In one or more example, the (limited/specific) time duration is one TTI/occasion. Preferably in certain embodiments, the (limited/specific) time duration may be/mean the specific timing. Preferably in certain embodiments, the specific timing may be one TTI/occasion.

Preferably in certain embodiments, when the UE performs the UL transmission, the UE may monitor PDCCH for (receiving) a corresponding DL transmission at the specific timing. Preferably in certain embodiments, when the NW receives the UL transmission, the NW may transmit PDCCH for (transmitting) a corresponding DL transmission at the specific timing.

Preferably in certain embodiments, the UE may derive/determine the specific timing based on transmission timing of the UL transmission. Preferably in certain embodiments, the UE may derive/determine the specific timing based on a timing association/correspondence (e.g., a time difference) with the transmission timing of the UL transmission. Preferably in certain embodiments, the timing association/correspondence may be configured, indicated and/or provided by the network (e.g., in the NW signaling). Preferably in certain embodiments or alternatively, the timing association/correspondence may be predefined/fixed/specified/pre-configured.

Preferably in certain embodiments, if the UE performs repetition/bundle of the UL transmissions, the specific timing may be derived/determined based on the first/initial one or the last one among the repetition/bundle of the UL transmissions.

Preferably in certain embodiments, the specific timing may be later than or equal to the transmission timing of the UL transmission plus a time offset (e.g., the time offset described above). Preferably in certain embodiments, for different kinds of the UL transmissions, the time offset may be the same or different. Preferably in certain embodiments, for different kinds of the UL transmissions, the timing association/correspondence with transmission timing of UL transmission and corresponding specific timing may be the same or different. Preferably in certain embodiments, for different kinds of the UL transmissions, the resource association/correspondence with transmission resource of UL transmission and corresponding one or more specific resources may be the same or different.

In one or more example, when the UE performs the UL transmission, the UE may monitor PDCCH on one or more specific resources (e.g., PDCCH resources(s), candidate PDCCH resource(s)) at the specific timing or the (limited/specific) time duration. Preferably in certain embodiments, when the NW receives the UL transmission, the NW may transmit PDCCH for (transmitting) a corresponding DL transmission on one of the one or more specific resources at the specific timing or the (limited/specific) time duration.

Preferably in certain embodiments, the UE may derive/determine the one or more specific resources based on resource association/correspondence (e.g., resource association/correspondence in frequency, time, and/or code domain) with transmission resource of the UL transmission. Preferably in certain embodiments, the resource association/correspondence may be configured, indicated and/or provided by the network (e.g., in the NW signaling). Preferably in certain embodiments or alternatively, the resource association/correspondence may be predefined/fixed/specified/pre-configured.

Preferably in certain embodiments, the one or more specific resources may be (or include) one specific resource. In this case, the resource association/correspondence may be one-to-one between the PDCCH resource and the transmission resource of the UL transmission (e.g., PRACH resource, PUSCH resources).

Preferably in certain embodiments, the transmission resource of the UL transmission may be/mean/comprise the lowest frequency unit (e.g., lowest PRB, lowest Resource Element (RE), or lowest sub-carrier) of the transmission resource of the UL transmission.

The above example(s), method(s), concept(s) and/or embodiment(s) for PDCCH monitoring could be combined. Preferably in certain embodiments, for different kinds of the UL transmissions, different example(s), method(s), concept(s) and/or embodiment(s) for PDCCH monitoring may be applied accordingly. The different kinds of the UL transmissions may be differentiated based on the first information. The different kinds of the UL transmissions may be associated with different UE types, power levels, data types, data size, UE ID, UE group ID, cause, location, and/or repetition number.

After the UE triggers the RA procedure and/or performs the UL transmission(s), since there may be a collision when multiple UEs performs RA procedures, the UE needs to determine the contention resolution of the RA procedure, e.g., whether the UL transmission is successfully received by the network, whether the RA procedure could be considered as successfully completed. Based on the current NR MAC specification TS 38.321 ([3] 3GPP TS 38.321 V17.6.0), the UE determines the contention resolution under two cases: one is the case that the Cell Radio Network Temporary Identifier (C-RNTI) MAC CE is included in Msg3 or MSGA, and the other is the case that the CCCH SDU is included in Msg3 or MSGA. However, for an ambient IoT UE, the two cases may not be applicable (since there may be no C-RNTI MAC CE or CCCH SDU in Msg3 or MSGA), or the determination of contention resolution for the at least one of the cases may not be appropriate for an ambient IoT UE.

To solve the issue, the UE could receive a PDCCH (order/transmission) as the NW response for the UL transmission(s) in the RA procedure. In response to transmitting a first transmission and/or a third transmission, the UE may receive a PDCCH transmission without a PDSCH transmission. The UE may not receive a PDSCH (transmission), payload, MAC PDU, and/or TB. The UE may not receive a MSGB and/or Msg4 (e.g., MSGB and/or Msg4 via PDSCH). The UE may receive the PDCCH transmission as a MSGB and/or Msg4. The PDCCH transmission may be addressed to a Random Access Radio Network Temporary Identifier (RA-RNTI), MSGB-RNTI, and/or Temporary Cell Radio Network Temporary Identifier (TC-RNTI). The PDCCH transmission may be scrambling with the UE ID. The PDCCH transmission may be scrambling with part of the UE ID, e.g., the first x bits of the UE ID (e.g., x Least Significant Bit (LSB) bits or x Most Significant Bit (MSB) bits). The PDCCH transmission may indicate the UE ID. The PDCCH transmission may indicate part of the UE ID, e.g., the first x bits of the UE ID (e.g., x LSB bits or x MSB bits).

The PDCCH transmission may comprise a field indication of the UE ID. The PDCCH transmission may comprise a field indication of part of the UE ID, e.g., the first x bits of the UE ID (e.g., x LSB bits or x MSB bits). The UE may consider the PDCCH transmission including or scrambling (part of) the UE ID as a MSGB and/or Msg4.

Preferably in certain embodiments, the PDCCH transmission being scrambled with the UE ID may mean/comprise that the PDCCH includes downlink control information and Cyclic Redundancy Check (CRC) bits of the downlink control information is scrambled with (part of) the UE ID.

Preferably in certain embodiments, the PDCCH transmission comprising the field indication of (part of) the UE ID may mean/comprise that the PDCCH includes downlink control information and the downlink control information comprises the field indication of (part of) the UE ID.

For example, the UE may include its UE ID (e.g., via an RRC message, via a MAC CE) in a Msg3 and/or MSGA. The UE may transmit the Msg3/MSGA with the UE ID. In response to transmitting the Msg3/MSGA, the UE may monitor the PDCCH (e.g., based on above examples) and receive a PDCCH transmission. The UE may consider contention resolution successful, consider RAR reception successful, and/or consider the RA procedure successfully completed, if (at least) or based on one or a combination of the following conditions are fulfilled:
a notification of a reception of a PDCCH transmission (of Special Cell (SpCell)) is received from lower layers;
the PDCCH transmission is addressed to a RA-RNTI/TC-RNTI/MSGB-RNTI of the UE;
the PDCCH transmission is scrambling with (part of) the UE ID;
the PDCCH transmission indicates (part of) the UE ID;
the PDCCH transmission comprises (part of) the UE ID;
an indication in the PDCCH transmission matches (part of) the UE ID;
the PDCCH transmission indicates a RAPID, e.g., wherein the RAPID is transmitted via the first transmission;
the UE is an ambient IoT UE;
the RA procedure is initiated for ambient IoT; and/or
the RA procedure is triggered by the NW signaling (e.g., carrier wave, interrogation signal).

The ambient IoT UE could not need to maintain a TA value. The UE may not receive a Timing Advance Command (TAC) in the RA procedure. The RAR and/or MSGB (e.g., for the ambient IoT UE) may not contain a TAC. The UE may not receive a fourth information in an RA procedure. The fourth information comprises TAC, C-RNTI, ChannelAccess-CPext, Transmit Power Control (TPC) command, HARQ Feedback Timing Indicator, and/or PUCCH Resource Indicator. The NW may not provide the fourth information in an RA procedure. The UE may not apply the fourth information in the RA procedure. The UE may not indicate the fourth information to a lower layer.

The UE may not have subsequent transmission during or after the RA procedure. The UE may not transmit or receive transmission other than the first transmission, second transmission, third transmission, and/or fourth transmission during or after the RA procedure. The UE could not need to set a C-RNTI. The UE may not set a C-RNTI as the value of TC-RNTI. The UE may not set a C-RNTI received in a successRAR (MAC subPDU). The UE may not receive a C-RNTI in the RA procedure.

The above example(s), method(s), concept(s) and/or embodiment(s) for contention resolution could be combined. The contention resolution may mean or represent that an RA procedure is successfully completed, an initial access is successfully completed, and/or one or more transmission is successfully completed. The contention resolution may mean or represent that the UE successfully completes an RA procedure, transmits UL data (e.g., the first information) to the NW, and/or accesses/responses the NW.

The above example(s), method(s), concept(s) and/or embodiment(s) for transmission, reception, PDCCH monitoring and/or contention resolution could be combined.

Throughout the present disclosure, the “time duration” may be replaced by “time period”.

Various examples and embodiments of the present invention are described below. For the methods, alternatives, concepts, examples, and embodiments detailed above and herein, the following aspects and embodiments are possible.

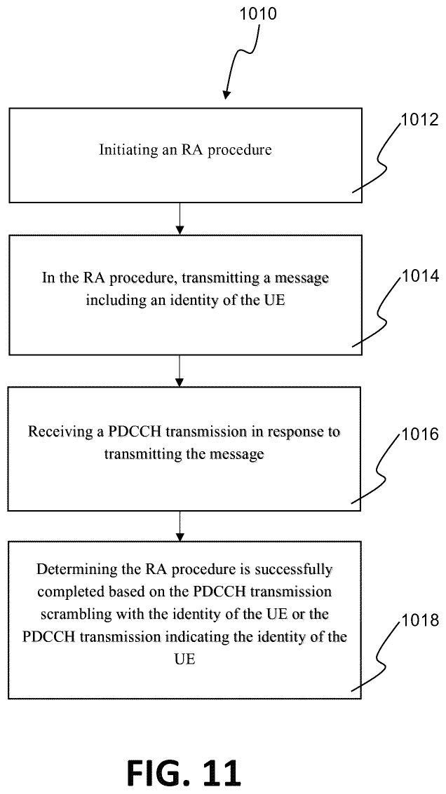

Referring to FIG. 11, with this and other concepts, systems, and methods of the present invention, a method 1010 for a UE in a wireless communication system comprises initiating an RA procedure (step 1012), in the RA procedure, transmitting a message including an identity of the UE (step 1014), receiving a PDCCH transmission in response to transmitting the message (step 1016), and determining the RA procedure is successfully completed based on the PDCCH transmission scrambling with the identity of the UE or the PDCCH transmission indicating the identity of the UE (step 1018).

In various embodiments, the message does not include a CCCH message and/or a C-RNTI.

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) initiate an RA procedure; (ii) in the RA procedure, transmit a message including an identity of the UE; (iii) receive a PDCCH transmission in response to transmitting the message; and (iv) determine the RA procedure is successfully completed based on the PDCCH transmission scrambling with the identity of the UE or the PDCCH transmission indicating the identity of the UE. Moreover, the CPU 308 can execute the program code 312 to perform all of the described actions, steps, and methods described above, below, or otherwise herein.

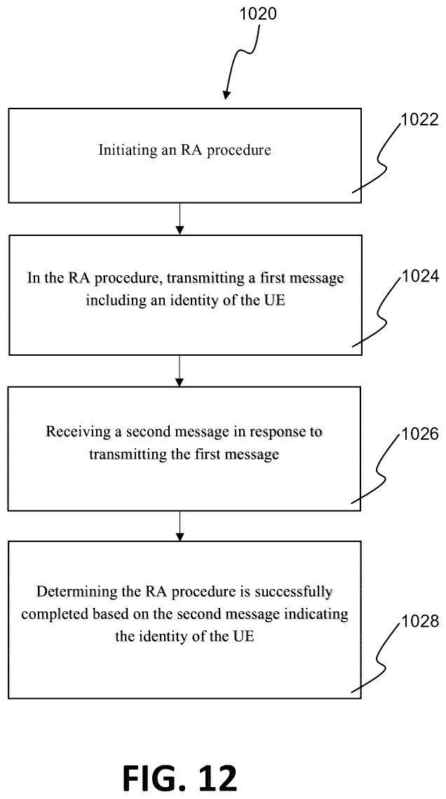

Referring to FIG. 12, with this and other concepts, systems, and methods of the present invention, a method 1020 for a UE in a wireless communication system comprises initiating an RA procedure (step 1022), in the RA procedure, transmitting a first message including an identity of the UE (step 1024), receiving a second message in response to transmitting the first message (step 1026), and determining the RA procedure is successfully completed based on the second message indicating the identity of the UE (step 1028).

In various embodiments, the identity of the UE is a ue-Identity and/or a UE contention resolution ID provided in a MAC CE.

In various embodiments, the identity of the UE is provided in a MAC CE or is a MAC CE.

In various embodiments, the second message comprises a UE contention resolution ID MAC CE.

In various embodiments, the UE contention resolution ID MAC CE matches the identity of the UE.

In various embodiments, the UE does not apply a TA value in response to (receiving) the second message.

In various embodiments, the UE does not set a C-RNTI in response to (receiving) the second message.

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) initiate an RA procedure; (ii) in the RA procedure, transmit a first message including an identity of the UE; (iii) receive a second message in response to transmitting the first message; and (iv) determine the RA procedure is successfully completed based on the second message indicating the identity of the UE. Moreover, the CPU 308 can execute the program code 312 to perform all of the described actions, steps, and methods described above, below, or otherwise herein.

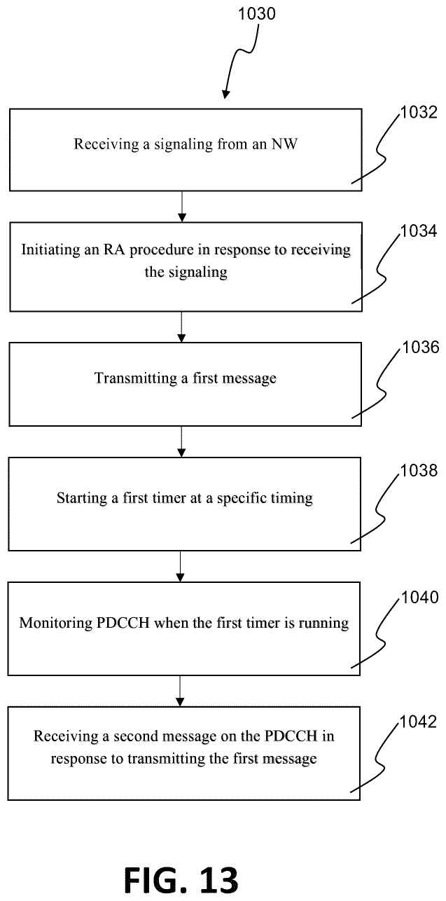

Referring to FIG. 13, with this and other concepts, systems, and methods of the present invention, a method 1030 for a UE in a wireless communication system comprises receiving a signaling from an NW (step 1032), initiating an RA procedure in response to (receiving) the signaling (step 1034), transmitting a first message (step 1036), starting a first timer at a specific timing (step 1038), monitoring PDCCH when the first timer is running (step 1040), and receiving a second message on the PDCCH in response to transmitting the first message (step 1042).

In various embodiments, the specific timing is the end of the first transmission plus a time offset, the end of the signaling reception plus a time offset, or arrival time of another signaling.

In various embodiments, the time offset is related to a characteristic of the UE.

In various embodiments, the second message is received when the first timer is running.

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) receive a signaling from an NW; (ii) initiate an RA procedure in response to (receiving) the signaling; (iii) transmit a first message; (iv) start a first timer at a specific timing; (v) monitoring PDCCH when the first timer is running; and (vi) receive a second message on the PDCCH in response to transmitting the first message. Moreover, the CPU 308 can execute the program code 312 to perform all of the described actions, steps, and methods described above, below, or otherwise herein.

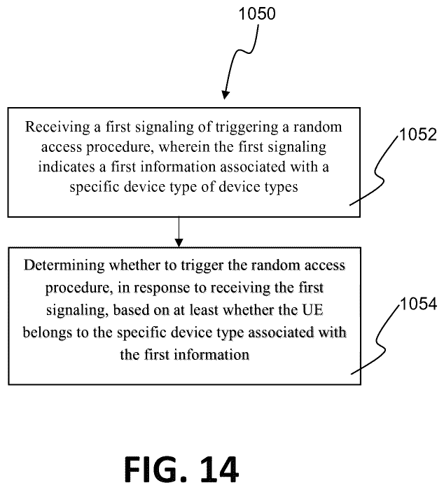

Referring to FIG. 14, with this and other concepts, systems, and methods of the present invention, a method 1050 for a UE in a wireless communication system comprises receiving a first signaling of triggering a random access procedure, wherein the first signaling indicates a first information associated with a specific device type of device types (step 1052), and determining whether to trigger the random access procedure, in response to (receiving) the first signaling, based on at least whether the UE belongs to the specific device type associated with the first information (step 1054).

In various embodiments, the first signaling is an ambient IoT paging message or a paging message, and/or wherein the random access procedure is an ambient IoT random access procedure.

In various embodiments, the method further comprises: receiving a second information indicated by the first signaling, wherein the second information indicates a group ID of the UE or a set of UEs, and in response to (receiving) the first signaling, triggering the random access procedure if at least the UE belongs to the specific device type associated with the first information, wherein the first signaling indicates the second information of the group ID of the UE, and/or the UE belongs to the set of UEs.

In various embodiments, the set of UEs are allowed to trigger the random access procedure.

In various embodiments, the method further comprises: in response to (receiving) the first signaling, not triggering the random access procedure if the UE does not belong to the specific device type associated with the first information, and/or if the first signaling does not indicate a second information of ID or a group ID of the UE, and/or the UE does not belong to a set of UEs indicated by the first signaling.

In various embodiments, the device types include at least a first device type and a second device type, wherein at least one of: the first device type is able to generate transmission by itself and the second device type generates transmission by backscattering, and/or the first device type has or is equipped with amplification and the second device type does not have or is not equipped with amplification, and/or the first device type and the second device type are differentiated by at least any of energy storage, power level, and/or device size.

In various embodiments, the method further comprises: in response to (receiving) the first signaling, triggering the random access procedure if at least the UE belongs to the specific device type associated with the first information, and/or in response to (receiving) the first signaling, not triggering the random access procedure if at least the UE does not belong to the specific device type associated with the first information.

In various embodiments, the first signaling is transmitted from a reader, and/or wherein the reader is a network node, an intermediate node, or another UE.

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) receive a first signaling of triggering a random access procedure, wherein the first signaling indicates a first information associated with a specific device type of device types; and (ii) determine whether to trigger the random access procedure, in response to (receiving) the first signaling, based on at least whether the UE belongs to the specific device type associated with the first information. Moreover, the CPU 308 can execute the program code 312 to perform all of the described actions, steps, and methods described above, below, or otherwise herein.

Referring back to FIGS. 3 and 4, in one or more embodiments from the perspective of a reader in a wireless communication system, the device 300 includes a program code 312 stored in memory 310 of the transmitter. The CPU 308 could execute program code 312 to: (i) transmit a first signaling of triggering a random access procedure, wherein the first signaling indicates a first information associated with a specific device type of device types. Moreover, the CPU 308 can execute the program code 312 to perform all of the described actions, steps, and methods described above, below, or otherwise herein.

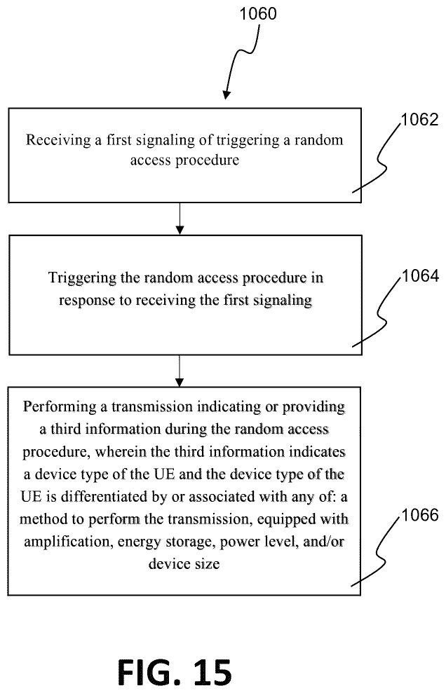

Referring to FIG. 15, with this and other concepts, systems, and methods of the present invention, a method 1060 for a UE in a wireless communication system comprises receiving a first signaling of triggering a random access procedure (step 1062), triggering the random access procedure in response to (receiving) the first signaling (step 1064), and performing a transmission indicating or providing a third information during the random access procedure, wherein the third information indicates a device type of the UE and the device type of the UE is differentiated by or associated with any of: a method to perform the transmission, equipped with amplification, energy storage, power level, and/or device size (step 1066).

In various embodiments, the third information indicates the UE belonging to which type of more than one type of ambient IoT device, wherein the more than one type of ambient IoT device is differentiated by any of: a method to perform the transmission, equipped with amplification, energy storage, power level, and/or device size.

In various embodiments, the third information indicates the device type of the UE comprising any of: generating (the) transmission by itself or generating (the) transmission by backscattering, and/or equipped with amplification or not equipped with amplification, and/or differentiation by energy storage, power level, and/or device size.

In various embodiments, the first signaling is an ambient IoT paging message and/or a paging message, and/or wherein the random access procedure is an ambient IoT random access procedure.

In various embodiments, the first signaling is transmitted from a reader, and/or wherein the transmission is transmitted to the reader during the random access procedure, and/or wherein the reader is a network node, an intermediate node, or another UE.

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) receive a first signaling of triggering a random access procedure; (ii) trigger the random access procedure in response to (receiving) the first signaling; and (iii) perform a transmission indicating or providing a third information during the random access procedure, wherein the third information indicates a device type of the UE and the device type of the UE is differentiated by or associated with any of: a method to perform the transmission, equipped with amplification, energy storage, power level, and/or device size. Moreover, the CPU 308 can execute the program code 312 to perform all of the described actions, steps, and methods described above, below, or otherwise herein.

Referring back to FIGS. 3 and 4, in one or more embodiments from the perspective of a reader in a wireless communication system, the device 300 includes a program code 312 stored in memory 310 of the transmitter. The CPU 308 could execute program code 312 to: (i) transmit a first signaling of triggering a random access procedure; and (ii) receive a transmission indicating or providing a third information during the random access procedure, wherein the third information indicates a device type of the UE and the device type of the UE is differentiated by or associated with any of: a method to perform the transmission, equipped with amplification, energy storage, power level, and/or device size. Moreover, the CPU 308 can execute the program code 312 to perform all of the described actions, steps, and methods described above, below, or otherwise herein.

Any combination of the above or herein concepts or teachings can be jointly combined, in whole or in part, or formed to a new embodiment. The disclosed details and embodiments can be used to solve at least (but not limited to) the issues mentioned above and herein.

It is noted that any of the methods, alternatives, steps, examples, and embodiments proposed herein may be applied independently, individually, and/or with multiple methods, alternatives, steps, examples, and embodiments combined together.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects, concurrent channels may be established based on pulse repetition frequencies. In some aspects, concurrent channels may be established based on pulse position or offsets. In some aspects, concurrent channels may be established based on time hopping sequences. In some aspects, concurrent channels may be established based on pulse repetition frequencies, pulse positions or offsets, and time hopping sequences.

Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of ordinary skill in the art would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer program product may comprise packaging materials.

While the invention has been described in connection with various aspects and examples, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method of a User Equipment (UE), comprising:
receiving a first signaling of triggering a random access procedure, wherein the first signaling indicates a first information associated with a specific device type of device types; and
determining whether to trigger the random access procedure, in response to receiving the first signaling, based on at least whether the UE belongs to the specific device type associated with the first information.

2. The method of claim 1, wherein the first signaling is an ambient Internet of Things (IoT) paging message or a paging message, and/or wherein the random access procedure is an ambient IoT random access procedure.

3. The method of claim 1, further comprising:
receiving a second information indicated by the first signaling, wherein the second information indicates a group Identity (ID) of the UE or a set of UEs; and/or
in response to receiving the first signaling, triggering the random access procedure if at least the UE belongs to the specific device type associated with the first information, wherein the first signaling indicates the second information of the group ID of the UE, and/or the UE belongs to the set of UEs.

4. The method of claim 3, wherein the set of UEs are allowed to trigger the random access procedure.

5. The method of claim 1, further comprising:
in response to receiving the first signaling, not triggering the random access procedure if the UE does not belong to the specific device type associated with the first information, and/or if the first signaling does not indicate a second information of ID or a group ID of the UE, and/or the UE does not belong to a set of UEs indicated by the first signaling.

6. The method of claim 1, wherein the device types include at least a first device type and a second device type, wherein at least one of:
the first device type is able to generate transmission by itself and the second device type generates transmission by backscattering, and/or
the first device type has or is equipped with amplification and the second device type does not have or is not equipped with amplification, and/or
the first device type and the second device type are differentiated by at least any of energy storage, power level, and/or device size.

7. The method of claim 1, further comprising:
in response to receiving the first signaling, triggering the random access procedure if at least the UE belongs to the specific device type associated with the first information; and/or
in response to receiving the first signaling, not triggering the random access procedure if at least the UE does not belong to the specific device type associated with the first information.

8. The method of claim 1, wherein the first signaling is transmitted from a reader, wherein the reader is a network node, an intermediate node, or another UE.

9. A method of a User Equipment (UE), comprising:
receiving a first signaling of triggering a random access procedure;
triggering the random access procedure in response to receiving the first signaling; and
performing a transmission indicating or providing a third information during the random access procedure, wherein the third information indicates a device type of the UE, and the device type of the UE is differentiated by or associated with any of: a method to perform the transmission, equipped with amplification, energy storage, power level, and/or device size.

10. The method of claim 9, wherein the third information indicates the UE belonging to which type of more than one type of ambient Internet of Things (IoT) device, wherein the more than one type of ambient IoT device is differentiated by any of: a method to perform the transmission, equipped with amplification, energy storage, power level, and/or device size.

11. The method of claim 9, wherein the third information indicates the device type of the UE comprising any of:
generating the transmission by itself or generating the transmission by backscattering, and/or
equipped with amplification or not equipped with amplification, and/or
differentiation by energy storage, power level, and/or device size.

12. The method of claim 9, wherein the first signaling is an ambient IoT paging message and/or a paging message, and/or wherein the random access procedure is an ambient IoT random access procedure.

13. The method of claim 9, wherein the first signaling is transmitted from a reader, and/or
wherein the transmission is transmitted to the reader during the random access procedure, and/or
wherein the reader is a network node, an intermediate node, or another UE.

14. A User Equipment (UE), comprising:
a memory; and
a processor operatively coupled with the memory, wherein the processor is configured to execute a program code to:
receive a first signaling of triggering a random access procedure, wherein the first signaling indicates a first information associated with a specific device type of device types; and
determine whether to trigger the random access procedure, in response to receiving the first signaling, based on at least whether the UE belongs to the specific device type associated with the first information.

15. The UE of claim 14, wherein the first signaling is an ambient Internet of Things (IoT) paging message or a paging message, and/or wherein the random access procedure is an ambient IoT random access procedure.

16. The UE of claim 14, wherein the processor is further configured to execute the program code to:
receive a second information indicated by the first signaling, wherein the second information indicates a group ID of the UE or a set of UEs; and/or
in response to receiving the first signaling, trigger the random access procedure if at least the UE belongs to the specific device type associated with the first information, wherein the first signaling indicates the second information of the group ID of the UE, and/or the UE belongs to the set of UEs.

17. The UE of claim 16, wherein the set of UEs are allowed to trigger the random access procedure.

18. The UE of claim 14, wherein the processor is further configured to execute the program code to:
in response to receiving the first signaling, not triggering the random access procedure if the UE does not belong to the specific device type associated with the first information, and/or if the first signaling does not indicate a second information of ID or a group ID of the UE, and/or the UE does not belong to a set of UEs indicated by the first signaling.

19. The UE of claim 14, wherein the device types include at least a first device type and a second device type, wherein at least one of:
the first device type is able to generate transmission by itself and the second device type generates transmission by backscattering, and/or
the first device type has or is equipped with amplification and the second device type does not have or is not equipped with amplification, and/or
the first device type and the second device type are differentiated by at least any of energy storage, power level, and/or device size.

20. The UE of claim 14, wherein the processor is further configured to execute the program code to:
in response to receiving the first signaling, trigger the random access procedure if at least the UE belongs to the specific device type associated with the first information; and/or
in response to receiving the first signaling, not trigger the random access procedure if at least the UE does not belong to the specific device type associated with the first information.
